(19) United States
(12) Patent Application Publication
(10) Pub. No.: US 2024/0317905 A1
(43) Pub. Date: Sep. 26, 2024

(54) POLYMERS OF VINYLCYCLOBUTANE AND PROCESSES FOR MAKING SAME

(71) Applicants: EXXONMOBIL CHEMICAL PATENTS INC., BAYTOWN, TX (US); THE TRUSTEES OF PRINCETON UNIVERSITY, PRINCETON, NJ (US)

(72) Inventors: Nikola S. Lambic, Seabrook, TX (US); Brian J. Rohde, Houston, TX (US); Irene C. Cai, Webster, TX (US); Sarah J. Mattler, League City, TX (US); Tzu-Pin Lin, Seabrook, TX (US); Gursu Culcu, Humble, TX (US); Jo Ann M. Canich, Houston, TX (US); Jarod M. Younker, Houston, TX (US); Alex E. Carptenter, Austin, TX (US); Paul J. Chirik, Princeton, NJ (US)

(21) Appl. No.: 18/545,505

(22) Filed: Dec. 19, 2023

Related U.S. Application Data
(60) Provisional application No. 63/436,006, filed on Dec. 29, 2022.

(51) Int. Cl. C08F 10/14; C08F 4/659; C08F 4/6592

(52) U.S. Cl. CPC C08F 10/14; C08F 4/65912; C08F 4/65916; C08F 4/65927

(57) ABSTRACT

Vinylcyclobutane (VCB) homopolymers, VCB copolymers and processes for making same. The VCB homopolymers and copolymers have a polydispersity (PDI) of less than 3.0 and are made by contacting VCB monomer in the presence of a single-site metallocene, post metallocene, or half metallocene, and an activator, under sufficient reaction conditions to produce a VCB (co)polymer having the narrow PDI of less than 3.0. The resulting poly(vinylcyclobutane) polymers have increased crystallinity and melting point properties (Tm of 165° C. to 246° C.) that are comparable to conventional polyolefins such as polyethylene (typical Tm <135° C.) and polypropylene (typical Tm <165° C.).

### CROSS-REFERENCE TO RELATED APPLICATION

This application claims priority to U.S. Provisional Patent Application No. 63/436,006, filed on Dec. 29, 2022, which is incorporated by reference herein.

### FIELD

The present disclosure relates to olefin copolymers with increased crystallinity and melting point properties. More particularly, the present disclosure relates to homopolymers and copolymers of vinylcyclobutane, and processes for making same.

### BACKGROUND

Poly(vinylcyclobutane) has received limited attention because of limited availability of monomer (vinylcyclobutane or “VCB”) and a lack of suitable polymerization systems. Copolymers containing VCB are even more rare than poly(vinylcyclobutane) homopolymers and not widely known. The synthesis of poly(vinylcyclobutane) was first reported in J. Polym. Sci. Part A: Polym. Chem. 1964, 2, 755. However, the conditions were harsh and lead to a product that required acid digestions followed by Soxhlet extraction to purify. This journal article discloses a Ziegler/Natta polymerization system (TiCl₄ with TIBAL) with high catalyst loadings for prolonged reaction periods (7 days, 75° C.). The resulting residue was digested with 10% HCl in MeOH for 7 days followed by a 48 hr Soxhlet extraction using C₆H_{6.} The resulting polymer was poorly characterized and defined. Limited solubility and melting point information were provided.

The remainder of the literature pertaining to poly(vinylcyclobutane) is limited to two highly specialized X-ray diffraction studies. J. Polym. Sci., Part C. Polym. Letter, 1967, 16, 725; and Macromolecules, 2000, 33, 125-129.

There is a need, therefore, for improved processes for polymerizing vinylcyclobutane to produce homopolymers of vinylcyclobutane as well as copolymers thereof.

### SUMMARY

Vinylcyclobutane (VCB) homopolymers, VCB copolymers and processes for making same. The VCB homopolymers and copolymers have a polydispersity (PDI) of less than 3.0 and are made by contacting VCB monomer in the presence of a single-site metallocene, post metallocene, or half metallocene, and an activator, under sufficient reaction conditions to produce a VCB (co)polymer having the narrow PDI of less than 3.0. The resulting poly(vinylcyclobutane) polymers have increased crystallinity and melting point properties (Tm of 165° C. to 246° C.) that are comparable to conventional polyolefins such as polyethylene (typical Tm <135° C.) and polypropylene (typical Tm <165° C.).

One particular catalyst system is the post metallocene catalyst compound represented by Formula (I):

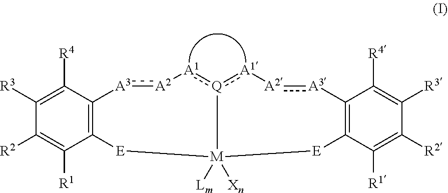

wherein:
M is a group 3, 4, 5, or 6 transition metal or a Lanthanide;
E and E′ are each independently O, S, or NR⁹ where R⁹ is independently hydrogen, a C₁-C₄₀ hydrocarbyl, a C₁-C₄₀ substituted hydrocarbyl or a heteroatom-containing group;
Q is group 14, 15, or 16 atom that forms a dative bond to metal M;
A¹QA^{1′} are part of a heterocyclic Lewis base containing 4 to 40 non-hydrogen atoms that links A² to A^{2′} via a 3-atom bridge with Q being the central atom of the 3-atom bridge, A¹ and A^{1′} are independently C, N, or C(R²²), where R²² is selected from the group consisting of hydrogen, C₁-C₂₀ hydrocarbyl, and C₁-C₂₀ substituted hydrocarbyl;
A³ [symbol] A² is a divalent group containing 2 to 40 non-hydrogen atoms that links A¹ to the E-bonded aryl group via a 2-atom bridge;
A^{2′} [symbol] A^{3′} is a divalent group containing 2 to 40 non-hydrogen atoms that links A^{1′} to the E′-bonded aryl group via a 2-atom bridge;
L is a Lewis base;
X is an anionic ligand;
n is 1, 2 or 3;
m is 0, 1, or 2;
n+m is not greater than 4;
each of R¹, R², R³, R⁴, R^{1′}, R^{2′}, R^{3′}, and R^{4′} is independently hydrogen, a C₁-C₄₀ hydrocarbyl, a C₁-C₄₀ substituted hydrocarbyl, a heteroatom or a heteroatom-containing group, and
one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings;
any two L groups may be joined together to form a bidentate Lewis base;
an X group may be joined to an L group to form a monoanionic bidentate group; and
any two X groups may be joined together to form a dianionic ligand group.

### BRIEF DESCRIPTION OF THE DRAWINGS

FIG. 1 shows the thermal behavior of poly(vinylcyclobutane) made according to one or more embodiments provided herein which exhibits glass transition temperature of 34° C. and a high melting point of 246° C. unique to homopolymer composition. Such high melting point is unusual compared to conventional poly(olefins) and is higher than that reported for poly(vinylcyclobutane) produced by prior art Z/N catalyst systems.

FIG. 2 shows ¹³C NMR spectroscopic data for the poly(vinylcyclobutane) polymer and confirms its structure. Furthermore, FIG. 2 also confirms isotacic nature of the vinylcyclobutane units.

FIG. 3 shows ¹H NMR spectroscopic data for the poly(vinylcyclobutane), confirming the presence of cyclic 4-carbon ring structures.

FIG. 4 shows a heteronuclear 2D NMR spectrum data for the poly(vinylcyclobutane), which further confirms the structural assignment.

FIG. 5 shows GPC data for the poly(vinylcyclobutane) polymer confirming a narrow PDI and a sufficiently high Mw >10,000 g/mol. Such narrow PDI value is unique to usage of single site catalysts in preparation of poly(vinylcyclobutane).

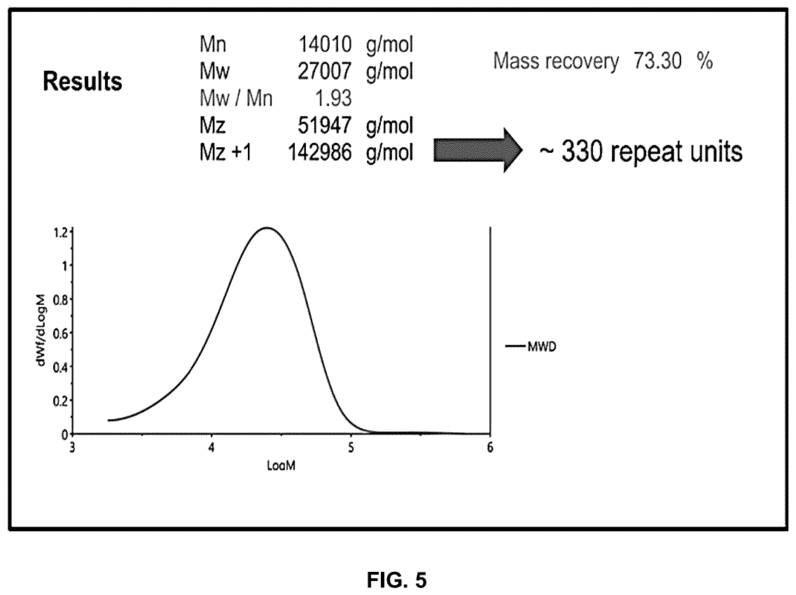

### DETAILED DESCRIPTION

The present disclosure is directed to homopolymers and copolymers of vinylcyclobutane, and processes for making same. The poly(vinylcyclobutane) polymers are made using unique single site catalysts as described herein. The resulting poly(vinylcyclobutane) polymers have increased crystallinity and melting point properties (Tm of 180° C. to 240° C.) that are comparable to conventional polyolefins such as polyethylene (typical Tm <135° C.) and polypropylene (typical Tm <165° C.). These versatile thermal properties (e.g. increased crystallinity and melting points) allow the poly(vinylcyclobutanes) to serve as replacements for such conventional polyolefins, as well as engineering thermoplastics.

In addition to improved thermal properties, the poly(vinylcyclobutane) polymers showcase narrower polydispersity (typically <3.0) compared to Ti-based Ziegler-Natta systems which commonly show broad polydispersities (typically >4.0) due to the inherent multi-site character of the catalyst. Uniformly low polydispersities (<3) provide advantages for application like fiber blowing, but also lead to low oligomer content and lower residual volatile organic compounds, which is traditionally difficult to achieve using even the most sophisticated Ziegler-Natta systems.

Further, the poly(vinylcyclobutanes) polymers provided herein are made from catalyst systems and processes capable of commercially realistic production rates, including solution and slurry process. Owing to the single site nature of the catalysts that is used, the resulting poly(vinylcyclobutane) homopolymers and copolymers possess a high degree of randomness, which was not expected based on poly(vinylcyclobutanes) made using ZN catalysts due to the inherent block-like microstructures that are produced with such catalyst systems. Increased randomness typically leads to reduction in haze and yields polymer films and articles with improved optical properties.

For the purposes of this invention and the claims thereto, the following definitions shall be used.

### Definitions

The new numbering scheme for the Periodic Table Groups is used as described in Chemical and Engineering News, v. 63(5), pg. 27 (1985). Therefore, a “group 4 metal” is an element from group 4 of the Periodic Table, e.g. Hf, Ti, or Zr.

For purposes herein, a “catalyst system” is the combination of at least one catalyst compound, at least one activator, an optional co-activator, and an optional support material. For purposes of the present disclosure and the claims thereto, when catalyst systems are described as comprising neutral stable forms of the components, it is well understood by one of ordinary skill in the art, that the ionic form of the component is the form that reacts with the monomers to produce polymers.

A “metallocene” catalyst compound is an organometallic transition metal catalyst compound having one, two or three, typically one or two, substituted or unsubstituted cyclopentadienyl ligands bound to the transition metal, typically a metallocene catalyst is an organometallic compound containing at least one π-bound cyclopentadienyl moiety (or substituted cyclopentadienyl moiety). A “half-metallocene” catalyst is an organometallic compound containing only one π-bound cyclopentadienyl moiety (or substituted cyclopentadienyl moiety). Substituted or unsubstituted cyclopentadienyl ligands include substituted or unsubstituted indenyl, fluorenyl, tetrahydro-s-indacenyl, tetrahydro-as-indacenyl, benz[f]indenyl, benz[e]indenyl, tetrahydrocyclopenta[b]naphthalene, tetrahydrocyclopenta[a]naphthalene, and the like. For purposes of the present disclosure in relation to metallocene catalyst compounds, the term “substituted” means that one or more hydrogen atoms have been replaced with a hydrocarbyl, heteroatom (such as a halide), or a heteroatom containing group, (such as silylcarbyl, germylcarbyl, halocarbyl, etc.). For example, methyl cyclopentadiene (Cp) is a Cp group substituted with a methyl group.

The following numbering schemes are used herein for cyclopentadienyl, indenyl, fluorenyl, and cyclopentanaphthyl (also termed benzindenyl). It should be noted that indenyl can be considered a cyclopentadienyl fused with a benzene ring. Analogously, fluorenyl can be considered a cyclopentadienyl with two phenyl rings fused onto the cyclopentadienyl ring. Each structure below is drawn and named as an anion.

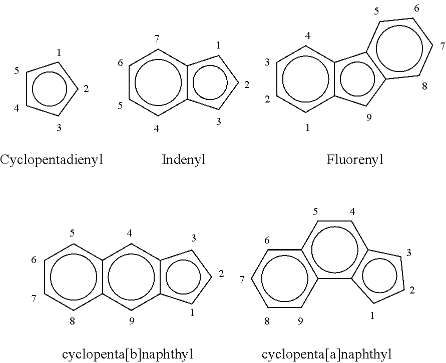

The following numbering schemes are used herein for indenyl, tetrahydro-s-indacenyl and tetrahydro-as-indacenyl ligands.

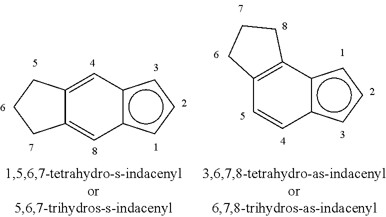

The terms “post-metallocene”, “post-metallocene catalyst” and “post-metallocene compound” are used interchangeable and refer to transition metal complexes that contain a transition metal, at least one anionic donor ligand, and at least one leaving group with a non-carbon atom directly linking to the metal (such as halogen leaving group(s)), but do not contain any π-coordinated cyclopentadienyl anion donors (e.g., π-bound cyclopentadienyl moiety or substituted cyclopentadienyl moiety), where the complexes are useful for the polymerization of olefins, typically when combined with activator(s). Post-metallocene catalysts include those first disclosed after 1980, typically after 1990.

The following abbreviations may be used herein: Me is methyl, Et is ethyl, Pr is propyl, cPr is cyclopropyl, nPr is n-propyl, iPr is isopropyl, Bu is butyl, nBu is normal butyl, iBu is isobutyl, sBu is sec-butyl, tBu is tert-butyl, Oct is octyl, Ph is phenyl, MAO is methylalumoxane, dme is 1,2-dimethoxyethane, p-tBu is para-tertiary butyl, TMS is trimethylsilyl, TIBAL is triisobutylaluminum, TNOA and TNOAL are tri(n-octyl)aluminum, p-Me is para-methyl, Bn is benzyl (i.e., CH2Ph), THF (also referred to as thf) is tetrahydrofuran, RT is room temperature (and is 23° C. unless otherwise indicated), tol is toluene, EtOAc is ethyl acetate, Cbz is Carbazole, and Cy is cyclohexyl.

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, Mz) are g/mol.

Unless otherwise noted all melting points (Tm) are DSC second melt.

According to one embodiment, vinylcyclobutane (VCB) monomer can be polymerized by contacting VCB monomer and optionally one or more C₂-C₂₀ alpha-olefin comonomers in the presence of a catalyst system that includes a single-site metallocene, post-metallocene, or half-metallocene under reaction conditions to produce a VCB polymer.

A suitable post-metallocene catalyst for polymerizing VCB can be a Lewis Base catalyst that includes a metal selected from groups 3, 4, 5 or 6 or Lanthanide metals of the Periodic Table of the Elements, a tridentate dianionic ligand containing two anionic donor groups and a neutral heterocyclic Lewis base donor, wherein the heterocyclic donor is covalently bonded between the two anionic donors. Preferably the dianionic, tridentate ligand features a central heterocyclic donor group and two phenolate donors and the tridentate ligand coordinates to the metal center to form two eight-membered rings. The metal is preferably selected from group 3, 4, 5, or 6 elements. Preferably the metal, M, is a group 4 metal. Most preferably the metal, M, is zirconium or hafnium.

The heterocyclic Lewis base donor features a nitrogen or oxygen donor atom. Preferred heterocyclic groups include derivatives of pyridine, pyrazine, pyrimidine, triazine, thiazole, imidazole, thiophene, oxazole, thiazole, furan, and substituted variants of thereof. Preferably the heterocyclic Lewis base lacks hydrogen(s) in the position alpha to the donor atom. Particularly preferred heterocyclic Lewis base donors include pyridine, 3-substituted pyridines, and 4-substituted pyridines.

The anionic donors of the tridentate dianionic ligand may be arylthiolates, phenolates, or anilides. Preferred anionic donors are phenolates. It is preferred that the tridentate dianionic ligand coordinates to the metal center to form a complex that lacks a mirror plane of symmetry. It is preferred that the tridentate dianionic ligand coordinates to the metal center to form a complex that has a two-fold rotation axis of symmetry; when determining the symmetry of the bis(phenolate) complexes only the metal and dianionic tridentate ligand are considered (i.e. ignore remaining ligands).

The bis(phenolate) ligands are preferably tridentate dianionic ligands that coordinate to the metal M in such a fashion that a pair of 8-membered metallocycle rings are formed. The bis(phenolate) ligands wrap around the metal to form a complex with a 2-fold rotation axis, thus giving the complexes C₂ symmetry. The C₂ geometry and the 8-membered metallocycle rings are features of these complexes that make them effective catalyst components for the production of polyolefins, particularly isotactic poly(alpha olefins). If the ligands were coordinated to the metal in such a manner that the complex had mirror-plane (Cₛ) symmetry, then the catalyst would be expected to produce only atactic poly(alpha olefins); these symmetry-reactivity rules are summarized by Bercaw, J. E. (2009) in Macromolecules, v. 42, pp. 8751-8762. The pair of 8-membered metallocycle rings of the inventive complexes is also a notable feature that is advantageous for catalyst activity, temperature stability, and isoselectivity of monomer enchainment. Related group 4 complexes featuring smaller 6-membered metallocycle rings are known (Macromolecules 2009, 42, 8751-8762) to form mixtures of C₂ and Cₛ symmetric complexes when used in olefin polymerizations and are thus not well suited to the production of highly isotactic poly(alpha olefins).

Bis(phenolate) ligands that contain oxygen donor groups (i.e. E=E′=oxygen in Formula (I)) in the present invention are preferably substituted with alkyl, substituted alkyl, aryl, or other groups. Each phenolate group can be substituted in the ring position that is adjacent to the oxygen donor atom. It is preferred that substitution at the position adjacent to the oxygen donor atom be an alkyl group containing 1-20 carbon atoms. It is preferred that substitution at the position next to the oxygen donor atom be a non-aromatic cyclic alkyl group with one or more five-or six-membered rings. It is preferred that substitution at the position next to the oxygen donor atom be a cyclic tertiary alkyl group. It is highly preferred that substitution at the position next to the oxygen donor atom be adamantan-1-yl or substituted adamantan-1-yl.

The neutral heterocyclic Lewis base donor is covalently bonded between the two anionic donors via “linker groups” that join the heterocyclic Lewis base to the phenolate groups. The “linker groups” are indicated by (A³A²) and (A^{2′}A^{3′}) in Formula (I). The choice of each linker group may affect the catalyst performance, such as the tacticity of the poly(alpha olefin) produced. Each linker group is typically a C₂-C₄₀ divalent group that is two-atoms in length. One or both linker groups may independently be phenylene, substituted phenylene, heteroaryl, vinylene, or a non-cyclic two-carbon long linker group. When one or both linker groups are phenylene, the alkyl substituents on the phenylene group may be chosen to optimize catalyst performance. Typically, one or both phenylenes may be unsubstituted or may be independently substituted with C₁ to C₂₀ alkyl, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, or an isomer thereof, such as isopropyl, etc.

The foregoing Lewis base catalyst can be represented by the structure shown below in Formula (I):

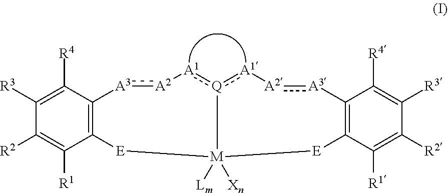

wherein:
M is a group 3, 4, 5, or 6 transition metal or a Lanthanide (such as Hf, Zr or Ti);
E and E′ are each independently O, S, or NR⁹, where R⁹ is independently hydrogen, C₁-C₄₀ hydrocarbyl, C₁-C₄₀ substituted hydrocarbyl, or a heteroatom-containing group, preferably O, preferably both E and E′ are O;
Q is group 14, 15, or 16 atom that forms a dative bond to metal M, preferably Q is C, O, S or N, more preferably Q is C, Nor O, most preferably Q is N;
A¹QA^{1′} are part of a heterocyclic Lewis base containing 4 to 40 non-hydrogen atoms that links A² to A^{2′} via a 3-atom bridge with Q being the central atom of the 3-atom bridge (A¹QA¹ combined with the curved line joining A¹ and A^{1′} represents the heterocyclic Lewis base), A¹ and A^{1′} are independently C, N, or C(R²²), where R²² is selected from hydrogen, C₁-C₂₀ hydrocarbyl, and C₁-C₂₀ substituted hydrocarbyl. Preferably A¹ and A^{1′} are C;
A³ [symbol] A² is a divalent group containing 2 to 40 non-hydrogen atoms that links A¹ to the E-bonded aryl group via a 2-atom bridge, such as ortho-phenylene, substituted ortho-phenylene, ortho-arene, indolene, substituted indolene, benzothiophene, substituted benzothiophene, pyrrolene, substituted pyrrolene, thiophene, substituted thiophene, 1,2-ethylene (—CH₂CH₂—), substituted 1,2-ethylene, 1,2-vinylene (—HC═CH—), or substituted 1,2-vinylene, preferably A³ [symbol] A² is a divalent hydrocarbyl group;
A^{2′} [symbol] A^{3′} is a divalent group containing 2 to 40 non-hydrogen atoms that links A^{1′} to the E′-bonded aryl group via a 2-atom bridge such as ortho-phenylene, substituted ortho-phenylene, ortho-arene, indolene, substituted indolene, benzothiophene, substituted benzothiophene, pyrrolene, substituted pyrrolene, thiophene, substituted thiophene, 1,2-ethylene (—CH₂CH₂—), substituted 1,2-ethylene, 1,2-vinylene (—HC═CH—), or substituted 1,2-vinylene, preferably A^{2′} [symbol] A^{3′} is a divalent hydrocarbyl group;
each L is independently a Lewis base;
each X is independently an anionic ligand;
n is 1, 2 or 3;
m is 0, 1, or 2;
n+m is not greater than 4;
each of R¹, R², R³, R⁴, R^{1′}, R^{2′}, R^{3′}, and R^{4′} is independently hydrogen, C₁-C₄₀ hydrocarbyl, C₁-C₄₀ substituted hydrocarbyl, a heteroatom or a heteroatom-containing group (preferably R^{1′} and R¹ are independently a cyclic group, such as a cyclic tertiary alkyl group), or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings;
any two L groups may be joined together to form a bidentate Lewis base;
an X group may be joined to an L group to form a monoanionic bidentate group;
any two X groups may be joined together to form a dianionic ligand group.

The foregoing Lewis base catalyst can also be represented by the structure shown below in Formula (II):

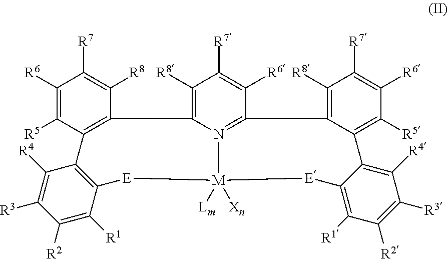

wherein:
M is a group 3, 4, 5, or 6 transition metal or a Lanthanide (such as Hf, Zr or Ti);
E and E′ are each independently O, S, or NR⁹, where R⁹ is independently hydrogen, C₁-C₄₀ hydrocarbyl, C₁-C₄₀ substituted hydrocarbyl, or a heteroatom-containing group, preferably O, preferably both E and E′ are O;
each L is independently a Lewis base;
each X is independently an anionic ligand;
n is 1, 2 or 3;
m is 0, 1, or 2;
n+m is not greater than 4;
each of R¹, R², R³, R⁴, R^{1′}, R^{2′}, R^{3′}, and R^{4′} is independently hydrogen, C₁-C₄₀ hydrocarbyl, C₁-C₄₀ substituted hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings;
any two L groups may be joined together to form a bidentate Lewis base;
an X group may be joined to an L group to form a monoanionic bidentate group;
any two X groups may be joined together to form a dianionic ligand group;
each of R⁵, R⁶, R⁷, R⁸, R^{5′}, R^{6′}, R^{7′}; R^{8′}, R¹⁰, R¹¹, and R¹² is independently hydrogen, C₁-C₄₀ hydrocarbyl, C₁-C₄₀ substituted hydrocarbyl, a heteroatom or a heteroatom-containing group, or one or more of R⁵ and R⁶, R⁶ and R⁷, R⁷ and R⁸, R^{5′} and R^{6′}, R^{6′} and R^{7′}, R^{7′} and R^{8′}, R¹⁰ and R¹¹, or R¹¹ and R¹² may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings.

The metal, M, is preferably selected from group 3, 4, 5, or 6 elements, more preferably group 4. Most preferably the metal, M, is zirconium or hafnium.

The donor atom Q of the neutral heterocyclic Lewis base (in Formula (I)) is preferably nitrogen, carbon, or oxygen. Preferably Q is nitrogen.

Non-limiting examples of neutral heterocyclic Lewis base groups include derivatives of pyridine, pyrazine, pyrimidine, triazine, thiazole, imidazole, thiophene, oxazole, thiazole, furan, and substituted variants of thereof. Preferred heterocyclic Lewis base groups include derivatives of pyridine, pyrazine, thiazole, and imidazole.

Each A¹ and A^{1′} of the heterocyclic Lewis base (in formula I) are independently C, N, or C(R²²), where R²² is selected from hydrogen, C₁-C₂₀ hydrocarbyl, and C₁-C₂₀ substituted hydrocarbyl. Preferably A¹ and A^{1′} are carbon. When Q is carbon, it is preferred that A¹ and A^{1′} be selected from nitrogen and C(R²²). When Q is nitrogen, it is preferred that A¹ and A^{1′} be carbon. It is preferred that Q=nitrogen, and A¹=A^{1′}=carbon. When Q is nitrogen or oxygen, is preferred that the heterocyclic Lewis base in Formula (I) not have any hydrogen atoms bound to the A¹ or A^{1′} atoms. This is preferred because it is thought that hydrogens in those positions may undergo unwanted decomposition reactions that reduce the stability of the catalytically active species.

The heterocyclic Lewis base (of formula I) represented by A¹QA^{1′} combined with the curved line joining A¹ and A^{1′} is preferably selected from the following, with each R²³ group selected from hydrogen, heteroatoms, C₁-C₂₀ alkyls, C₁-C₂₀ alkoxides, C₁-C₂₀ amides, and C₁-C₂₀ substituted alkyls.

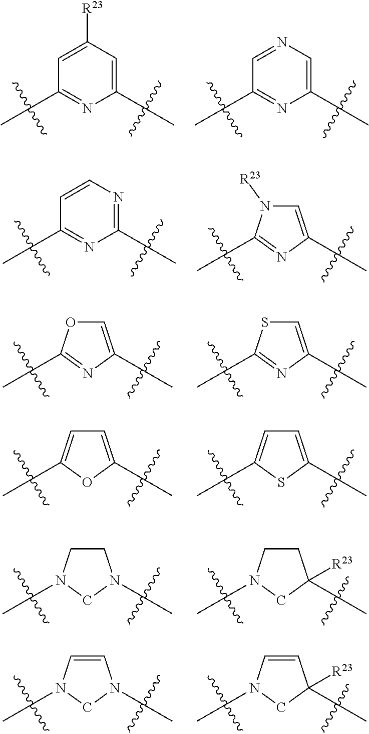

In some embodiments, the heterocyclic Lewis base (of Formula (I)) represented by A¹QA^{1′} combined with the curved line joining A¹ and A^{1′} is a six membered ring containing one ring heteroatom with Q being the ring heteroatom, or a five membered ring containing one or two ring heteroatoms but with Q being a ring carbon. Alternately, the heterocyclic Lewis base (of Formula (I)) represented by A¹QA^{1′} combined with the curved line joining A¹ and A^{1′} is not a five membered ring containing one or more ring heteroatoms with Q being a ring heteroatom.

In Formula (I) or (II), E and E′ are each selected from oxygen or NR⁹, where R⁹ is independently hydrogen, C₁-C₄₀ hydrocarbyl, C₁-C₄₀ substituted hydrocarbyl, or a heteroatom-containing group. It is preferred that E and E′ are oxygen. When E and/or E′ are NR⁹ it is preferred that R⁹ be selected from C₁ to C₂₀ hydrocarbyls, alkyls, or aryls. In one embodiment E and E′ are each selected from O, S, or N(alkyl) or N(aryl), where the alkyl is preferably a C₁ to C₂₀ alkyl, such as methyl, ethyl, propyl, butyl, pentyl, hexyl, octyl, nonyl, decyl, undecyl, dodceyl and the like, and aryl is a C₆ to C₄₀ aryl group, such as phenyl, naphthalenyl, benzyl, methylphenyl, and the like.

In embodiments, A³ [symbol] A² and A^{2′} [symbol] A^{3′} are independently a divalent hydrocarbyl group, such as C₁ to C₁₂ hydrocarbyl group.

In complexes of Formula (I) or (II), when E and E′ are oxygen it is advantageous that each phenolate group be substituted in the position that is next to the oxygen atom (i.e. R¹ and R^{1′} in Formula (I) or (II)). Thus, when E and E′ are oxygen it is preferred that each of R¹ and R^{1′} is independently a C₁-C₄₀ hydrocarbyl, a C₁-C₄₀ substituted hydrocarbyl, a heteroatom or a heteroatom-containing group, more preferably, each of R¹ and R^{1′} is independently a non-aromatic cyclic alkyl group with one or more five-or six-membered rings (such as cyclohexyl, cyclooctyl, adamantanyl, or 1-methylcyclohexyl, or substituted adamantanyl), most preferably a non-aromatic cyclic tertiary alkyl group (such as 1-methylcyclohexyl, adamantanyl, or substituted adamantanyl).

In some embodiments of the invention of Formula (I) or (II), each of R¹ and R^{1′} is independently a tertiary hydrocarbyl group. In other embodiments of the invention of Formula (I) or (II), each of R¹ and R^{1′} is independently a cyclic tertiary hydrocarbyl group. In other embodiments of the invention of Formula (I) or (II), each of R¹ and R^{1′} is independently a polycyclic tertiary hydrocarbyl group.

In some embodiments of the invention of Formula (I) or (II), each of R¹ and R^{1′} is independently a tertiary hydrocarbyl group. In other embodiments of the invention of Formula (I) or (II), each of R¹ and R^{1′} is independently a cyclic tertiary hydrocarbyl group. In other embodiments of the invention of Formula (I) or (II), each of R¹ and R^{1′} is independently a polycyclic tertiary hydrocarbyl group.

The linker groups (i.e. A³ [symbol] A² and A^{2′} [symbol] A^{3′} in Formula (I)) are each preferably part of an ortho-phenylene group, preferably a substituted ortho-phenylene group. It is preferred for the R⁷ and R^{7′} positions of Formula (II) to be hydrogen, or C₁ to C₂₀ alkyl, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, or an isomer thereof, such as iospropyl, etc. For applications targeting polymers with high tacticity it is preferred for the R⁷ and R^{7′} positions of Formula (II) to be a C₁ to C₂₀ alkyl, most preferred for both R⁷ and R^{7′} to be a C₁ to C₃ alkyl.

In embodiments of Formula (I) herein, Q is C, N or O, preferably Q is N.

In embodiments of Formula (I) herein, A¹ and A^{1′} are independently carbon, nitrogen, or C(R²²), with R²² selected from hydrogen, C₁-C₂₀ hydrocarbyl, C₁-C₂₀ substituted hydrocarbyl. Preferably A¹ and A^{1′} are carbon.

In embodiments of Formula (I) herein, A¹QA^{1′} in Formula (I) is part of a heterocyclic Lewis base, such as a pyridine, pyrazine, pyrimidine, triazine, thiazole, imidazole, thiophene, oxazole, thiazole, furan, or a substituted variant of thereof.

In embodiments of Formula (I) herein, A¹QA^{1′} are part of a heterocyclic Lewis base containing 2 to 20 non-hydrogen atoms that links A² to A^{2′} via a 3-atom bridge with Q being the central atom of the 3-atom bridge. Preferably each A¹ and A^{1′} is a carbon atom and the A¹QA^{1′} fragment forms part of a pyridine, pyrazine, pyrimidine, triazine, thiazole, imidazole, thiophene, oxazole, thiazole, furan, or a substituted variant of thereof group, or a substituted variant thereof.

In one embodiment of Formula (I) herein, Q is carbon, and each A¹ and A^{1′} is N or C(R²²), where R²² is selected from hydrogen, C₁-C₂₀ hydrocarbyl, C₁-C₂₀ substituted hydrocarbyl, a heteroatom or a heteroatom-containing group. In this embodiment, the A¹QA^{1′} fragment forms part of a cyclic carbene, N-heterocyclic carbene, cyclic amino alkyl carbene, or a substituted variant of thereof group, or a substituted variant thereof.

In embodiments of Formula (I) herein, A³ [symbol] A² is a divalent group containing 2 to 20 non-hydrogen atoms that links A¹ to the E-bonded aryl group via a 2-atom bridge, where the A³ [symbol] A² is a linear alkyl or forms part of a cyclic group (such as an optionally substituted ortho-phenylene group, or ortho-arylene group) or a substituted variant thereof.

A^{2′} [symbol] A^{3′} is a divalent group containing 2 to 20 non-hydrogen atoms that links A^{1′} to the E′-bonded aryl group via a 2-atom bridge, where the A^{2′} [symbol] A^{3′} is a linear alkyl or forms part of a cyclic group (such as an optionally substituted ortho-phenylene group, or ortho-arylene group or, or a substituted variant thereof.

In embodiments of the invention herein, in Formula (I) and (II), M is a group 4 metal, such as Hf or Zr.

In embodiments of the invention herein, in Formula (I) and (II), E and E′ are O.

In embodiments of the invention herein, in Formula (I) and (II), R¹, R², R³, R⁴, R^{1′}, R^{2′}, R^{3′}, and R^{4′} is independently hydrogen, C₁-C₄₀ hydrocarbyl, C₁-C₄₀ substituted hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings, preferably hydrogen, methyl, ethyl, propyl, butyl, pentyl, hexyl, or an isomer thereof.

In embodiments of the invention herein, in Formula (I) and (II), R¹, R², R³, R⁴, R^{1′}, R^{2′}, R^{3′}, R^{4′} and R⁹ are independently selected from methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthalenyl, cyclohexyl, cyclohexenyl, methylcyclohexyl, and isomers thereof.

In embodiments of the invention herein, in Formula (I) and (II), R⁴ and R^{4′} is independently hydrogen or a C₁ to C₃ hydrocarbyl, such as methyl, ethyl or propyl.

In embodiments of the invention herein, in Formula (I) and (II), R⁹ is hydrogen, C₁-C₄₀ hydrocarbyl, C₁-C₄₀ substituted hydrocarbyl, or a heteroatom-containing group, preferably hydrogen, methyl, ethyl, propyl, butyl, pentyl, hexyl, or an isomer thereof. Preferably R⁹ is methyl, ethyl, propyl, butyl, C₁ to C₆ alkyl, phenyl, 2-methylphenyl, 2,6-dimethylphenyl, or 2,4,6-trimethylphenyl.

In embodiments of the invention herein, in Formula (I) and (II), each X is, independently, selected from the group consisting of hydrocarbyl radicals having from 1 to 20 carbon atoms (such as alkyls or aryls), hydrides, amides, alkoxides, sulfides, phosphides, halides, alkyl sulfonates, and a combination thereof, (two or more X's may form a part of a fused ring or a ring system), preferably each X is independently selected from halides, aryls, and C₁ to C₅ alkyl groups, preferably each X is independently a hydrido, dimethylamido, diethylamido, methyltrimethylsilyl, neopentyl, phenyl, benzyl, methyl, ethyl, propyl, butyl, pentyl, fluoro, iodo, bromo, or chloro group.

Alternatively, each X may be, independently, a halide, a hydride, an alkyl group, an alkenyl group or an arylalkyl group.

In embodiments of the invention herein, in Formula (I) and (II), each L is a Lewis base, independently, selected from the group consisting of ethers, thio-ethers, amines, nitriles, imines, pyridines, halocarbons, and phosphines, preferably ethers and thioethers, and a combination thereof, optionally two or more L's may form a part of a fused ring or a ring system, preferably each L is independently selected from ether and thioether groups, preferably each L is a ethyl ether, tetrahydrofuran, dibutyl ether, or dimethylsulfide group.

In embodiments of the invention herein, in Formula (I) and (II), R1 and R1′ are independently cyclic tertiary alkyl groups.

In embodiments of the invention herein, in Formula (I) and (II), n is 1, 2 or 3, typically 2.

In embodiments of the invention herein, in Formula (I) and (II), m is 0, 1 or 2, typically 0. In embodiments of the invention herein, in Formula (I) and (II), R¹ and R^{1′} are not hydrogen.

In embodiments of the invention herein, in Formula (I) and (II), M is Hf or Zr, E and E′ are O; each of R¹ and R^{1′} is independently a C₁-C₄₀ hydrocarbyl, a C₁-C₄₀ substituted hydrocarbyl, a heteroatom or a heteroatom-containing group, each R², R³, R⁴, R^{2′}, R^{3′}, and R^{4′} is independently hydrogen, C₁-C₂₀ hydrocarbyl, C₁-C₂₀ substituted hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings; each X is, independently, selected from the group consisting of hydrocarbyl radicals having from 1 to 20 carbon atoms (such as alkyls or aryls), hydrides, amides, alkoxides, sulfides, phosphides, halides, and a combination thereof, (two or more X's may form a part of a fused ring or a ring system); each L is, independently, selected from the group consisting of ethers, thioethers, and halo carbons (two or more L's may form a part of a fused ring or a ring system).

In embodiments of the invention herein, in Formula (II), each of R⁵, R⁶, R⁷, R⁸, R^{5′}, R^{6′}, R^{7′}, R^{8′}, R¹⁰, R¹¹ and R¹² is independently hydrogen, C₁-C₄₀ hydrocarbyl, C₁-C₄₀ substituted hydrocarbyl, a heteroatom or a heteroatom-containing group, or one or more adjacent R groups may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings.

In embodiments of the invention herein, in Formula (II), each of R⁵, R⁶, R⁷, R⁸, R^{5′}, R^{6′}, R^{7′}, R^{8′}, R¹⁰, R¹¹ and R¹² is independently hydrogen, methyl, ethyl, propyl, butyl, pentyl, hexyl, or an isomer thereof.

In embodiments of the invention herein, in Formula (II), each of R⁵, R⁶, R⁷, R⁸, R^{5′}, R^{6′}, R^{7′}, R^{8′}, R¹⁰, R¹¹ and R¹² is are independently selected from methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthalenyl, cyclohexyl, cyclohexenyl, methylcyclohexyl, and isomers thereof.

In embodiments of the invention herein, in Formula (II), M is Hf or Zr, E and E′ are O; each of R¹ and R^{1′} is independently a C₁-C₄₀ hydrocarbyl, a C₁-C₄₀ substituted hydrocarbyl, a heteroatom or a heteroatom-containing group,
each R¹, R², R³, R⁴, R^{1′}, R^{2′}, R^{3′}, and R^{4′} is independently hydrogen, C₁-C₂₀ hydrocarbyl, C₁-C₂₀ substituted hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings; R⁹ is hydrogen, C₁-C₂₀ hydrocarbyl, C₁-C₂₀ substituted hydrocarbyl, or a heteroatom-containing group, such as hydrogen, methyl, ethyl, propyl, butyl, pentyl, hexyl, or an isomer thereof, and
each X is, independently, selected from the group consisting of hydrocarbyl radicals having from 1 to 20 carbon atoms (such as alkyls or aryls), hydrides, amides, alkoxides, sulfides, phosphides, halides, dienes, amines, phosphines, ethers, and a combination thereof, (two or more X's may form a part of a fused ring or a ring system); n is 2; m is 0; and each of R⁵, R⁶, R⁷, R⁸, R^{5′}, R^{6′}, R^{7′}, R^{8′}, R¹⁰, R¹¹ and R¹² is independently hydrogen, C₁-C₂₀ hydrocarbyl, C₁-C₂₀ substituted hydrocarbyl, a heteroatom or a heteroatom-containing group, or one or more adjacent R groups may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings, such as each of R⁵, R⁶, R⁷, R⁸, R^{5′}, R^{6′}, R^{7′}, R^{8′}, R¹⁰, R¹¹ and R¹² is are independently selected from methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthyl, cyclohexyl, cyclohexenyl, methylcyclohexyl, and isomers thereof.

Preferred embodiment of Formula (I) is M is Zr or Hf, Q is nitrogen, both A¹ and A^{1′} are carbon, both E and E′ are oxygen, and both R¹ and R^{1′} are C₄-C₂₀ cyclic tertiary alkyls.

Preferred embodiment of Formula (I) is M is Zr or Hf, Q is nitrogen, both A¹ and A^{1′} are carbon, both E and E′ are oxygen, and both R¹ and R^{1′} are adamantan-1-yl or substituted adamantan-1-yl.

Preferred embodiment of Formula (I) is M is Zr or Hf, Q is nitrogen, both A¹ and A^{1′} are carbon, both E and E′ are oxygen, and both R¹ and R^{1′} are C₆-C₂₀ aryls.

Preferred embodiment of Formula (II) is M is Zr or Hf, both E and E′ are oxygen, and both R¹ and R^{1′} are C₄-C₂₀ cyclic tertiary alkyls.

Preferred embodiment of Formula (II) is M is Zr or Hf, both E and E′ are oxygen, and both R¹ and R^{1′} are adamantan-1-yl or substituted adamantan-1-yl.

Preferred embodiment of Formula (II) is M is Zr or Hf, both E and E′ are oxygen, and each of R¹, R^{1′}, R³ and R^{3′} are adamantan-1-yl or substituted adamantan-1-yl.

Preferred embodiment of Formula (II) is M is Zr or Hf, both E and E′ are oxygen, both R¹ and R^{1′} are C₄-C₂₀ cyclic tertiary alkyls, and both R⁷ and R^{7′} are C₁-C₂₀ alkyls.

Catalyst compounds that are particularly useful in this invention include one or more of: dimethylzirconium[2′,2′″-(pyridine-2,6-diyl)bis(3-adamantan-1-yl)-5-(tert-butyl)-[1,1′-biphenyl]-2-olate)], dimethylhafnium[2′,2′″-(pyridine-2,6-diyl)bis(3-adamantan-1-yl)-5-(tert-butyl)-[1,1′-biphenyl]-2-olate)], dimethylzirconium[6,6′-(pyridine-2,6-diylbis(benzo[b]thiophene-3,2-diyl))bis(2-adamantan-1-yl)-4-methylphenolate)], dimethylhafnium[6,6′-(pyridine-2,6-diylbis(benzo[b]thiophene-3,2-diyl))bis(2-adamantan-1-yl)-4-methylphenolate)], dimethylzirconium[2′,2′″-(pyridine-2,6-diyl)bis(3-((3r,5r,7r)-adamantan-1-yl)-5-methyl-[1,1′-biphenyl]-2-olate)], dimethylhafnium[2′,2′″-(pyridine-2,6-diyl)bis(3-((3r,5r,7r)-adamantan-1-yl)-5-methyl-[1,1′-biphenyl]-2-olate)], dimethylzirconium[2′,2′″-(pyridine-2,6-diyl)bis(3-((3r,5r,7r)-adamantan-1-yl)-4′,5-dimethyl-[1,1′-biphenyl]-2-olate)], dimethylhafnium[2′,2′″-(pyridine-2,6-diyl)bis(3-((3r,5r,7r)-adamantan-1-yl)-4′,5-dimethyl-[1,1′-biphenyl]-2-olate)].

Catalyst compounds that are particularly useful include those represented by one or more of the following complexes:

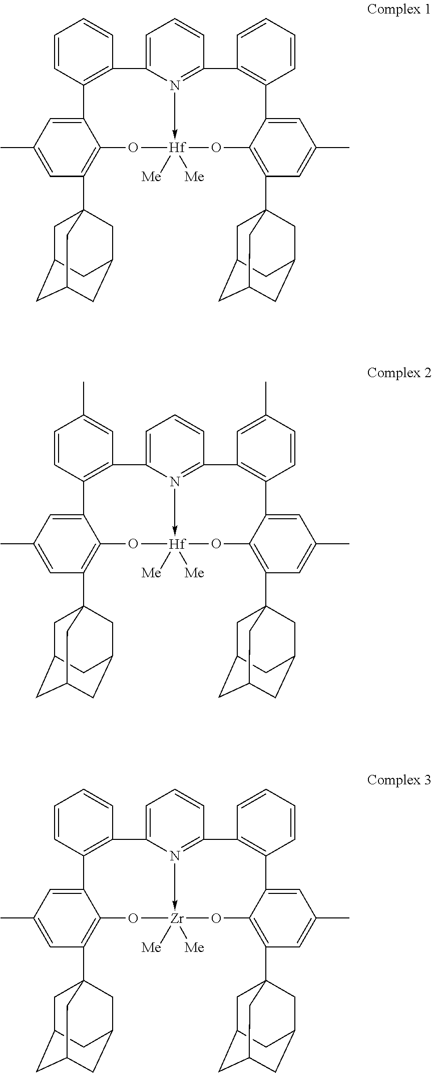

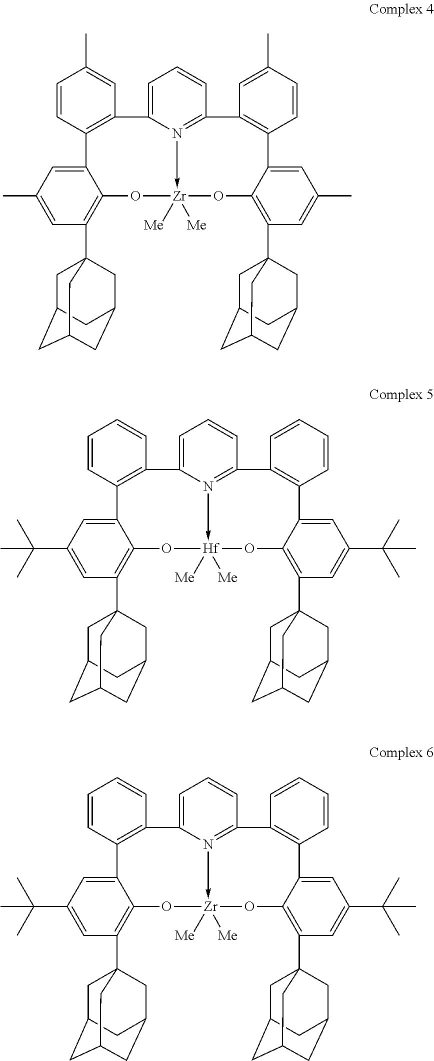

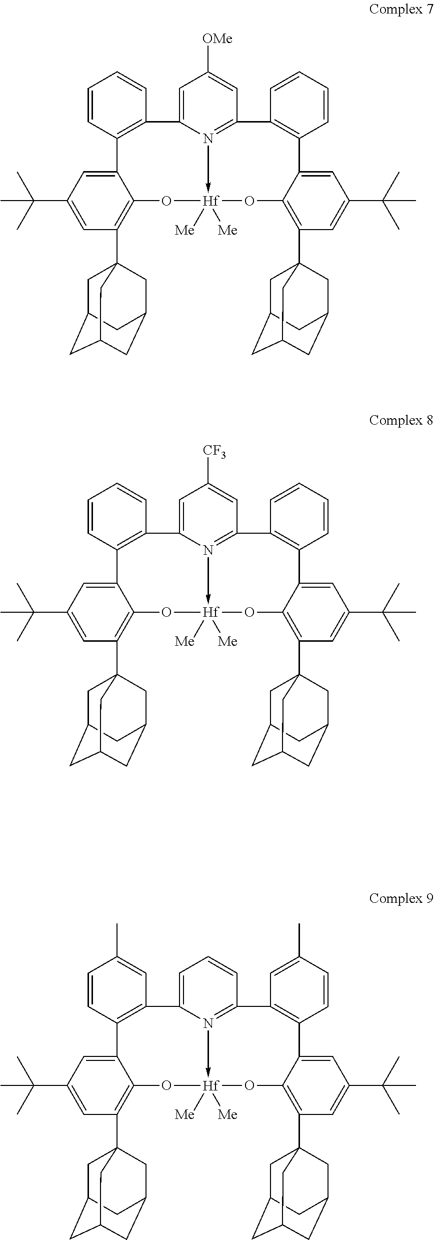

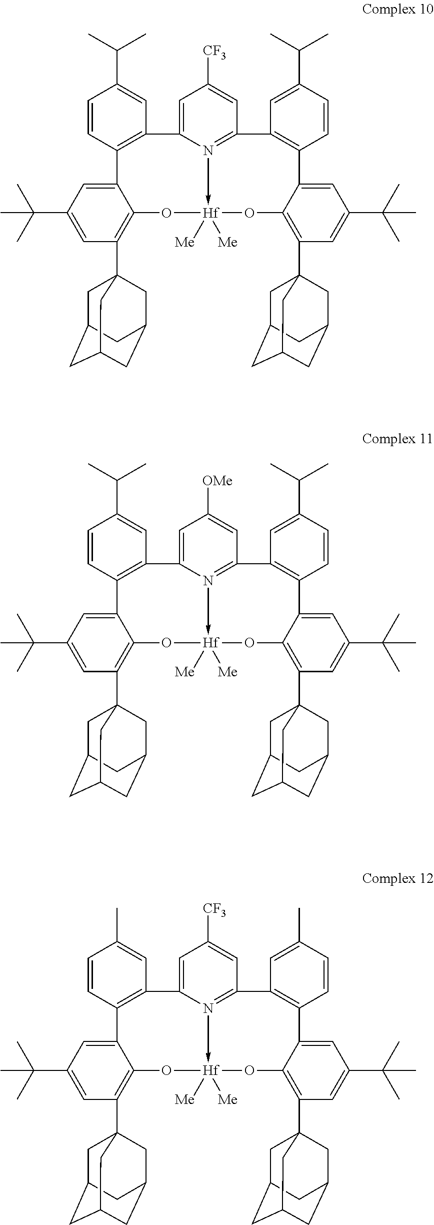

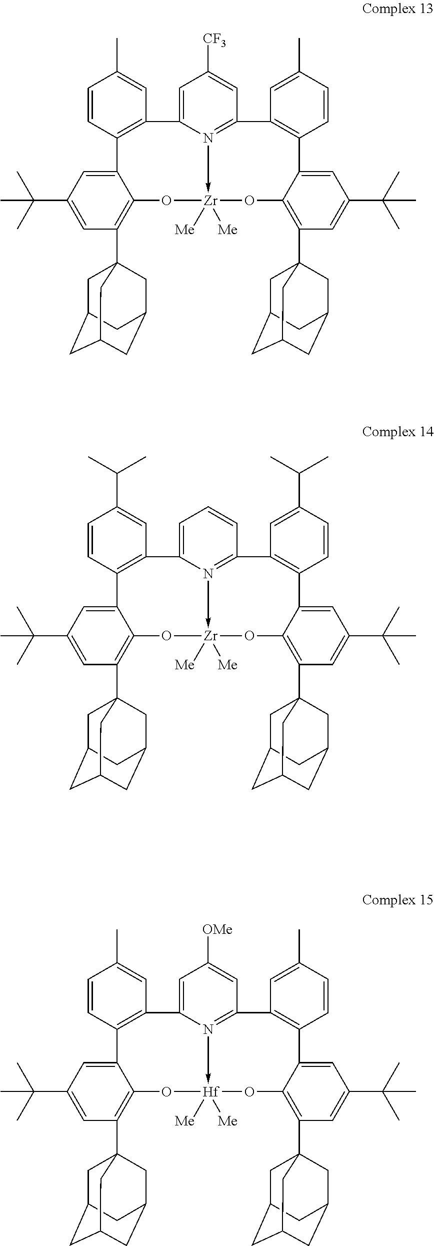

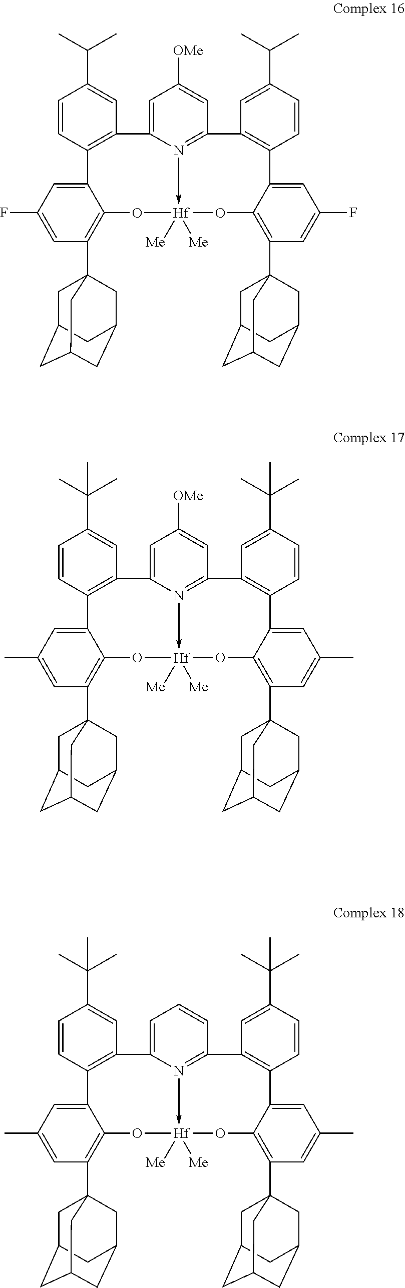

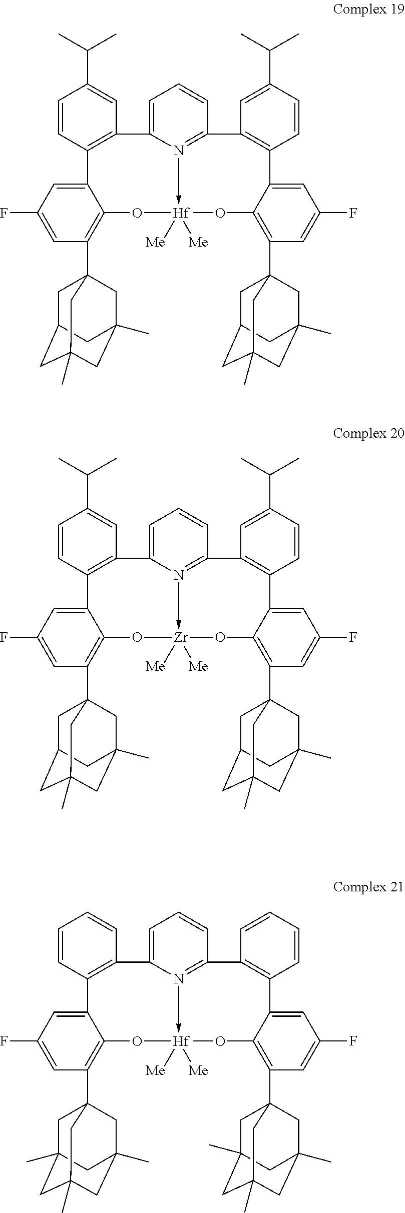

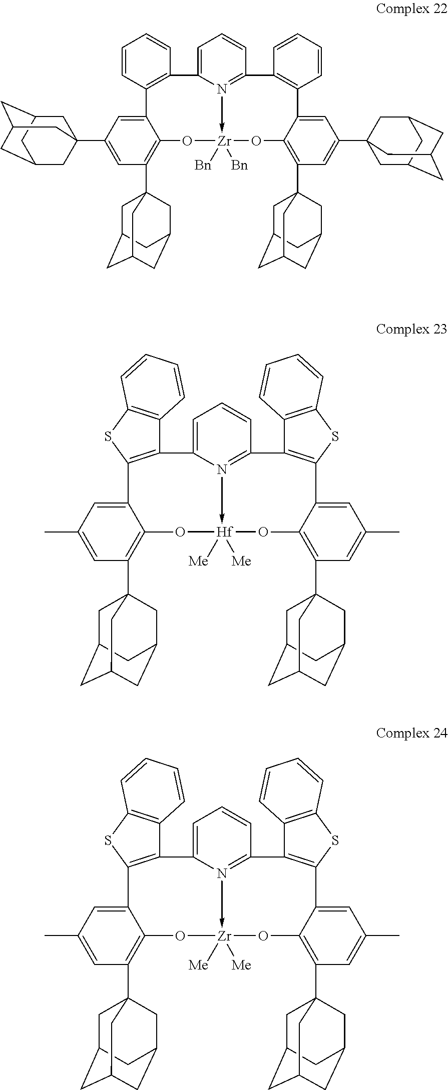

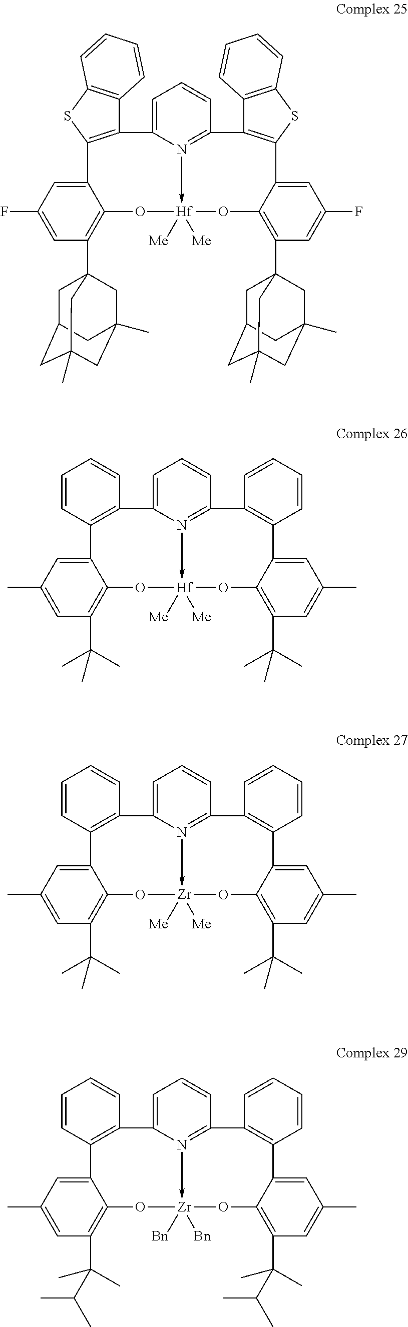

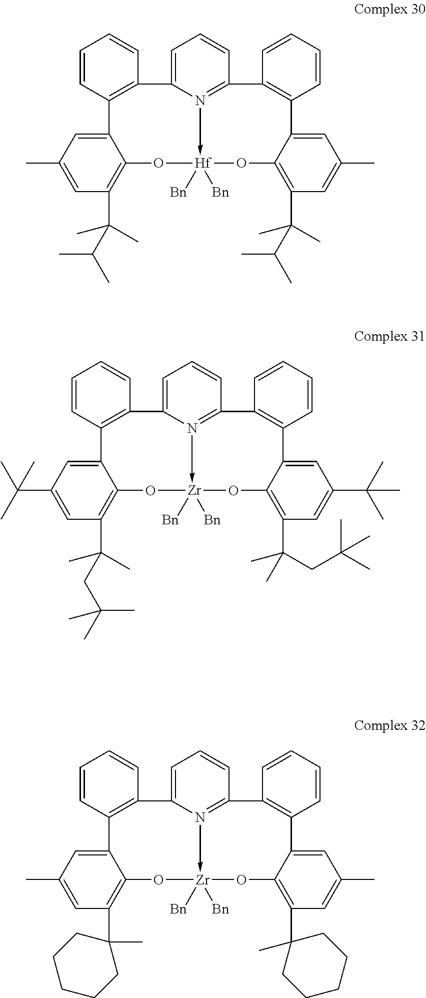

### Metallocene Catalysts

Suitable metallocene catalyst compounds can be transition metal catalyst compounds having one, two or three, typically one or two, substituted or unsubstituted cyclopentadienyl ligands (such as substituted or unsubstituted Cp, Ind or Flu) bound to the transition metal. Metallocene catalyst compounds as used herein include metallocenes comprising Group 3 to Group 12 metal complexes, such as, Group 4 to Group 6 metal complexes, for example, Group 4 metal complexes. The metallocene catalyst compound of catalyst systems of the present disclosure may be unbridged metallocene catalyst compounds represented by the formula: Cp^{A}Cp^{B}M′X′ₙ, wherein each Cp^{A} and Cp^{B} is independently selected from cyclopentadienyl ligands (for example, Cp, Ind, or Flu) and ligands isolobal to cyclopentadienyl, one or both Cp^{A} and Cp^{B} may contain heteroatoms, and one or both Cp^{A} and Cp^{B} may be substituted by one or more R″ groups; M′ is selected from Groups 3 through 12 atoms and lanthanide Group atoms; X′ is an anionic leaving group; n is 0 or an integer from 1 to 4; each R″ is independently selected from alkyl, substituted alkyl, heteroalkyl, alkenyl, substituted alkenyl, heteroalkenyl, alkynyl, substituted alkynyl, heteroalkynyl, alkoxy, aryloxy, alkylthio, arylthio, aryl, substituted aryl, heteroaryl, aralkyl, aralkylene, alkaryl, alkarylene, haloalkyl, haloalkenyl, haloalkynyl, heteroalkyl, heterocycle, heteroaryl, a heteroatom-containing group, hydrocarbyl, substituted hydrocarbyl, heterohydrocarbyl, silyl, boryl, phosphino, phosphine, amino, amine, ether, and thioether.

In at least one embodiment, each Cp^{A} and Cp^{B} is independently selected from cyclopentadienyl, indenyl, fluorenyl, indacenyl, tetrahydroindenyl, cyclopentaphenanthreneyl, benzindenyl, fluorenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7-H-dibenzofluorenyl, indeno[1,2-9]anthrene, thiophenoindenyl, thiophenofluorenyl, hydrogenated and substituted versions thereof. Each Cp^{A} and Cp^{B} may independently be indacenyl or tetrahydroindenyl.

The metallocene catalyst compound may be a bridged metallocene catalyst compound represented by the formula: Cp^{A}(T)Cp^{B}M′X′ₙ, wherein each Cp^{A} and Cp^{B} is independently selected from cyclopentadienyl ligands (for example, Cp, Ind, or Flu) and ligands isolobal to cyclopentadienyl, where onene or both Cp^{A} and Cp^{B} may contain heteroatoms, and one or both Cp^{A} and Cp^{B} may be substituted by one or more R″ groups; M′ is selected from Groups 3 through 12 atoms and lanthanide Group atoms, preferably Group 4; X′ is an anionic leaving group; n is 0 or an integer from 1 to 4; (T) is a bridging group selected from divalent alkyl, divalent substituted alkyl, divalent heteroalkyl, divalent alkenyl, divalent substituted alkenyl, divalent heteroalkenyl, divalent alkynyl, divalent substituted alkynyl, divalent heteroalkynyl, divalent alkoxy, divalent aryloxy, divalent alkylthio, divalent arylthio, divalent aryl, divalent substituted aryl, divalent heteroaryl, divalent aralkyl, divalent aralkylene, divalent alkaryl, divalent alkarylene, divalent haloalkyl, divalent haloalkenyl, divalent haloalkynyl, divalent heteroalkyl, divalent heterocycle, divalent heteroaryl, a divalent heteroatom-containing group, divalent hydrocarbyl, divalent substituted hydrocarbyl, divalent heterohydrocarbyl, divalent silyl, divalent boryl, divalent phosphino, divalent phosphine, divalent amino, divalent amine, divalent ether, divalent thioether. R″ is selected from alkyl, substituted alkyl, heteroalkyl, alkenyl, substituted alkenyl, heteroalkenyl, alkynyl, substituted alkynyl, heteroalkynyl, alkoxy, aryloxy, alkylthio, arylthio, aryl, substituted aryl, heteroaryl, aralkyl, aralkylene, alkaryl, alkarylene, haloalkyl, haloalkenyl, haloalkynyl, heteroalkyl, heterocycle, heteroaryl, a heteroatom-containing group, hydrocarbyl, substituted hydrocarbyl, heterohydrocarbyl, silyl, boryl, phosphino, phosphine, amino, amine, germanium, ether, and thioether.

In at least one embodiment, each of Cp^{A} and Cp^{B} is independently selected from cyclopentadienyl, indenyl, fluorenyl, cyclopentaphenanthreneyl, benzindenyl, fluorenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7-H-dibenzofluorenyl, indeno[1,2-9]anthrene, thiophenoindenyl, thiophenofluorenyl, hydrogenated, and substituted versions thereof, preferably cyclopentadienyl, n-propylcyclopentadienyl, indenyl, pentamethylcyclopentadienyl, tetramethylcyclopentadienyl, and n-butylcyclopentadienyl. Each Cp^{A} and Cp^{B} may independently be indacenyl or tetrahydroindenyl.

(T) is a bridging group containing at least one Group 13, 14, 15, or 16 element, in particular boron or a Group 14, 15 or 16 element, preferably (T) is O, S, NR′, or SiR′₂, where each R′ is independently hydrogen or C₁-C₂₀ hydrocarbyl.

### Half-Metallocene

In another embodiment, the metallocene catalyst compound can be a half-metallocene represented by the formula:

T_{y}CpₘMGₙX_{q}

where Cp is independently a substituted or unsubstituted cyclopentadienyl ligand (for example, substituted or unsubstituted Cp, Ind, or Flu) or substituted or unsubstituted ligand isolobal to cyclopentadienyl; M is a Group 4 transition metal; G is a heteroatom group represented by the formula JR*_{z} where J is N, P, O or S, and R* is a linear, branched, or cyclic C₁-C₂₀ hydrocarbyl; z is 1 or 2; T is a bridging group; y is 0 or 1; X is a leaving group; m=1, n=1, 2 or 3, q=0, 1, 2 or 3, and the sum of m+n+q is equal to the coordination number of the transition metal.

In at least one embodiment, J is N, and R* is methyl, ethyl, propyl, butyl, pentyl, hexyl, heptyl, octyl, nonyl, cyclooctyl, cyclododecyl, decyl, undecyl, dodecyl, adamantyl or an isomer thereof.

In at least one embodiment, the catalyst compound is represented by formula (II) or formula (III):

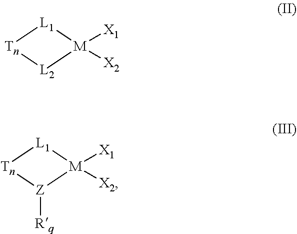

wherein in each of formula (II) and formula (III):
M is the metal center, and is a Group 4 metal, such as titanium, zirconium or hafnium, such as zirconium or hafnium when L₁ and L₂ are present and titanium when Z is present;
n is 0 or 1;
T is an optional bridging group which, if present, is a bridging group containing at least one Group 13, 14, 15, or 16 element, in particular boron or a Group 14, 15 or 16 element (preferably T is selected from dialkylsilyl, diarylsilyl, dialkylmethyl, ethylenyl (—CH₂—CH₂—) or hydrocarbylethylenyl wherein one, two, three or four of the hydrogen atoms in ethylenyl are substituted by hydrocarbyl, where hydrocarbyl can be independently C₁ to C₁₆ alkyl or phenyl, tolyl, xylyl and the like), and when T is present, the catalyst represented can be in a racemic or a meso form;
L₁ and L₂ are independently cyclopentadienyl, indenyl, tetrahydroindenyl or fluorenyl, optionally substituted, that are each bonded to M, or L₁ and L₂ are independently cyclopentadienyl, indenyl, tetrahydroindenyl or fluorenyl, which are optionally substituted, in which any two adjacent substituents on L¹ and L² are optionally joined to form a substituted or unsubstituted, saturated, partially unsaturated, or aromatic cyclic or polycyclic substituent;
Z is nitrogen, oxygen, sulfur, or phosphorus (preferably nitrogen);
q is 1 or 2 (preferably q is 1 when Z is N);
R′ is a cyclic, linear or branched C₁ to C₄₀ alkyl or substituted alkyl group;
X₁ and X₂ are, independently, hydrogen, halogen, hydride radicals, hydrocarbyl radicals, substituted hydrocarbyl radicals, halocarbyl radicals, substituted halocarbyl radicals, silylcarbyl radicals, substituted silylcarbyl radicals, germylcarbyl radicals, or substituted germylcarbyl radicals; or X₁ and X₂ are joined and bound to the metal atom to form a metallacycle ring containing from about 3 to about 20 carbon atoms; or both together can be an olefin, diolefin or aryne ligand.

Preferably, T in any formula herein is present and is a bridging group containing at least one Group 13, 14, 15, or 16 element, in particular a Group 14 element. Examples of suitable bridging groups include P(═S)R′, P(═Se)R′, P(═O)R′, R′₂C, R′₂Si, R′₂Ge, R′₂CCR′₂, R′₂CCR′₂CR′₂, R′₂CCR′₂CR′₂CR′₂, R′C═CR′, R′C═CR′CR′₂, R′₂CCR′═CR′CR′₂, R′C═CR′CR′═CR′, R′C═CR′CR′₂CR′₂, R′₂CSiR′₂, R′₂SiSiR′₂, R′₂SiOSiR′₂, R′₂CSiR′,CR′₂, R′₂SiCR′₂SiR′₂, R′C═CR′SiR′₂, R′₂CGeR′₂, R′₂GeGeR′₂, R′₂CGeR′₂CR′₂, R′₂GeCR′₂GeR′₂, R′₂SiGeR′₂, R′C═CR′GeR′₂, R′B, R′₂C—BR′, R′₂C—BR′—CR′₂, R′₂C—O—CR′₂, R′₂CR′₂C—O—CR′₂CR′₂, R′₂C—O—CR′₂CR′₂, R′₂C—O—CR′═CR′, R′₂C—S—CR′₂, R′₂CR′₂C—S—CR′₂CR′₂, R′₂C—S—CR′₂CR′₂, R′₂C—S—CR′═CR′, R′₂C—Se—CR′₂, R′₂CR′₂C—Se—CR′₂CR′₂, R′₂C—Se—CR′₂CR′₂, R′₂C—Se—CR′═CR′, R′₂C—N═CR′, R′₂C—NR′—CR′₂, R′₂C—NR′—CR′₂CR′₂, R′₂C—NR′—CR′═CR′, R′₂CR′₂C—NR′—CR′₂CR′₂, R′₂C—P═CR′, R′₂C—PR′—CR′₂, O, S, Se, Te, NR′, PR′, AsR′, SbR′, O—O, S—S, R′N—NR′, R′P—PR′, O—S, O—NR′, O—PR′, S—NR′, S—PR′, and R′N—PR′ where R′ is hydrogen or a C₁-C₂₀ containing hydrocarbyl, substituted hydrocarbyl, halocarbyl, substituted halocarbyl, silylcarbyl or germylcarbyl substituent and optionally two or more adjacent R′ may join to form a substituted or unsubstituted, saturated, partially unsaturated or aromatic, cyclic or polycyclic substituent. Preferred examples for the bridging group T include CH₂, CH₂CH₂, SiMe₂, SiPh₂, SiMePh, Si(CH₂)₃, Si(CH₂)₄, O, S, NPh, PPh, NMe, PMe, NEt, NPr, NBu, PEt, PPr, Me₂SiOSiMe₂, and PBu.

In a preferred embodiment of the invention in any embodiment of any formula described herein, T is represented by the formula R^{a}₂J or (R^{a}₂J)₂, where J is C, Si, or Ge, and each R^{a} is, independently, hydrogen, halogen, C₁ to C₂₀ hydrocarbyl (such as methyl, ethyl, propyl, butyl, pentyl, hexyl, heptyl, octyl, nonyl, decyl, undecyl, or dodecyl) or a C₁ to C₂₀ substituted hydrocarbyl, and two R^{a} can form a cyclic structure including aromatic, partially saturated, or saturated cyclic or fused ring system. Preferably, T is a bridging group comprising carbon or silica, such as dialkylsilyl, preferably T is selected from CH₂, CH₂CH₂, C(CH₃)₂, SiMe₂, SiPh₂, SiMePh, silylcyclobutyl (Si(CH₂)₃), (Ph)₂C, (p-(Et)₃SiPh)₂C, Me₂SiOSiMe_{2,} and cyclopentasilylene (Si(CH₂)₄).

In at least one embodiment, the metallocene or half metallocene catalyst compound has a symmetry that is either C1, C₂ or pseudo C₂ or Cs symmetrical such as the representative catalyst families described below:

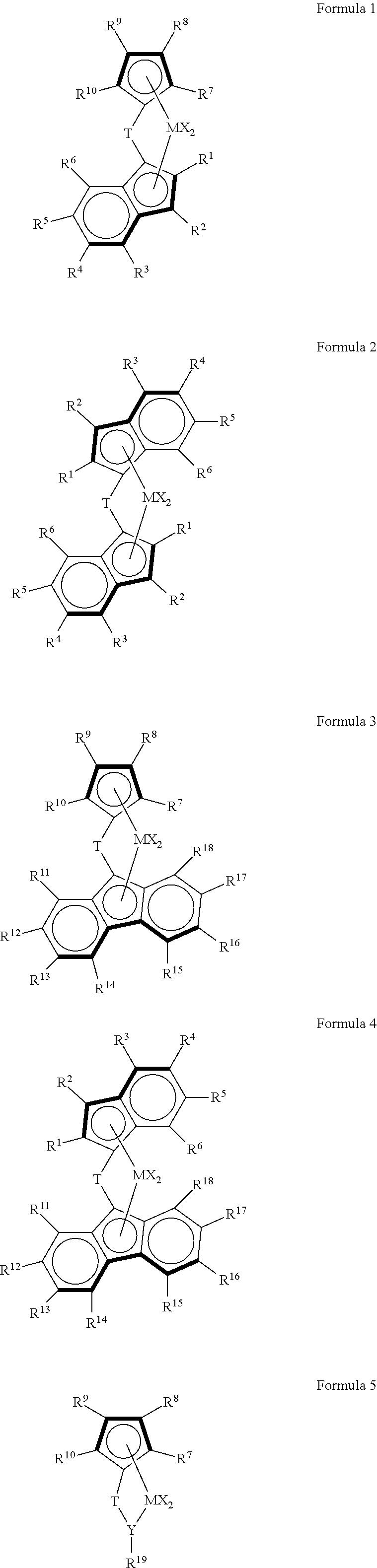

The Cp-indenyl family (Formula 1) broadly described in patent applications WO2014099303 and WO2017069854, U.S. Pat. No. 9,266,910B2 and WO202134459A1 where M=Ti, Zr, Hf, R¹-R¹⁰ can each independently be hydride, a C1-C60 alkyl, cycloalkyl, aryl, heteroalkyl or heteroaryl. Adjacent groups can optionally be fused to form a C5-C20 cyclic ring. T is a bridging group comprising carbon or silicon, such as dialkylsilyl, preferably T is selected from CH₂, CH₂CH₂, C(CH₃)₂, SiMe₂, SiPh₂, SiMePh, silylcyclobutyl (Si(CH₂)₃), (Ph)₂C, (p-(Et)₃SiPh)₂C, Me₂SiOSiMe_{2,} and cyclopentasilylene (Si(CH₂)₄) and X is, independently, hydrogen, halogen, hydride radicals, hydrocarbyl radicals, substituted hydrocarbyl radicals, halocarbyl radicals, substituted halocarbyl radicals, silylcarbyl radicals, substituted silylcarbyl radicals, germylcarbyl radicals, or substituted germylcarbyl radicals; or X₁ and X₂ are joined and bound to the metal atom to form a metallacycle ring containing from about 3 to about 20 carbon atoms; or both together can be an olefin, diolefin or aryne ligand. Most preferably, R⁷-R¹⁰ and R¹ are methyl and R³ is aryl or substituted aryl or heteroaryl group.

The bis-indenyl family (Formula 2) broadly described in the following references of interest include U.S. Pat. Nos. 9,309,340; 9,266,910; 7,005,491; 6,977,287; 6,780,936; and 5,504,171; WO0202575. U.S. Pat. No. 7,157,591, WO2005105864, US20120149829. US20150025205, WO2016053468, WO2015095188, US Patent Publication Nos. 2004/0087750; 2002/0013440; 2015/0322184 and 2001/0007896; EP Patent Publication Nos. 3441407 and 2402353; PCT Publication Nos. WO 2015/158790; WO 2015/009471; WO 2006/097497; WO 2005/058916; WO 2002/02575; Nifant'ev, I. E. et al. (2011) “Asymmetric ansa-Zirconocenes Containing a 2-Methyl-4-aryltetrahydroindacene Fragment: Synthesis, Structure, and Catalytic Activity in Propylene Polymerization and Copolymerization” Organometallics, 2011, v. 30, pp. 5744-5752; M=Ti, Zr, Hf, R¹-R⁶ can each independently be hydride, a C1-C60 alkyl, cycloalkyl, aryl, heteroalkyl or heteroaryl. R₅ and R⁴ and R₃ and R₄ can optionally be fused to form a C5-C20 cyclic ring. T is a bridging group comprising carbon or silicon, such as dialkylsilyl, preferably T is selected from CH₂, CH₂CH₂, C(CH₃)₂, SiMe₂, SiPh₂, SiMePh, silylcyclobutyl (Si(CH₂)₃), (Ph)₂C, (p-(Et)₃SiPh)₂C, Me₂SiOSiMe_{2,} and cyclopentasilylene (Si(CH₂)₄) and X₁ and X₂ are, independently, hydrogen, halogen, hydride radicals, hydrocarbyl radicals, substituted hydrocarbyl radicals, halocarbyl radicals, substituted halocarbyl radicals, silylcarbyl radicals, substituted silylcarbyl radicals, germylcarbyl radicals, or substituted germylcarbyl radicals; or X₁ and X₂ are joined and bound to the metal atom to form a metallacycle ring containing from about 3 to about 20 carbon atoms; or both together can be an olefin, diolefin or aryne ligand. Most preferably, R₁ is alkyl or hydride, while R₃ is aryl or substituted aryl or heteroaryl group.

The Cp-fluorenyl family (Formula 3) broadly described in JP02173110, U.S. Pat. No. 5,747,406, EP530908 and in Organometallics 2007, 26, 8, 2024-2036, Macromolecular Chemistry and Physics 2014, 215 (21) , 2035-2047 Razavi A. (2013) Syndiotactic Polypropylene: Discovery, Development, and Industrialization via Bridged Metallocene Catalysts. In: Kaminsky W. (eds) Polyolefins: 50 years after Ziegler and Natta II. Advances in Polymer Science, vol 258. Springer, Berlin, Heidelberg. In general, M=Ti, Zr, Hf, R₇-R₁₈ can each independently be hydride, a C1-C60 alkyl, cycloalkyl, aryl, heteroalkyl or heteroaryl. where any of the adjacent groups can be joined to form a cyclic or polycyclic ring. T is a bridging group comprising carbon or silicon, such as dialkylsilyl, preferably T is selected from CH₂, CH₂CH₂, C(CH₃)₂, SiMe₂, SiPh₂, SiMePh, silylcyclobutyl (Si(CH₂)₃), (Ph)₂C, (p-(Et)₃SiPh)₂C, Me₂SiOSiMe_{2,} and cyclopentasilylene (Si(CH₂)₄) and X₁ and X₂ are, independently, hydrogen, halogen, hydride radicals, hydrocarbyl radicals, substituted hydrocarbyl radicals, halocarbyl radicals, substituted halocarbyl radicals, silylcarbyl radicals, substituted silylcarbyl radicals, germylcarbyl radicals, or substituted germylcarbyl radicals; or X₁ and X₂ are joined and bound to the metal atom to form a metallacycle ring containing from about 3 to about 20 carbon atoms; or both together can be an olefin, diolefin or aryne ligand.

The indenyl-fluorenyl family (Formula 4) described in EP754698, Organometallics 2000, 19, 19, 3767-3775 JP 10204112 A JP 10204113 A EP 754698 A2 WO 9920664 A2 KR202005388 and Organometallics (2000), 19(20), 4077-4083. In general, M=Ti, Zr, Hf, R¹-R¹⁸ can each independently be hydride, a C1-C60 alkyl, cycloalkyl, aryl, heteroalkyl or heteroaryl. where any of the adjacent groups can be joined to form a cyclic or polycyclic ring. T is a bridging group comprising carbon or silicon, such as dialkylsilyl, preferably T is selected from CH₂, CH₂CH₂, C(CH₃)₂, SiMe₂, SiPh₂, SiMePh, silylcyclobutyl (Si(CH₂)₃), (Ph)₂C, (p-(Et)₃SiPh)₂C, Me₂SiOSiMe₂ and cyclopentasilylene (Si(CH₂)₄). Most preferably, the bridging group is CH₂CH₂. X₁ and X₂ are, independently, hydrogen, halogen, hydride radicals, hydrocarbyl radicals, substituted hydrocarbyl radicals, halocarbyl radicals, substituted halocarbyl radicals, silylcarbyl radicals, substituted silylcarbyl radicals, germylcarbyl radicals, or substituted germylcarbyl radicals; or X₁ and X₂ are joined and bound to the metal atom.

The CGC-type family (Formula 5) broadly encompasses publications in Chem. Rev. 1998, 98, 2587-2598. WO9827103, WO9942467, WO9715583 and WO2004013149A1. In addition recent publications WO2017192226, KR2019086989 describe other derivatives. Other references of interest involve Journal of Organometallic Chemistry 664 (2002) 5-26, Organometallics 1997, 16, 2879-2885 and JACS 2007, 129, 7327. In general, M=Ti, Zr, Hf, and most preferably Ti. T is a bridging group comprising silicon, such as dialkylsilyl, preferably T is selected from, SiMe₂, SiPh₂, SiMePh, silylcyclobutyl (Si(CH₂)₃) and cyclopentasilylene (Si(CH₂)₄). Y is nitrogen, R⁷-R¹⁰ and R¹⁹ can be alkyl, cycloalkyl, aryl and heteroaryl. R₄-R₅ can optionally be joined to form an indene, tetrahydroindene, tetrahydroindacene or benz[f]indenyl moiety. Alternatively adjacent R⁷-R¹⁰ can be joined separately to form fluorenyl or substituted fluorenyl moiety. X₁ and X₂ are, independently, hydrogen, halogen, hydride radicals, hydrocarbyl radicals, substituted hydrocarbyl radicals, halocarbyl radicals, substituted halocarbyl radicals, silylcarbyl radicals, substituted silylcarbyl radicals, germylcarbyl radicals, or substituted germylcarbyl radicals: or X₁ and X₂ are joined and bound to the metal atom.

In an exemplary embodiment, the catalyst compound is one or more of the single-site metallocene or half-metallocene catalyst compounds selected from the group consisting of Formulas 1-5:

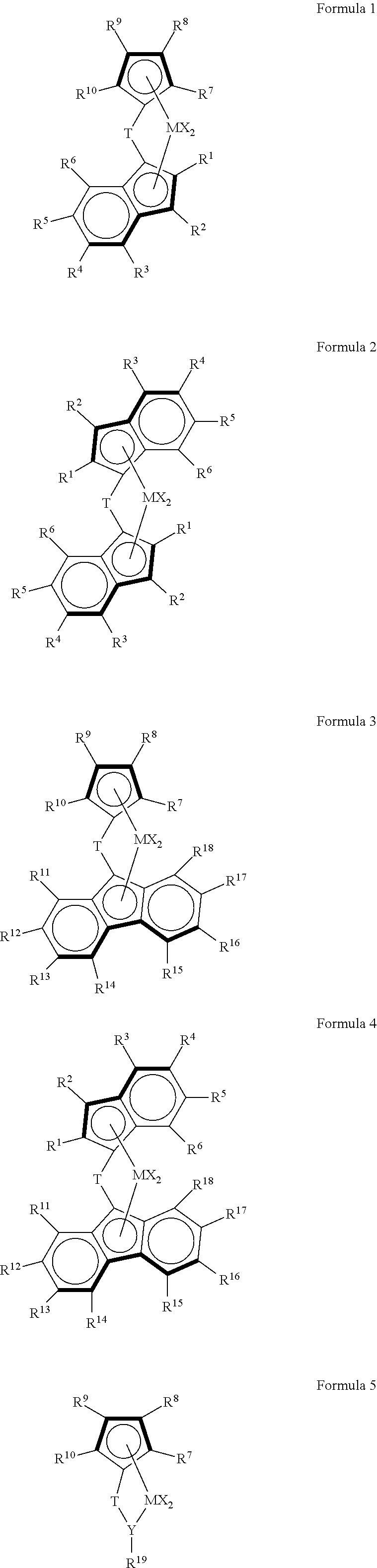

wherein M is a transition metal atom selected from group 3, 4, or 5 of the Periodic Table of Elements; and preferably selected from the group consisting of Ti, Zr, and Hf,
each X is a univalent anionic ligand, or the two Xs are joined and bound to the M to form a metallocycle ring, or the two Xs are joined to form a chelating ligand, a diene ligand, or an alkylidene ligand,
T is a bridging group represented by the formula, (R*2G)g, where each G is C, Si, or Ge, g is 1 or 2, and each R* is, independently, hydrogen, halogen, C₁ to C₂₀ hydrocarbyl or a C₁ to C₂₀ substituted hydrocarbyl, and two or more R* can optionally form a cyclic structure including aromatic, partially saturated, or saturated cyclic or fused ring system, preferably T is selected from the group consisting of R′₂C, R′₂Si, R′₂Ge, R′₂CCR′₂, R′₂CCR′₂CR′₂, R′₂CCR′₂CR′₂CR′₂, R′C═CR′, R′C═CR′CR′₂, R′₂CCR′═CR′CR′₂, R′C═CR′CR′═CR′, R′C═CR′CR′₂CR′₂, R′₂CSiR′₂, R₂CSiR′₂CR′₂, R′₂SiCR′₂SiR′₂, R′C═CR′SiR′₂, R′₂CGeR′₂, R′₂GeGeR′₂, R′₂CGeR′₂CR′₂, R′₂GeCR′₂GeR′₂, R′₂SiGeR′₂, R′C═CR′GeR′₂, R′B, R′₂C—BR′, R′₂C—BR′—CR′₂, R′₂C—O—CR′₂, R′₂CR′₂C—O—CR′₂CR′₂, R′₂C—O—CR′₂CR′₂, R′₂C—O—CR′═CR′, R′₂C—S—CR′₂, R′₂CR′₂C—S—CR′₂CR′₂, R′₂C—S—CR′₂CR′₂, R′₂C—S—CR′═CR′, R′₂C—Se—CR′₂, R′₂CR₂C—Se—CR′₂CR′₂, R′₂C—Se—CR₂CR′₂, R′₂C—Se—CR′═CR′, R′₂C—N═CR′, R′₂C—NR′—CR′₂, R′₂C—NR′—CR′₂CR′₂, R′₂C—NR′—CR′═CR′, R′₂CR′₂C—NR′—CR′₂CR′₂, R′₂C—P═CR′, or R′₂C—PR′—CR′₂ where each R′ is, independently, hydrogen or a C1 to C20 containing hydrocarbyl (such as methyl, ethyl, propyl, butyl, pentyl, hexyl, heptyl, octyl, nonyl, decyl, undecyl, or dodecyl), substituted hydrocarbyl, halocarbyl, substituted halocarbyl, silylcarbyl or germylcarbyl substituent and, optionally, two or more adjacent R′ may join to form a substituted or unsubstituted, saturated, partially unsaturated or aromatic, cyclic or polycyclic substituent, preferably T is a bridging group comprising carbon or silica, such as dialkylsilyl, more preferably T is selected from the group consisting of CH₂, CH₂CH₂, C(CH₃)₂, SiMe₂, SiPh₂SiMePh, silylcyclobutyl (Si(CH₂)₃), (Ph)₂C, (p-(Et)₃SiPh)₂C, and cyclopentasilylene (Si(CH2)4) (Si(CH₂)₄),
R¹, R², R⁴, R5, R¹¹-R¹⁹ are independently a substituted or unsubstituted C₁ to a C₂₀ hydrocarbyl group or hydrogen and any two adjacent R¹, R², R⁴, R5, and R¹¹-R¹⁸ can be joined to form a cyclic structure, wherein R¹ is optionally a primary substituted or unsubstituted C₁-C₁₂ alkyl or hydrogen group such as hydride, methyl, ethyl, propyl, isopropyl, butyl, isobutyl, pentyl, isopentyl, hexyl, cyclopropyl, or cyclohexyl, and
R³ is a substituted or unsubstituted C₁ to a C₂₀ hydrocarbyl, aryl group or hydrogen, more preferably R³ is selected from the group consisting of phenyl, 1-naphthyl, 2-naphthyl, 9-anthracenyl, 2-biphenyl, 3-biphenyl, 4-biphenyl, 2-methylphenyl, 3-methylphenyl, 4-methylphenyl, 2,3-dimethylphenyl, 2,4-dimethylphenyl, 2,5-dimethylphenyl, 2,6-dimethylphenyl, 3,4-dimethylphenyl, 3,5-dimethylphenyl, 2,4,5-trimethylphenyl, 3,4,5-trimethylphenyl, 2,3,4,5,6-pentamethylphenyl, 2-ethylphenyl, 3-ethylphenyl, 4-ethylphenyl, 2,3-diethylphenyl, 2,4-diethylphenyl, 2,5-diethylphenyl, 2,6-diethylphenyl, 3,4-diethylphenyl, 3,5-diethylphenyl, 3-isopropylphenyl, 4-isopropylphenyl, 3,5-di-isopropylphenyl, 2,5-di-isopropylphenyl, 2-tert-butylphenyl, 3-tert-butylphenyl, 4-tert-butylphenyl, 3,5-di-tert-butylphenyl, 3,5-di-tert-butyl-4-methoxyphenyl, 2,5-di-tert-butylphenyl, 2-trimethylsilylphenyl, 3-trimethylsilylphenyl, 4-trimethylsilylphenyl, 3,5-bis(trimethylsilyl)phenyl, 2-trifluoromethylphenyl, 3-trifluoromethylphenyl, 4-trifluoromethylphenyl, 3,5-bis(trifluoromethyl)phenyl, cyclopropyl, carbazolyl, indolyl, pyrrolyl, or 2-furanyl, 3-furanyl, 5-methyl-2-furanyl, 5-ethyl-2-furanyl, 4,5-dimethyl-2-furanyl, 2-methyl-3-furanyl, 5-methyl-3-furanyl, 2-thiophenyl, 3-thiophenyl, 5-methyl-2-thiophenyl, 2-methyl-3-thiophenyl, and 5-methyl-3-thiophenyl.

The metallocene catalyst component may comprise any combination of any “embodiment” described herein. In addition, suitable metallocenes useful herein include, but are not limited to, the metallocenes disclosed and referenced in the US patents cited above, as well as those disclosed and referenced in U.S. Pat. Nos. 7,179,876; 7,169,864; 7,157,531; 7,129,302; 6,995,109; 6,958,306; 6,884,748; 6,689,847; US Patent publication 2007/0055028, and published PCT Applications WO 97/22635; WO 00/699/22; WO 01/30860; WO 01/30861; WO 02/46246; WO 02/50088; WO 04/026921; and WO 06/019494, all fully incorporated herein by reference. Additional catalysts suitable for use herein include those referenced in U.S. Pat. Nos. 6,309,997; 6,265,338; US Patent publication 2006/019925, and the following articles: Resconi, L. et al. (2000) “Selectivity in Propene Polymerization with Metallocene Catalysts,” Chem. Rev., v. 100(4), pp. 1253-1346; Gibson, V. C. et al. (2003) “Advances in Non-Metallocene Olefin Polymerization Catalysis,” Chem. Rev., v. 103(1), pp. 283-316; Chem Eur. J. 2006, v. 12, p. 7546; Nakayama, Y et al. (2004), “Olefin Polymerization Behavior of bis(phenoxy-imine) Zr, Ti, and V complexes with MgCl2-based Cocatalysts,” J. Mol. Catalysis A: Chemical, v. 213, pp. 141-150; Nakayama, Y. et al. (2005), “Propylene Polymerization Behavior of Fluorinated Bis(phenoxy-imine) Ti Complexes with an MgCl2-Based Compound (MgCl2-Supported Ti-Based Catalysts),” Macromol. Chem. Phys., v. 206(18), pp. 1847-1852; and Matsui, S. et al. (2001) “A Family of Zirconium Complexes Having Two Phenoxy-Imine Chelate Ligands for Olefin Polymerization,” J. Am. Chem. Soc., v. 123(28), pp. 6847-6856.

In preferred embodiments of the invention, the catalyst compound is one or more of:
dimethylsilylbis(tetrahydroindenyl)MXₙ,
dimethylsilyl bis(2-methylindenyl)MXₙ,
dimethylsilyl bis(2-methylfluorenyl)MXₙ,
dimethylsilyl bis(2-methyl-5,7-propylindenyl)MXₙ,
dimethylsilyl bis(2-methyl-4-phenylindenyl)MXₙ,
dimethylsilyl bis(2-ethyl-5-phenylindenyl)MXₙ,
dimethylsilyl bis(2-methyl-4-biphenylindenyl)MXₙ,
dimethylsilylene bis(2-methyl-4-carbazolylindenyl)MXₙ,
rac-dimethylsilyl-bis-(5,6,7,8-tetrahydro-5,5,8,8-tetramethyl-2-methyl-1H-benz(f)indene)MXₙ,
—(CH₃)₂Si(cyclopentadienyl)(1-adamantylamido)MXₙ,
μ-(CH₃)₂Si(3-tertbutylcyclopentadienyl)(1-adamantylamido)MXₙ,
μ-(CH₃)₂(tetramethylcyclopentadienyl)(1-adamantylamido)MXₙ,
μ-(CH₃)₂Si(tetramethylcyclopentadienyl)(1-adamantylamido)MXₙ,
μ-(CH₃)₂C(tetramethylcyclopentadienyl)(1-adamantylamido)MXₙ,
μ-(CH₃)₂Si(tetramethylcyclopentadienyl)(1-tertbutylamido)MXₙ,
μ-(CH₃)₂Si(fluorenyl)(1-tertbutylamido)MXₙ,
μ-(CH₃)₂Si(tetramethylcyclopentadienyl)(1-cyclododecylamido)MXₙ,
μ-(C₆H₅)₂C(tetramethylcyclopentadienyl)(1-cyclododecylamido)MXₙ,
μ-(CH₃)₂Si(η⁵-2,6,6-trimethyl-1,5,6,7-tetrahydro-s-indacen-1-yl)(tertbutylamido)MXₙ,
dimethylsilyl-(4-([1,l′-biphenyl]-2-yl)-2-hexyl-1H-inden-1-yl)(4-(3,5-di-tert-butyl-4-methoxyphenyl)-2-methyl-1H-inden-1-yl) MXₙ
dimethylsilyl-(4-(4-(tert-butyl)phenyl)-2-isopropyl-1H-inden-1-yl)(4-(4-(tert-butyl)phenyl)-2-methyl-1,5,6,7-tetrahydro-s-indacen-1-yl) MXₙ
dimethylsilyl-(4-(4-(tert-butyl)phenyl)-2-isopropyl-1H-inden-1-yl)(4-(4-(tert-butyl)phenyl)-2-methyl-1H-inden-1-yl)MXₙ
tetramethylcyclopentadienyl dimethylsilyl (2-methyl-4-phenyl)-1,5,6,7-tetrahydro-s-indacen-1-yl)MXₙ
tetramethylcyclopentadienyl dimethylsilyl (2-methyl-4-(4-tertbutylphenyl)-1,5,6,7-tetrahydro-s-indacen-1-yl)MXₙ
tetramethylcyclopentadienyl dimethylsilyl (2-methyl-4-(o-tolyl)-1,5,6,7-tetrahydro-s-indacen-1-yl)MXₙ
tetramethylcyclopentadienyl dimethylsilyl (4-([1,1′-biphenyl]-2-yl)-1,5,6,7-tetrahydro-s-indacen-1-yl)MXₙ
tetramethylcyclopentadienyl dimethylsilyl (4-(2-isopropylphenyl)-2-methyl-1,5,6,7-tetrahydro-s-indacen-1-yl)MXₙ
tetramethylcyclopentadienyl dimethylsilyl (2-methyl-4-(2,3,4-trimethylphenyl)-1,5,6,7-tetrahydro-s-indacen-1-yl)MXₙ
tetramethylcyclopentadienyl dimethylsilyl (4-(3,5-di-tert-butyl-4-methoxyphenyl)-2-methyl-1,5,6,7-tetrahydro-s-indacen-1-yl)MXₙ
tetramethylcyclopentadienyl dimethylsilyl (4-(anthracen-9-yl)-2-methyl-1,5,6,7-tetrahydro-s-indacen-1-yl))MXₙ
tetramethylcyclopentadienyl dimethylsilyl (2-methyl-4-(3,5-di-trifluoromethylphenyl)-1,5,6,7-tetrahydro-s-indacen-1-yl)MXₙ
tetramethylcyclopentadienyl dimethylsilyl (4-(1-naphthyl)-2-methyl-1,5,6,7-tetrahydro-s-indacen-1-yl)) MXₙ
where M is selected from Ti, Zr, and Hf; where X is selected from the group consisting of halogens, hydrides, C₁₋₁₂ alkyls, C₂₋₁₂ alkenyls, C₆₋₁₂ aryls, C₇₋₂₀ alkylaryls, C₁₋₁₂ alkoxys, C₆₋₁₆ aryloxys, C₇₋₁₈ alkylaryloxys, C₁₋₁₂ fluoroalkyls, C₆₋₁₂ fluoroaryls, and C₁₋₁₂ heteroatom-containing hydrocarbons, substituted derivatives thereof, and combinations thereof, and where n is zero or an integer from 1 to 4, preferably X is selected from halogens (such as bromide, fluoride, chloride), or C₁ to C₂₀ alkyls (such as methyl, ethyl, propyl, butyl, and pentyl) and n is 1 or 2, preferably 2.
μ-(CH₃)₂Si(cyclopentadienyl)(1-adamantylamido)M(R)₂;
μ-(CH₃)₂Si(3-tertbutylcyclopentadienyl)(1-adamantylamido)M(R)₂;
μ-(CH₃)₂(tetramethylcyclopentadienyl)(1-adamantylamido)M(R)₂;
μ-(CH₃)₂Si(tetramethylcyclopentadienyl)(1-adamantylamido)M(R)₂;
μ-(CH₃)₂C(tetramethylcyclopentadienyl)(1-adamantylamido)M(R)₂;
μ-(CH₃)₂Si(tetramethylcyclopentadienyl)(1-tertbutylamido)M(R)₂;
μ-(CH₃)₂Si(fluorenyl)(1-tertbutylamido)M(R)₂;
μ-(CH₃)₂Si(tetramethylcyclopentadienyl)(1-cyclododecylamido)M(R)₂;
μ-(C₆H₅)₂C(tetramethylcyclopentadienyl)(1-cyclododecylamido)M(R)₂;
μ-(CH₃)₂Si(η⁵-2,6,6-trimethyl-1,5,6,7-tetrahydro-s-indacen-1-yl)(tertbutylamido)M(R)₂;
where M is selected from Ti, Zr, and Hf; and R is selected from halogen or C₁ to C₅ alkyl.

In preferred embodiments of the invention, the catalyst compound is one or more of:
dimethylsilyl (tetramethylcyclopentadienyl)(cyclododecylamido)titanium dimethyl;
dimethylsilyl (tetramethylcyclopentadienyl)(cyclododecylamido)titanium dimethyl;
dimethylsilyl (tetramethylcyclopentadienyl)(t-butylamido)titanium dimethyl;
dimethylsilyl (tetramethylcyclopentadienyl)(t-butylamido)titanium dimethyl;
μ-(CH₃)₂Si(cyclopentadienyl)(1-adamantylamido)titanium dimethyl;
μ-(CH₃)₂Si(3-tertbutylcyclopentadienyl)(1-adamantylamido)titanium dimethyl;
μ-(CH₃)₂(tetramethylcyclopentadienyl)(1-adamantylamido)titanium dimethyl;
μ-(CH₃)₂Si(tetramethylcyclopentadienyl)(1-adamantylamido)titanium dimethyl;
μ-(CH₃)₂C(tetramethylcyclopentadienyl)(1-adamantylamido)titanium dimethyl;
μ-(CH₃)₂Si(tetramethylcyclopentadienyl)(1-tertbutylamido)titanium dimethyl₂;
μ-(CH₃)₂Si(fluorenyl)(1-tertbutylamido)titanium dimethyl;
μ-(CH₃)₂Si(tetramethylcyclopentadienyl)(1-cyclododecylamido)titanium dimethyl;
μ-(C₆H₅)₂C(tetramethylcyclopentadienyl)(1-cyclododecylamido)titanium dimethyl; and/or
μ-(CH₃)₂Si(η⁵-2,6,6-trimethyl-1,5,6,7-tetrahydro-s-indacen-1-yl)(tertbutylamido)titanium dimethyl.

In at least one embodiment, the catalyst is rac-dimethylsilyl-bis(indenyl)hafnium dimethyl and or 1,1′-bis(4-triethylsilylphenyl)methylene-(cyclopentadienyl)(3,8-di-tertiary-butyl-1-fluorenyl)hafnium dimethyl.

In at least one embodiment, the catalyst compound is one or more of:
dimethylsilyl bis(indenyl)zirconium dimethyl,
dimethylsilyl bis(indenyl)hafnium dimethyl,
bis(indenyl)zirconium dimethyl,
bis(indenyl)hafnium dimethyl,
dimethylsilyl bis(tetrahydroindenyl)zirconium dimethyl,
bis(n-propylcyclopentadienyl)zirconium dimethyl,
dimethylsilylbis(tetrahydroindenyl)hafnium dimethyl,
dimethylsilyl bis(2-methylindenyl)zirconium dimethyl,
dimethylsilyl bis(2-methylfluorenyl)zirconium dimethyl,
dimethylsilyl bis(2-methylindenyl)hafnium dimethyl,
dimethylsilyl bis(2-methylfluorenyl)hafnium dimethyl,
dimethylsilyl bis(2-methyl-5,7-propylindenyl) zirconium dimethyl,
dimethylsilyl bis(2-methyl-4-phenylindenyl) zirconium dimethyl,
dimethylsilyl bis(2-ethyl-5-phenylindenyl) zirconium dimethyl,
dimethylsilyl bis(2-methyl-4-biphenylindenyl) zirconium dimethyl,
dimethylsilylene bis(2-methyl-4-carbazolylindenyl) zirconium dimethyl,
rac-dimethylsilyl-bis-(5,6,7,8-tetrahydro-5,5,8,8-tetramethyl-2-methyl-1H-benz(f)indene)hafnium dimethyl,
diphenylmethylene (cyclopentadienyl)(fluoreneyl)hafnium dimethyl,
bis(methylcyclopentadienyl)zirconium dimethyl,
rac-dimethylsiylbis(2-methyl,3-propyl indenyl)hafnium dimethyl,
dimethylsilylbis(indenyl)hafnium dimethyl,
dimethylsilylbis(indenyl)zirconium dimethyl,
dimethyl rac-dimethylsilyl-bis-(5,6,7,8-tetrahydro-5,5,8,8-tetramethyl-2-methyl-1H-benz(f)indene)hafnium dimethyl,

In some embodiments, two or more different catalyst compounds are present in the catalyst system used herein. In some embodiments, two or more different catalyst compounds are present in the reaction zone where the process(es) described herein occur. When two transition metal compound catalysts are used in one reactor as a mixed catalyst system, the two transition metal compounds are preferably chosen such that the two are compatible. A simple screening method such as by ¹H or ¹³C NMR, known to those of ordinary skill in the art, can be used to determine which transition metal compounds are compatible. It is preferable to use the same activator for the transition metal compounds, however, two different activators, such as a non-coordinating anion activator and an alumoxane, can be used in combination. If one or more transition metal compounds contain an X group which is not a hydride, hydrocarbyl, or substituted hydrocarbyl, then the alumoxane can be contacted with the transition metal compounds prior to addition of the non-coordinating anion activator.

The two transition metal compounds (pre-catalysts) may be used in any ratio. Preferred molar ratios of (A) transition metal compound to (B) transition metal compound fall within the range of (A:B) 1:1000 to 1000:1, alternatively 1:100 to 500:1, alternatively 1:10 to 200:1, alternatively 1:1 to 100:1, and alternatively 1:1 to 75:1, and alternatively 5:1 to 50:1. The particular ratio chosen will depend on the exact pre-catalysts chosen, the method of activation, and the end product desired. In a particular embodiment, when using the two pre-catalysts, where both are activated with the same activator, useful mole percents, based upon the molecular weight of the pre-catalysts, are 10 to 99.9% A to 0.1 to 90% B, alternatively 25 to 99% A to 0.5 to 50% B, alternatively 50 to 99% A to 1 to 25% B, and alternatively 75 to 99% A to 1 to 10% B.

### Activators

The terms “cocatalyst” and “activator” are used herein interchangeably. Activators are defined to be any compound which can activate any one of the catalyst compounds described above by converting the neutral metal compound to a catalytically active metal compound cation.

After the catalyst complexes described have been synthesized, the catalyst systems may be formed by combining them with one or more activators in any suitable manner, including by supporting them for use in slurry or gas phase polymerization. The catalyst systems may also be added to or generated in solution polymerization or bulk polymerization (in the monomer). Suitable catalyst systems may include a complex as described above and an activator such as alumoxane or a non-coordinating anion.

Non-limiting activators, for example, include alumoxanes, ionizing activators, which may be neutral or ionic, and conventional-type cocatalysts. Preferred activators typically include alumoxane compounds, modified alumoxane compounds, and ionizing anion precursor compounds that abstract a reactive metal ligand making the metal compound cationic and providing a charge-balancing non-coordinating or weakly coordinating anion, e.g. a non-coordinating anion.

### Alumoxane Activators

Alumoxane activators are utilized as activators in the catalyst systems described herein. Alumoxanes are generally oligomeric compounds containing —Al(R¹)—O— sub-units, where R¹ is an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as catalyst activators, particularly when the abstractable ligand is an alkyl, halide, alkoxide or amide. Mixtures of different alumoxanes and modified alumoxanes may also be used. It may be preferable to use a visually clear methylalumoxane. A cloudy or gelled alumoxane can be filtered to produce a clear solution or clear alumoxane can be decanted from the cloudy solution. A useful alumoxane is a modified methyl alumoxane (MMAO) cocatalyst type 3A (commercially available from Akzo Chemicals, Inc. under the trade name Modified Methylalumoxane type 3A, covered under patent number U.S. Pat. No. 5,041,584). Another useful alumoxane is solid polymethylaluminoxane as described in U.S. Pat. Nos. 9,340,630; 8,404,880; and 8,975,209.

When the activator is an alumoxane (modified or unmodified), typically the maximum amount of activator is at up to a 5,000-fold molar excess Al/M over the catalyst compound (per metal catalytic site). The minimum activator-to-catalyst-compound is a 1:1 molar ratio. Alternate preferred ranges include from 1:1 to 500:1, alternately from 1:1 to 200:1, alternately from 1:1 to 100:1, or alternately from 1:1 to 50:1.

In an alternate embodiment, little or no alumoxane is used in the polymerization processes described herein. Preferably, alumoxane is present at zero mole %, alternately the alumoxane is present at a molar ratio of aluminum to catalyst compound transition metal less than 500:1, preferably less than 300:1, preferably less than 100:1, preferably less than 1:1.

### Ionizing/Non Coordinating Anion Activators

The term “non-coordinating anion” (NCA) means an anion which either does not coordinate to a cation or which is only weakly coordinated to a cation thereby remaining sufficiently labile to be displaced by a neutral Lewis base. Further, the anion will not transfer an anionic substituent or fragment to the cation so as to cause it to form a neutral transition metal compound and a neutral by-product from the anion. Non-coordinating anions useful in accordance with this invention are those that are compatible, stabilize the transition metal cation in the sense of balancing its ionic charge at +1, and yet retain sufficient lability to permit displacement during polymerization. The term NCA is also defined to include multicomponent NCA-containing activators, such as N,N-dimethylanilinium tetrakis(pentafluorophenyl)borate, that contain an acidic cationic group and the non-coordinating anion. The term NCA is also defined to include neutral Lewis acids, such as tris(pentafluorophenyl)boron, that can react with a catalyst to form an activated species by abstraction of an anionic group. Any metal or metalloid that can form a compatible, weakly coordinating complex may be used or contained in the non-coordinating anion. Suitable metals include, but are not limited to, aluminum, gold, and platinum. Suitable metalloids include, but are not limited to, boron, aluminum, phosphorus, and silicon.

It is within the scope of this invention to use an ionizing activator, neutral or ionic. It is also within the scope of this invention to use neutral or ionic activators alone or in combination with alumoxane or modified alumoxane activators.

In embodiments of the invention, the activator can be represented by the Formula (III):

(Z)_{d}⁺(A^{d-}) (III)

wherein Z is (L-H) or a reducible Lewis Acid, L is an neutral Lewis base; H is hydrogen; (L-H)⁺ is a Bronsted acid; A^{d-} is a non-coordinating anion having the charge d−; and d is an integer from 1 to 3 (such as 1, 2 or 3), preferably Z is (Ar₃C⁺), where Ar is aryl or aryl substituted with a heteroatom, a C₁ to C₄₀ hydrocarbyl, or a substituted C₁ to C₄₀ hydrocarbyl. The anion component A^{d-} includes those having the formula [M^{k+}Qₙ]^{d-} wherein k is 1, 2, or 3; n is 1, 2, 3, 4, 5, or 6 (preferably 1, 2, 3, or 4); n−k=d; M is an element selected from Group 13 of the Periodic Table of the Elements, preferably boron or aluminum, and Q is independently a hydride, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q having up to 40 carbon atoms (optionally with the proviso that in not more than 1 occurrence is Q a halide). Preferably, each Q is a fluorinated hydrocarbyl group having 1 to 40 (such as 1 to 20) carbon atoms, more preferably each Q is a fluorinated aryl group, such as a perfluorinated aryl group and most preferably each Q is a pentafluoryl aryl group or perfluoronaphthalenyl group. Examples of suitable Ad-also include diboron compounds as disclosed in U.S. Pat. No. 5,447,895, which is fully incorporated herein by reference.

When Z is the activating cation (L-H), it can be a Bronsted acid, capable of donating a proton to the transition metal catalytic precursor resulting in a transition metal cation, including ammoniums, oxoniums, phosphoniums, sulfoniums, and mixtures thereof, such as ammoniums of methylamine, aniline, dimethylamine, diethylamine, N-methylaniline, N-methyl-4-nonadecyl-N-octadecylaniline, N-methyl-4-octadecyl-N-octadecylaniline, diphenylamine, trimethylamine, triethylamine, N,N-dimethylaniline, methyldiphenylamine, pyridine, p-bromo N,N-dimethylaniline, p-nitro-N,N-dimethylaniline, dioctadecylmethylamine, phosphoniums from triethylphosphine, triphenylphosphine, and diphenylphosphine, oxoniums from ethers such as dimethyl ether, diethyl ether, tetrahydrofuran and dioxane, sulfoniums from thioethers, such as diethyl thioethers, tetrahydrothiophene, and mixtures thereof.

In particularly useful embodiments of the invention, the activator is soluble in non-aromatic-hydrocarbon solvents, such as aliphatic solvents.

In one or more embodiments, a 20 wt % mixture of the activator compound in n-hexane, isohexane, cyclohexane, methylcyclohexane, or a combination thereof, forms a clear homogeneous solution at 25° C., preferably a 30 wt % mixture of the activator compound in n-hexane, isohexane, cyclohexane, methylcyclohexane, or a combination thereof, forms a clear homogeneous solution at 25° C.

In embodiments of the invention, the activators described herein have a solubility of more than 10 mM (or more than 20 mM, or more than 50 mM) at 25° C. (stirred 2 hours) in methylcyclohexane.

In embodiments of the invention, the activators described herein have a solubility of more than 1 mM (or more than 10 mM, or more than 20 mM) at 25° C. (stirred 2 hours) in isohexane.

In embodiments of the invention, the activators described herein have a solubility of more than 10 mM (or more than 20 mM, or more than 50 mM) at 25° C. (stirred 2 hours) in methylcyclohexane and a solubility of more than 1 mM (or more than 10 mM, or more than 20 mM) at 25° C. (stirred 2 hours) in isohexane.

In a preferred embodiment, the activator is a non-aromatic-hydrocarbon soluble activator compound.

Non-aromatic-hydrocarbon soluble activator compounds useful herein include those represented by the Formula (V):

[R^{1′}R^{2′}R^{3′}EH]_{d}_{⁺}[Mt^{k+}Qₙ]^{d-} (V)

wherein:
E is nitrogen or phosphorous;
d is 1, 2 or 3; k is 1, 2, or 3; n is 1, 2, 3, 4, 5, or 6; n−k=d (preferably d is 1, 2 or 3; k is 3; n is 4, 5, or 6);
R^{1′}, R^{2′}, and R^{3′} are independently a C₁ to C₅₀ hydrocarbyl group optionally substituted with one or more alkoxy groups, silyl groups, a halogen atoms, or halogen containing groups,
wherein R^{1′}, R^{2′}, and R^{3′} together comprise 15 or more carbon atoms;
Mt is an element selected from group 13 of the Periodic Table of the Elements, such as B or Al; and
each Q is independently a hydride, bridged or unbridged dialkylamido, halide, alkoxide, aryloxide, hydrocarbyl, substituted hydrocarbyl, halocarbyl, substituted halocarbyl, or halosubstituted-hydrocarbyl radical.

Non-aromatic-hydrocarbon soluble activator compounds useful herein include those represented by the Formula (VI):

[R^{1′}R^{2′}R^{3′}EH]⁺[BR^{4′}R^{5′}R^{6′}R^{7′}]⁻ (VI)

wherein: E is nitrogen or phosphorous; R^{1′} is a methyl group; R^{2′} and R^{3′} are independently is C₄-C₅₀ hydrocarbyl group optionally substituted with one or more alkoxy groups, silyl groups, a halogen atoms, or halogen containing groups wherein R^{2′} and R^{3′} together comprise 14 or more carbon atoms; B is boron; and R^{4′}, R^{5′}, R^{6′}, and R^{7′} are independently hydride, bridged or unbridged dialkylamido, halide, alkoxide, aryloxide, hydrocarbyl, substituted hydrocarbyl, halocarbyl, substituted halocarbyl, or halosubstituted-hydrocarbyl radical.

Non-aromatic-hydrocarbon soluble activator compounds useful herein include those represented by the Formula (VII) or Formula (VIII):

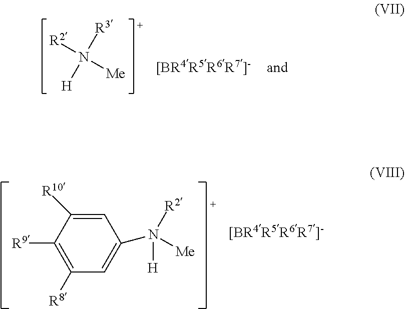

wherein:
N is nitrogen;
R^{2′} and R^{3′} are independently is C₆-C₄₀ hydrocarbyl group optionally substituted with one or more alkoxy groups, silyl groups, a halogen atoms, or halogen containing groups wherein R^{2′} and R^{3′} (if present) together comprise 14 or more carbon atoms;
R^{8′}, R^{9′}, and R^{10′} are independently a C₄-C₃₀ hydrocarbyl or substituted C₄-C₃₀ hydrocarbyl group;
B is boron;
and R^{4′}, R^{5′}, R^{6′}, and R^{7′} are independently hydride, bridged or unbridged dialkylamido, halide, alkoxide, aryloxide, hydrocarbyl, substituted hydrocarbyl, halocarbyl, substituted halocarbyl, or halosubstituted-hydrocarbyl radical.

Optionally, in any of Formulas (V), (VI), (VII), or (VIII) herein, R^{4′}, R^{5′}, R^{6′}, and R^{7′} are pentafluorophenyl.

Optionally, in any of Formulas (V), (VI), (VII), or (VIII) herein, R^{4′}, R^{5′}, R^{6′}, and R^{7′} are pentafluoronaphthalenyl.

Optionally, in any embodiment of Formula (VIII) herein, R^{8′} and R^{10′} are hydrogen atoms and R^{9′} is a C₄-C₃₀ hydrocarbyl group which is optionally substituted with one or more alkoxy groups, silyl groups, a halogen atoms, or halogen containing groups.

Optionally, in any embodiment of Formula (VIII) herein, R^{9′} is a C₈-C₂₂ hydrocarbyl group which is optionally substituted with one or more alkoxy groups, silyl groups, a halogen atoms, or halogen containing groups.

Optionally, in any embodiment of Formula (VII) or (VIII) herein, R^{2′} and R^{3′} are independently a C₁₂-C₂₂ hydrocarbyl group.

Optionally, R^{1′}, R^{2′} and R^{3′} together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 38 or more carbon atoms, such as 40 or more carbon atoms, such as 15 to 100 carbon atoms, such as 25 to 75 carbon atoms).

Optionally, R^{2′} and R^{3″} together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 38 or more carbon atoms, such as 40 or more carbon atoms, such as 15 to 100 carbon atoms, such as 25 to 75 carbon atoms).

Optionally, R^{8′}, R^{9″}, and R^{10′} together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 38 or more carbon atoms, such as 40 or more carbon atoms, such as 15 to 100 carbon atoms, such as 25 to 75 carbon atoms).

Optionally, when Q is a fluorophenyl group, then R^{2′} is not a C₁-C₄₀ linear alkyl group (alternately R^{2′} is not an optionally substituted C₁-C₄₀ linear alkyl group).

Optionally, each of R^{4′}, R^{5′}, R^{6′}, and R^{7′} is an aryl group (such as phenyl or naphthalenyl), wherein at least one of R^{4′}, R^{5′}, R^{6′}, and R^{7′} is substituted with at least one fluorine atom, preferably each of R^{4′}, R^{5′}, R^{6′}, and R^{7′} is a perfluoroaryl group (such as perfluorophenyl or perfluoronaphthalenyl).

Optionally, each Q is an aryl group (such as phenyl or naphthalenyl), wherein at least one Q is substituted with at least one fluorine atom, preferably each Q is a perfluoroaryl group (such as perfluorophenyl or perfluoronaphthalenyl).

Optionally, R^{1′} is a methyl group; R^{2′} is C₆-C₅₀ aryl group; and R^{3′} is independently C₁-C₄₀ linear alkyl or C₅-C₅₀-aryl group.

Optionally, each of R^{2′} and R^{3′} is independently unsubstituted or substituted with at least one of halide, C₁-C₃₅ alkyl, C₅-C₁₅ aryl, C₆-C₃₅ arylalkyl, C₆-C₃₅ alkylaryl, wherein R², and R³ together comprise 20 or more carbon atoms.

Optionally, each Q is independently a hydride, bridged or unbridged dialkylamido, halide, alkoxide, aryloxide, hydrocarbyl, substituted hydrocarbyl, halocarbyl, substituted halocarbyl, or halosubstituted-hydrocarbyl radical, provided that when Q is a fluorophenyl group, then R^{2′} is not a C₁-C₄₀ linear alkyl group, preferably R^{2′} is not an optionally substituted C₁-C₄₀ linear alkyl group (alternately when Q is a substituted phenyl group, then R^{2′} is not a C₁-C₄₀ linear alkyl group, preferably R^{2′} is not an optionally substituted C₁-C₄₀ linear alkyl group). Optionally, when Q is a fluorophenyl group (alternately when Q is a substituted phenyl group), then R^{2′} is a meta-and/or para-substituted phenyl group, where the meta and para substituents are, independently, an optionally substituted C₁ to C₄₀ hydrocarbyl group (such as a C₆ to C₄₀ aryl group or linear alkyl group, a C₁₂ to C₃₀ aryl group or linear alkyl group, or a C₁₀ to C₂₀ aryl group or linear alkyl group), an optionally substituted alkoxy group, or an optionally substituted silyl group. Optionally, each Q is a fluorinated hydrocarbyl group having 1 to 30 carbon atoms, more preferably each Q is a fluorinated aryl (such as phenyl or naphthalenyl) group, and most preferably each Q is a perflourinated aryl (such as phenyl or naphthalenyl) group. Examples of suitable [Mt^{k+}Qₙ]^{d-} also include diboron compounds as disclosed in U.S. Pat. No. 5,447,895, which is fully incorporated herein by reference. Optionally, at least one Q is not substituted phenyl. Optionally all Q are not substituted phenyl. Optionally at least one Q is not perfluorophenyl. Optionally all Q are not perfluorophenyl.

In some embodiments of the invention, R^{1′} is not methyl, R^{2′} is not C₁₈ alkyl and R^{3′} is not C₁₈ alkyl, alternately R^{1′} is not methyl, R^{2′} is not C₁₈ alkyl and R^{3′} is not C₁₈ alkyl and at least one Q is not substituted phenyl, optionally all Q are not substituted phenyl.

Useful cation components in Formulas (III) and (V) to (VIII) include those represented by the following complexes numbered 10 through 36:

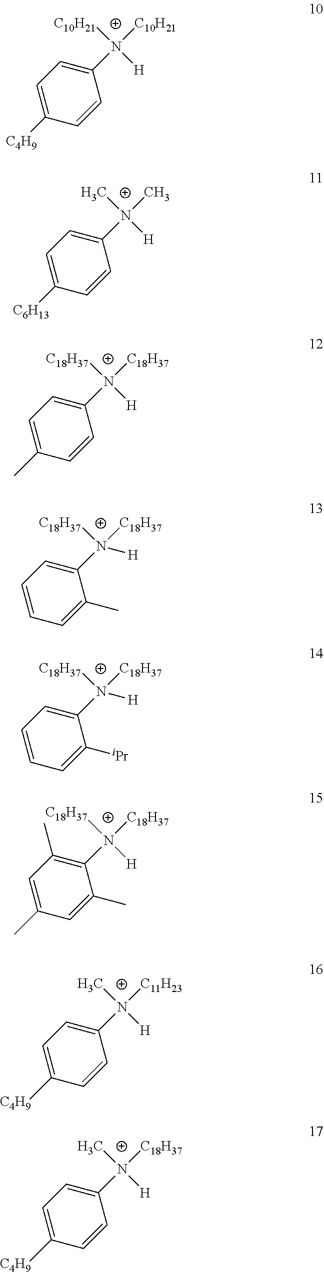

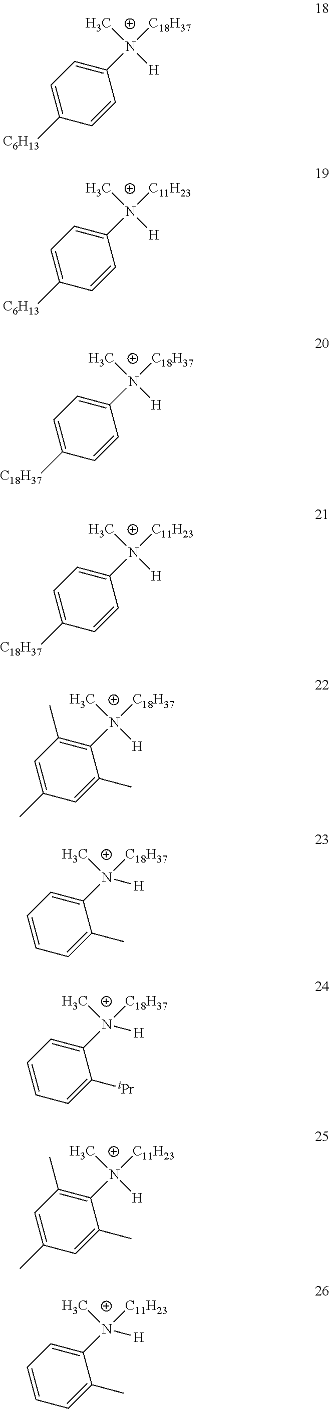

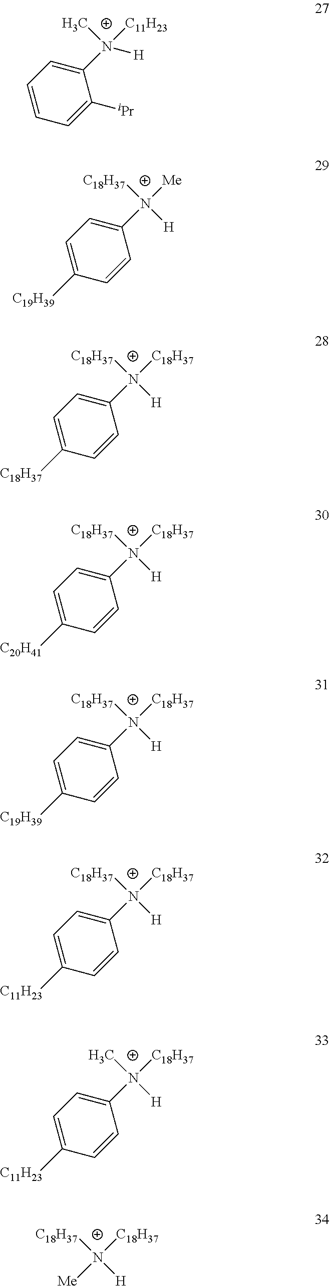

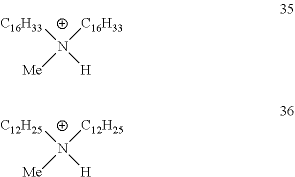

Useful cation components in Formulas (III) and (V) to (VIII) include those represented by the formulas:

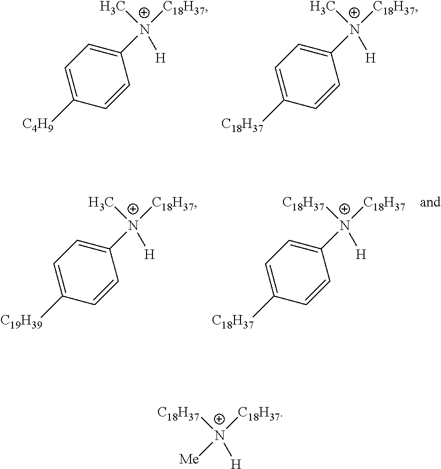

The anion component of the activators described herein includes those represented by the formula [Mt^{k+}Qₙ]⁻ wherein k is 1, 2, or 3; n is 1, 2, 3, 4, 5, or 6 (preferably 1, 2, 3, or 4), (preferably k is 3; n is 4, 5, or 6, preferably when M is B, n is 4); Mt is an element selected from Group 13 of the Periodic Table of the Elements, preferably boron or aluminum, and Q is independently a hydride, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q having up to 20 carbon atoms with the provison that in not more than 1 occurrence is Q a halide. Preferably, each Q is a fluorinated hydrocarbyl group, optionally having 1 to 20 carbon atoms, more preferably each Q is a fluorinated aryl group, and most preferably each Q is a perfluorinated aryl group. Preferably at least one Q is not substituted phenyl, such as perfluorophenyl, preferably all Q are not substituted phenyl, such as perfluorophenyl.

In one embodiment, the borate activator comprises tetrakis(heptafluoronaphth-2-yl)borate.

In one embodiment, the borate activator comprises tetrakis(pentafluorophenyl)borate.

Anions for use in the non-coordinating anion activators described herein also include those represented by formula 7, below:

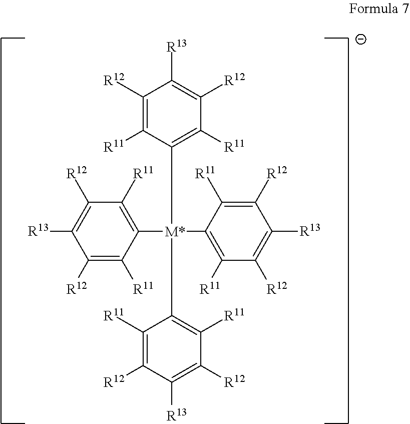

wherein:
M* is a group 13 atom, preferably B or Al, preferably B;
each R¹¹ is, independently, a halide, preferably a fluoride;
each R¹² is, independently, a halide, a C₆ to C₂₀ substituted aromatic hydrocarbyl group or a siloxy group of the formula —O—Si—R^{a}, where R^{a} is a C₁ to C₂₀ hydrocarbyl or hydrocarbylsilyl group, preferably R¹² is a fluoride or a perfluorinated phenyl group;
each R¹³ is a halide, a C₆ to C₂₀ substituted aromatic hydrocarbyl group or a siloxy group of the formula —O—Si—Rₐ, where R^{a} is a C₁ to C₂₀ hydrocarbyl or hydrocarbylsilyl group, preferably R¹³ is a fluoride or a C₆ perfluorinated aromatic hydrocarbyl group;
wherein R¹² and R¹³ can form one or more saturated or unsaturated, substituted or unsubstituted rings, preferably R¹² and R¹³ form a perfluorinated phenyl ring. Preferably the anion has a molecular weight of greater than 700 g/mol, and, preferably, at least three of the substituents on the M* atom each have a molecular volume of greater than 180 cubic Å.

“Molecular volume” is used herein as an approximation of spatial steric bulk of an activator molecule in solution. Comparison of substituents with differing molecular volumes allows the substituent with the smaller molecular volume to be considered “less bulky” in comparison to the substituent with the larger molecular volume. Conversely, a substituent with a larger molecular volume may be considered “more bulky” than a substituent with a smaller molecular volume.

Molecular volume may be calculated as reported in “A Simple “Back of the Envelope” Method for Estimating the Densities and Molecular Volumes of Liquids and Solids,” Journal of Chemical Education, v. 71(11), November 1994, pp. 962-964. Molecular volume (MV), in units of cubic Å, is calculated using the formula: MV=8.3Vₛ, where Vₛ is the scaled volume. Vₛ is the sum of the relative volumes of the constituent atoms, and is calculated from the molecular formula of the substituent using Table A below of relative volumes. For fused rings, the Vₛ is decreased by 7.5% per fused ring. The Calculated Total MV of the anion is the sum of the MV per substituent, for example, the MV of perfluorophenyl is 183 Å³, and the Calculated Total MV for tetrakis(perfluorophenyl)borate is four times 183 Å³, or 732 Å³.

TABLE A

| Element | Relative Volume |
|---|---|
| H | 1 |
| 1^{st} short period, Li to F | 2 |
| 2^{nd} short period, Na to Cl | 4 |
| 1^{st} long period, K to Br | 5 |
| 2^{nd} long period, Rb to I | 7.5 |
| 3^{rd} long period, Cs to Bi | 9 |

Exemplary anions useful herein and their respective scaled volumes and molecular volumes are shown in Table B below. The dashed bonds indicate bonding to boron.

TABLE 5

| | | Molecular | | MV | |
|---|---|---|---|---|---|
| | | Formula of | | Per | Calculated |
| | | Each | | subst. | Total MV |
| Ion | Structure of Boron Substituents | Substituent | Vₛ | (Å³) | (Å³) |
| tetrakis(perfluorophenyl) borate | 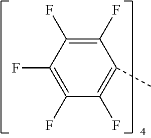 | C₆F₅ | 22 | 183 | 732 |
| tris(perfluorophenyl)- (perfluoronaphthalenyl) borate | 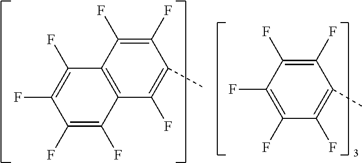 | C₆F₅ C₁₀F₇ | 22 34 | 183 261 | 810 |
| (perfluorophenyl)tris- (perfluoronaphthalenyl) borate | 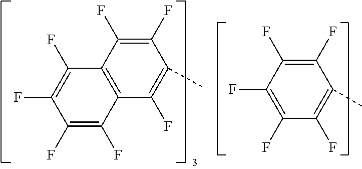 | C₆F₅ C₁₀F₇ | 22 34 | 183 261 | 966 |
| tetrakis (perfluoronaphthalenyl) borate | 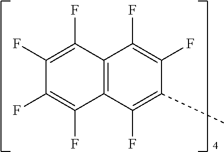 | C₁₀F₇ | 34 | 261 | 1044 |
| tetrakis (perfluorobiphenyl) borate | 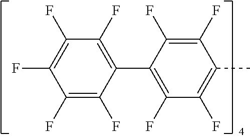 | C₁₂F₉ | 42 | 349 | 1396 |
| [(C₆F₃(C₆F₅)₂)₄B] | 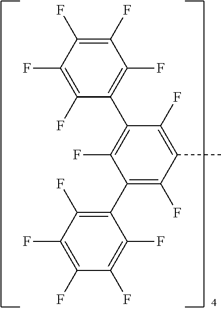 | C₁₈F₁₃ | 62 | 515 | 2060 |

The activators may be added to a polymerization in the form of an ion pair using, for example, [M2HTH]+[NCA]− in which the di(hydrogenated tallow)methylamine (“M2HTH”) cation reacts with a basic leaving group on the transition metal complex to form a transition metal complex cation and [NCA]−. Alternatively, the transition metal complex may be reacted with a neutral NCA precursor, such as B(C₆F₅)₃, which abstracts an anionic group from the complex to form an activated species. Useful activators include di(hydrogenated tallow)methylammonium[tetrakis(pentafluorophenyl)borate] (i.e., [M2HTH]B(C₆F₅)₄) and di(octadecyl)tolylammonium [tetrakis(pentafluorophenyl)borate] (i.e., [DOdTH]B(C₆F₅)₄).

Activator compounds that are particularly useful in this invention include one or more of:
N,N-di(hydrogenated tallow)methylammonium [tetrakis(perfluorophenyl) borate],
N-methyl-4-nonadecyl-N-octadecylanilinium [tetrakis(perfluorophenyl)borate],
N-methyl-4-hexadecyl-N-octadecylanilinium [tetrakis(perfluorophenyl)borate],
N-methyl-4-tetradecyl-N-octadecylanilinium [tetrakis(perfluorophenyl)borate],
N-methyl-4-dodecyl-N-octadecylanilinium [tetrakis(perfluorophenyl)borate],
N-methyl-4-decyl-N-octadecylanilinium [tetrakis(perfluorophenyl)borate],
N-methyl-4-octyl-N-octadecylanilinium [tetrakis(perfluorophenyl)borate],
N-methyl-4-hexyl-N-octadecylanilinium [tetrakis(perfluorophenyl)borate],
N-methyl-4-butyl-N-octadecylanilinium [tetrakis(perfluorophenyl)borate],
N-methyl-4-octadecyl-N-decylanilinium [tetrakis(perfluorophenyl)borate],
N-methyl-4-nonadecyl-N-dodecylanilinium [tetrakis(perfluorophenyl)borate],
N-methyl-4-nonadecyl-N-tetradecylanilinium [tetrakis(perfluorophenyl)borate],
N-methyl-4-nonadecyl-N-hexadecylanilinium [tetrakis(perfluorophenyl)borate],
N-ethyl-4-nonadecyl-N-octadecylanilinium [tetrakis(perfluorophenyl)borate],
N-methyl-N,N-dioctadecylammonium [tetrakis(perfluorophenyl)borate],
N-methyl-N,N-dihexadecylammonium [tetrakis(perfluorophenyl)borate],
N-methyl-N,N-ditetradecylammonium [tetrakis(perfluorophenyl)borate],
N-methyl-N,N-didodecylammonium [tetrakis(perfluorophenyl)borate],
N-methyl-N,N-didecylammonium [tetrakis(perfluorophenyl)borate],
N-methyl-N,N-dioctylammonium [tetrakis(perfluorophenyl)borate],
N-ethyl-N,N-dioctadecylammonium [tetrakis(perfluorophenyl)borate],
N,N-di(octadecyl)tolylammonium [tetrakis(perfluorophenyl)borate],
N,N-di(hexadecyl)tolylammonium [tetrakis(perfluorophenyl)borate],
N,N-di(tetradecyl)tolylammonium [tetrakis(perfluorophenyl)borate],
N,N-di(dodecyl)tolylammonium [tetrakis(perfluorophenyl)borate],
N-octadecyl-N-hexadecyl-tolylammonium [tetrakis(perfluorophenyl)borate],
N-octadecyl-N-hexadecyl-tolylammonium [tetrakis(perfluorophenyl)borate],
N-octadecyl-N-tetradecyl-tolylammonium [tetrakis(perfluorophenyl)borate],
N-octadecyl-N-dodecyl-tolylammonium [tetrakis(perfluorophenyl)borate],
N-octadecyl-N-decyl-tolylammonium [tetrakis(perfluorophenyl)borate],
N-hexadecyl-N-tetradecyl-tolylammonium [tetrakis(perfluorophenyl)borate],
N-hexadecyl-N-dodecyl-tolylammonium [tetrakis(perfluorophenyl)borate],
N-hexadecyl-N-decyl-tolylammonium [tetrakis(perfluorophenyl)borate],
N-tetradecyl-N-dodecyl-tolylammonium [tetrakis(perfluorophenyl)borate],
N-tetradecyl-N-decyl-tolylammonium [tetrakis(perfluorophenyl)borate],
N-dodecyl-N-decyl-tolylammonium [tetrakis(perfluorophenyl)borate],
N-methyl-N-octadecylanilinium [tetrakis(perfluorophenyl)borate],
N-methyl-N-hexadecylanilinium [tetrakis(perfluorophenyl)borate],
N-methyl-N-tetradecylanilinium [tetrakis(perfluorophenyl)borate],
N-methyl-N-dodecylanilinium [tetrakis(perfluorophenyl)borate],
N-methyl-N-decylanilinium [tetrakis(perfluorophenyl)borate], and
N-methyl-N-octylanilinium [tetrakis(perfluorophenyl)borate].

Additional useful activators and the synthesis non-aromatic-hydrocarbon soluble activators, are described in U.S. Ser. No. 16/394,166 filed Apr. 25, 2019, U.S. Ser. No. 16/394,186, filed Apr. 25, 2019, and U.S. Ser. No. 16/394,197, filed Apr. 25, 2019, which are incorporated by reference herein.

Likewise, particularly useful activators also include dimethylaniliniumtetrakis (pentafluorophenyl) borate and dimethyl anilinium tetrakis(heptafluoro-2-naphthalenyl) borate. For a more detailed description of useful activators please see WO 2004/026921 page 72, paragraph [00119] to page 81 paragraph [00151]. A list of additionally particularly useful activators that can be used in the practice of this invention may be found at page 72, paragraph [00177] to page 74, paragraph [00178] of WO 2004/046214. U.S. Pat. Nos. 8,658,556 and 6,211,105 show and describe other useful activators.

Preferred activators further include N-methyl-4-nonadecyl-N-octadecylbenzenaminium tetrakis(pentafluorophenyl)borate, N-methyl-4-nonadecyl-N-octadecylbenzenaminium tetrakis(perfluoronaphthalenyl)borate, N,N-dimethylanilinium tetrakis(perfluoronaphthalenyl)borate, N,N-dimethylanilinium tetrakis(perfluorobiphenyl)borate, N,N-dimethylanilinium tetrakis(perfluorophenyl)borate, N,N-dimethylanilinium tetrakis(3,5-bis(trifluoromethyl)phenyl)borate, triphenylcarbenium tetrakis(perfluoronaphthalenyl)borate, triphenylcarbenium tetrakis(perfluorobiphenyl)borate, triphenylcarbenium tetrakis(3,5-bis(trifluoromethyl)phenyl)borate, triphenylcarbenium tetrakis(perfluorophenyl)borate, [Me₃NH⁺][B(C₆F₅)₄⁻]; 1-(4-(tris(pentafluorophenyl)borate)-2,3,5,6-tetrafluorophenyl)pyrrolidinium; and tetrakis(pentafluorophenyl)borate, 4-(tris(pentafluorophenyl)borate)-2,3,5,6-tetrafluoropyridine.

In a preferred embodiment, the activator comprises a triaryl carbenium (such as triphenylcarbenium tetraphenylborate, triphenylcarbenium tetrakis(pentafluorophenyl)borate, triphenylcarbenium tetrakis-(2,3,4,6-tetrafluorophenyl)borate, triphenylcarbenium tetrakis(perfluoronaphthalenyl)borate, triphenylcarbenium tetrakis(perfluorobiphenyl)borate, triphenylcarbenium tetrakis(3,5-bis(trifluoromethyl)phenyl)borate).

In another embodiment, the activator comprises one or more of trialkylammonium tetrakis(pentafluorophenyl)borate, N,N-dialkylanilinium tetrakis(pentafluorophenyl)borate, dioctadecylmethylammonium tetrakis(pentafluorophenyl)borate, dioctadecylmethylammonium tetrakis(perfluoronaphthalenyl)borate, N,N-dimethyl-(2,4,6-trimethylanilinium) tetrakis(pentafluorophenyl)borate, trialkylammonium tetrakis-(2,3,4,6-tetrafluorophenyl) borate, N,N-dialkylanilinium tetrakis-(2,3,4,6-tetrafluorophenyl)borate, trialkylammonium tetrakis(perfluoronaphthalenyl)borate, N,N-dialkylanilinium tetrakis(perfluoronaphthalenyl)borate, trialkylammonium tetrakis(perfluorobiphenyl)borate, N,N-dialkylanilinium tetrakis(perfluorobiphenyl)borate, trialkylammonium tetrakis(3,5-bis(trifluoromethyl)phenyl)borate, N,N-dialkylanilinium tetrakis(3,5-bis(trifluoromethyl)phenyl)borate, N,N-dialkyl-(2,4,6-trimethylanilinium) tetrakis(3,5-bis(trifluoromethyl)phenyl)borate, di-(i-propyl)ammonium tetrakis(pentafluorophenyl)borate, (where alkyl is methyl, ethyl, propyl, n-butyl, sec-butyl, or t-butyl).

The typical activator-to-catalyst ratio, e.g., all NCA activators-to-catalyst ratio is about a 1:1 molar ratio. Alternate preferred ranges include from 0.1:1 to 100:1, alternately from 0.5:1 to 200:1, alternately from 1:1 to 500:1 alternately from 1:1 to 1000:1. A particularly useful range is from 0.5:1 to 10:1, preferably 1:1 to 5:1.

It is also within the scope of the present disclosure that the catalyst compounds can be combined with combinations of alumoxanes and NCA's (see for example, U.S. Pat. Nos. 5,153,157; 5,453,410; EP 0 573 120 B1; WO 1994/007928; and WO 1995/014044 (the disclosures of which are incorporated herein by reference in their entirety) which discuss the use of an alumoxane in combination with an ionizing activator).

### Optional Scavengers, Co-Activators, Chain Transfer Agents

In addition to activator compounds, scavengers or co-activators may be used. A scavenger is a compound that is typically added to facilitate polymerization by scavenging impurities. Some scavengers may also act as activators and may be referred to as co-activators. A co-activator, that is not a scavenger, may also be used in conjunction with an activator in order to form an active catalyst. In some embodiments a co-activator can be pre-mixed with the transition metal compound to form an alkylated transition metal compound.

Co-activators can include alumoxanes such as methylalumoxane, modified alumoxanes such as modified methylalumoxane, and aluminum alkyls such trimethylaluminum, tri-isobutylaluminum, triethylaluminum, and tri-isopropylaluminum, tri-n-hexylaluminum, tri-n-octylaluminum, tri-n-decylaluminum or tri-n-dodecylaluminum. Co-activators are typically used in combination with Lewis acid activators and ionic activators when the pre-catalyst is not a dihydrocarbyl or dihydride complex. Sometimes co-activators are also used as scavengers to deactivate impurities in feed or reactors.

Aluminum alkyl or organoaluminum compounds which may be utilized as scavengers or co-activators include, for example, trimethylaluminum, triethylaluminum, triisobutylaluminum, tri-n-hexylaluminum, tri-n-octylaluminum, and dialkyl zinc, such as diethyl zinc.

Chain transfer agents may be used in the compositions and or processes described herein. Useful chain transfer agents are typically hydrogen, alkylalumoxanes, a compound represented by the formula AlR₃, ZnR₂ (where each R is, independently, a C₁-C₈ aliphatic radical, preferably methyl, ethyl, propyl, butyl, penyl, hexyl octyl or an isomer thereof) or a combination thereof, such as diethyl zinc, trimethylaluminum, triisobutylaluminum, trioctylaluminum, or a combination thereof.

### Optional Support Materials

The catalyst system may include one or more inert support materials. The supported material can be a porous support material, for example, talc, and inorganic oxides. Other support materials include zeolites, clays, organoclays, or other organic or inorganic support materials, or mixtures thereof.

The support material can be an inorganic oxide in a finely divided form. Suitable inorganic oxide materials for use in catalyst systems include Groups 2, 4, 13, and 14 metal oxides, such as silica, alumina, and mixtures thereof. Other inorganic oxides that may be employed either alone or in combination with the silica, or alumina are magnesia, titania, or zirconia. Other suitable support materials, however, can be employed, for example, finely divided functionalized polyolefins, such as finely divided polyethylene. Useful supports include magnesia, titania, zirconia, montmorillonite, phyllosilicate, zeolites, talc, or clays. Also, combinations of these support materials may be used, for example, silica-chromium, silica-alumina, or silica-titania. Support materials include Al2O3, ZrO2, SiO2, and combinations thereof, such as SiO2, Al2O3, or SiO2/Al2O3.

The support material, such as an inorganic oxide, can have a surface area of from about 10 m2/g to about 700 m2/g, pore volume of from about 0.1 cm3/g to about 4 cm3/g and average particle size of from about 5 μm to about 500 μm. The surface area of the support material can be of from about 50 m2/g to about 500 m2/g, pore volume of from about 0.5 cm3/g to about 3.5 cm3/g and average particle size of from about 10 μm to about 200 μm. For example, the surface area of the support material is from about 100 m2/g to about 400 m2/g, pore volume from about 0.8 cm3/g to about 3 cm3/g and average particle size is from about 5 μm to about 100 μm. The average pore size of the support material useful in the present disclosure is from 10 Å to 1000 Å, such as 50 Å to about 500 Å, and such as 75 Å to about 350 Å. In at least one embodiment, the support material is a high surface area, amorphous silica (surface area=300 m2/gm; pore volume of 1.65 cm3/gm). Silicas can be marketed under the tradenames of Davison 952 or Davison 955 by the Davison Chemical Division of W.R. Grace and Company. In other embodiments DAVISON 948 is used. Alternatively, a silica can be ES-70™ silica (PQ Corporation, Malvern, Pennsylvania) that has been calcined at 875° C.

The support material should be dry, that is, free of absorbed water. Drying of the support material can be effected by heating or calcining at about 100° C. to about 1000° C., such as at least about 600° C. When the support material is silica, it is heated to at least 200° C., such as about 200° C. to about 850° C., and such as at about 600° C.; and for a time of about 1 minute to about 100 hours, from about 12 hours to about 72 hours, or from about 24 hours to about 60 hours. The calcined support material must have at least some reactive hydroxyl (OH) groups to produce supported catalyst systems of the present disclosure. The calcined support material is then contacted with at least one polymerization catalyst comprising at least one catalyst compound and an activator.

The support material, having reactive surface groups, such as hydroxyl groups, is slurried in a non-polar solvent and the resulting slurry is contacted with a solution of a catalyst compound and an activator. In at least one embodiment, the slurry of the support material is first contacted with the activator for a period of time from about 0.5 hours to about 24 hours, from about 2 hours to about 16 hours, or from about 4 hours to about 8 hours. The solution of the catalyst compound is then contacted with the isolated support/activator. In at least one embodiment, the supported catalyst system is generated in situ. In other embodiments, the slurry of the support material is first contacted with the catalyst compound for a period of time of from about 0.5 hours to about 24 hours, from about 2 hours to about 16 hours, or from about 4 hours to about 8 hours. The slurry of the supported catalyst compound is then contacted with the activator solution.

In certain embodiments, the mixture of the catalyst compound, activator and support is heated to about 0 C to about 70° C., such as about 23 C to about 60 C, such as at room temperature. Contact times may be from about 0.5 hours to about 24 hours, from about 2 hours to about 16 hours, or from about 4 hours to about 8 hours.

Suitable non-polar solvents are materials in which all of the reactants used herein, i.e., the activator and the catalyst compound, are at least partially soluble and which are liquid at reaction temperatures. Non-polar solvents can be alkanes, such as isopentane, hexane, n-heptane, octane, nonane, and decane, although a variety of other materials including cycloalkanes, such as cyclohexane, aromatics, such as benzene, toluene, and ethylbenzene, may also be employed.

In at least one embodiment, the support material includes a support material treated with an electron-withdrawing anion. The support material can be silica, alumina, silica-alumina, silica-zirconia, alumina-zirconia, aluminum phosphate, heteropolytungstates, titania, magnesia, boria, zinc oxide, mixed oxides thereof, or mixtures thereof; and the electron-withdrawing anion is selected from fluoride, chloride, bromide, phosphate, triflate, bisulfate, sulfate, or combination(s) thereof.

The electron-withdrawing component used to treat the support material can be a component that increases the Lewis or Brønsted acidity of the support material upon treatment (as compared to the support material that is not treated with at least one electron-withdrawing anion). In at least one embodiment, the electron-withdrawing component is an electron-withdrawing anion derived from a salt, an acid, or other compound, such as a volatile organic compound, that serves as a source or precursor for that anion. Electron-withdrawing anions can be sulfate, bisulfate, fluoride, chloride, bromide, iodide, fluorosulfate, fluoroborate, phosphate, fluorophosphate, trifluoroacetate, triflate, fluorozirconate, fluorotitanate, phospho-tungstate, or mixtures thereof, or combinations thereof. An electron-withdrawing anion can be fluoride, chloride, bromide, phosphate, triflate, bisulfate, or sulfate, or combination(s) thereof, in at least one embodiment. In at least one embodiment, the electron-withdrawing anion is sulfate, bisulfate, fluoride, chloride, bromide, iodide, fluorosulfate, fluoroborate, phosphate, fluorophosphate, trifluoroacetate, triflate, fluorozirconate, fluorotitanate, or combinations thereof.

Thus, for example, the support material suitable for use in the catalyst systems of the present disclosure can be one or more of fluorided alumina, chlorided alumina, bromided alumina, sulfated alumina, fluorided silica-alumina, chlorided silica-alumina, bromided silica-alumina, sulfated silica-alumina, fluorided silica-zirconia, chlorided silica-zirconia, bromided silica-zirconia, sulfated silica-zirconia, fluorided silica-titania, fluorided silica-coated alumina, sulfated silica-coated alumina, phosphated silica-coated alumina, or combinations thereof. In at least one embodiment, the activator-support can be, or can include, fluorided alumina, sulfated alumina, fluorided silica-alumina, sulfated silica-alumina, fluorided silica-coated alumina, sulfated silica-coated alumina, phosphated silica-coated alumina, or combinations thereof. In another embodiment, the support material includes alumina treated with hexafluorotitanic acid, silica-coated alumina treated with hexafluorotitanic acid, silica-alumina treated with hexafluorozirconic acid, silica-alumina treated with trifluoroacetic acid, fluorided boria-alumina, silica treated with tetrafluoroboric acid, alumina treated with tetrafluoroboric acid, alumina treated with hexafluorophosphoric acid, or combinations thereof. Further, these activator-supports can optionally be treated with a metal ion.

Nonlimiting examples of cations suitable for use in the present disclosure in the salt of the electron-withdrawing anion include ammonium, trialkyl ammonium, tetraalkyl ammonium, tetraalkyl phosphonium, H+, [H(OEt2)2]+, or combinations thereof.

Further, combinations of one or more different electron-withdrawing anions, in varying proportions, can be used to tailor the specific acidity of the support material to a desired level. Combinations of electron-withdrawing components can be contacted with the support material simultaneously or individually, and in any order that provides a desired chemically-treated support material acidity. For example, in at least one embodiment, two or more electron-withdrawing anion source compounds in two or more separate contacting steps.

In at least one embodiment of the present disclosure, one example of a process by which a chemically-treated support material is prepared is as follows: a selected support material, or combination of support materials, can be contacted with a first electron-withdrawing anion source compound to form a first mixture; such first mixture can be calcined and then contacted with a second electron-withdrawing anion source compound to form a second mixture; the second mixture can then be calcined to form a treated support material. In such a process, the first and second electron-withdrawing anion source compounds can be either the same or different compounds.

The method by which the oxide is contacted with the electron-withdrawing component, such as a salt or an acid of an electron-withdrawing anion, can include gelling, co-gelling, impregnation of one compound onto another, or combinations thereof. Following a contacting method, the contacted mixture of the support material, electron-withdrawing anion, and optional metal ion, can be calcined.

According to another embodiment of the present disclosure, the support material can be treated by a process comprising: (i) contacting a support material with a first electron-withdrawing anion source compound to form a first mixture; (ii) calcining the first mixture to produce a calcined first mixture; (iii) contacting the calcined first mixture with a second electron-withdrawing anion source compound to form a second mixture; and (iv) calcining the second mixture to form the treated support material.

### Polymerization Processes

Polymerization processes for making homo VCB polymer or VCB copolymer can be carried out in any suitable manner. For example, any suitable suspension, homogeneous, bulk, solution, slurry, or gas phase polymerization process can be used. Such processes can be run in a batch, semi-batch, or continuous mode. Homogeneous polymerization processes and slurry processes can be used. (A homogeneous polymerization process is a process where at least 90 wt % of the product is soluble in the reaction media.) A bulk homogeneous process can be used. (A bulk process is a process where monomer concentration in all feeds to the reactor is 70 volume % or more.) Alternately, no solvent or diluent is present or added in the reaction medium, (except for the small amounts used as the carrier for the catalyst system or other additives, or amounts found with the monomer; e.g., propane in propylene). In another embodiment, the process is a slurry process. As used herein, the term “slurry polymerization process” means a polymerization process where a supported catalyst is employed and monomers are polymerized on the supported catalyst particles. At least 95 wt % of polymer products derived from the supported catalyst are in granular form as solid particles (not dissolved in the diluent).

Vinylcyclobutane (VCB) monomer, and optionally one or more comonomers, can be contacted with a catalyst system comprising at least one catalyst compound and one or more activators, as described above. The catalyst compound and activator may be combined in any order and may be combined prior to contacting with the monomer.

Suitable comonomers include substituted or unsubstituted C2 to C40 alpha olefins, such as C2 to C20 alpha olefins, such as C2 to C12 alpha olefins, such as ethylene, propylene, butene, pentene, hexene, heptene, octene, nonene, decene, undecene, dodecene and isomers thereof. In at least one embodiment, the monomer is propylene and the optional comonomer is one or more ethylene or C4 to C40 olefins, such as C4 to C20 olefins, such as C6 to C12 olefins. The C4 to C40 olefin monomers may be linear, branched, or cyclic. The C4 to C40 cyclic olefins may be strained or unstrained, monocyclic or polycyclic, and may optionally include heteroatoms and/or one or more functional groups. In at least one embodiment, the monomer includes ethylene and an optional comonomer comprising one or more C3 to C40 olefins, such as C4 to C20 olefins, such as C6 to C12 olefins. The C3 to C40 olefin monomers may be linear, branched, or cyclic. The C3 to C40 cyclic olefins may be strained or unstrained, monocyclic or polycyclic, and may optionally include heteroatoms and/or one or more functional groups.

Exemplary C2 to C40 olefin comonomers include ethylene, propylene, butene, pentene, hexene, heptene, octene, nonene, decene, undecene, dodecene, norbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, such as hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and their respective homologs and derivatives, such as norbornene, norbornadiene, and dicyclopentadiene.

Diolefin comonomers also can be used, and can include any suitable hydrocarbon structure, such as C4 to C30, having at least two unsaturated bonds, where at least two of the unsaturated bonds are readily incorporated into a polymer by either a stereospecific or a non-stereospecific catalyst(s). The diolefin monomers can be selected from alpha, omega-diene monomers (i.e., di-vinyl monomers). The diolefin monomers can be linear di-vinyl monomers, such as those containing from 4 to 30 carbon atoms. Dienes can include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, for example dienes include 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Cyclic dienes can include cyclopentadiene, vinylnorbornene, norbornadiene, ethylidene norbornene, divinylbenzene, dicyclopentadiene or higher ring containing diolefins with or without substituents at various ring positions.

In at least one embodiment, one or more dienes are present in the polymer produced at up to 10 wt %, such as at 0.00001 wt % to 1 wt %, such as 0.002 wt % to 0.5 wt %, such as 0.003 wt % to 0.2 wt %, based upon the total weight of the composition. In at least one embodiment, 500 ppm or less of diene is added to the polymerization, such as 400 ppm or less, such as 300 ppm or less. In other embodiments, at least 50 ppm of diene is added to the polymerization, or 100 ppm or more, or 150 ppm or more.

Suitable diluents/solvents for polymerization include non-coordinating, inert liquids. Examples include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar™); perhalogenated hydrocarbons, such as perfluorinated C4-10 alkanes, chlorobenzene, and aromatic and alkylsubstituted aromatic compounds, such as benzene, toluene, mesitylene, and xylene. Suitable solvents also include liquid olefins which may act as monomers or comonomers including ethylene, propylene, 1-butene, 1-hexene, 1-pentene, 3-methyl-1-pentene, 4-methyl-1-pentene, 1-octene, 1-decene, and mixtures thereof. In at least one embodiment, aliphatic hydrocarbon solvents are used as the solvent, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In another embodiment, the solvent is not aromatic, such as aromatics are present in the solvent at less than 1 wt %, such as less than 0.5 wt %, such as less than 0 wt % based upon the weight of the solvents.

In at least one embodiment, the feed concentration of the VCB monomer and comonomer(s) for the polymerization is 60 vol % solvent or less, such as 40 vol % or less, such as 20 vol % or less, based on the total volume of the feedstream. In at least one embodiment, the polymerization is run in a bulk process.

Polymerizations can be run at any temperature and/or pressure suitable to obtain the desired VCB polymers. Suitable temperatures and/or pressures include a temperature of from about 0° C. to about 300° C., such as about 20° C. to about 200° C., such as about 35° C. to about 150° C., such as from about 40° C. to about 120° C., such as from about 45° C. to about 80° C.; and at a pressure of from about 0.35 MPa to about 10 MPa, such as from about 0.45 MPa to about 6 MPa, such as from about 0.5 MPa to about 4 MPa, such as from about 0.55 MPa to about 3 MPa, such as from about 0.60 MPa to about 2 MPa, such as from about 0.65 MPa to about 1 MPa (such as from about 0.95 psig to about 145 psig).

In a suitable polymerization, the run time of the reaction is up to 300 minutes, such as from about 5 minutes to 250 minutes, such as from about 10 minutes to 120 minutes, such as from about 20 minutes to 90 minutes, such as from about 30 minutes to 60 minutes.

In at least one embodiment, hydrogen is present in the polymerization reactor at a partial pressure of from 0.001 psig to 50 psig (0.007 to 345 kPa), such as from 0.01 psig to 25 psig (0.07 kPa to 172 kPa), such as 0.1 psig to 10 psig (0.7 kPa to 70 kPa).

In at least one embodiment, the activity of the catalyst is about 150 g/mmol/hr or more, alternately 300 g/mmol/hr or more, alternately 450 g/mmol/hr or more, alternately 500 g/mmol/hr or more, alternately 600 g/mmol/hr or more.

In at least one embodiment, the conversion of VCB monomer is at least 10%, based upon polymer yield and the weight of the monomer entering the reaction zone, such as 20% or more, such as 30% or more, such as 50% or more, such as 80% or more.

In at least one embodiment, little or no alumoxane is used in the process to produce the polymers. For example, alumoxane is present at zero mol %, alternately the alumoxane is present at a molar ratio of aluminum to transition metal less than 500:1, such as less than 300:1, such as less than 100:1, such as less than 1:1.

In at least one embodiment, little or no scavenger is used in the process to produce the ethylene polymer. For example, scavenger (such as tri alkyl aluminum) is present at zero mol %, alternately the scavenger is present at a molar ratio of scavenger metal to transition metal of less than 100:1, such as less than 50:1, such as less than 15:1, such as less than 10:1.

In at least one embodiment, the polymerization: 1) is conducted at temperatures of 0 to 300° C. (such as 25 to 150° C., such as 40 to 120° C., such as 45 to 80° C.); 2) is conducted at a pressure of atmospheric pressure to 10 MPa (such as 0.35 to 10 MPa, such as from 0.45 to 6 MPa, such as from 0.5 to 4 MPa, such as from 0.65 to 1 MPa); 3) is conducted in an aliphatic hydrocarbon solvent (such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof; such as where aromatics are present in the solvent at less than 1 wt %, such as less than 0.5 wt %, such as at 0 wt % based upon the weight of the solvents), such as isohexane; 4) where the catalyst system used in the polymerization includes less than 0.5 mol %, such as 0 mol % alumoxane, alternately the alumoxane is present at a molar ratio of aluminum to transition metal less than 500:1, such as less than 300: 1, such as less than 100:1, such as less than 1:1; 5) the polymerization occurs in one reaction zone; 6) the activity of the catalyst compound is at least 200 g/mmol/hr (such as at least 250 g/mmol/hr, such as at least 300 g/mmol/hr); 7) optionally scavengers (such as trialkyl aluminum compounds) are absent (e.g., present at zero mol %, alternately the scavenger is present at a molar ratio of scavenger metal to transition metal of less than 100:1, such as less than 50:1, such as less than 15:1, such as less than 10:1); and 8) optionally, hydrogen is present in the polymerization reactor at a partial pressure of 0.001 to 50 psig (0.007 to 345 kPa) (such as from 0.01 to 25 psig (0.07 to 172 kPa), such as 0.1 to 10 psig (0.7 to 70 kPa)). In at least one embodiment, the catalyst system used in the polymerization includes no more than one catalyst compound.

A “reaction zone” also referred to as a “polymerization zone” is a vessel where polymerization takes place, for example, a batch reactor. When multiple reactors are used in either series or parallel configuration, each reactor is considered as a separate polymerization zone. For a multi-stage polymerization in both a batch reactor and a continuous reactor, each polymerization stage is considered as a separate polymerization zone. In at least one embodiment, the polymerization occurs in one reaction zone. Room temperature is 23° C. unless otherwise noted.

Other additives may also be used in the polymerization, such as one or more scavengers, promoters, modifiers, chain transfer agents (such as diethyl zinc), reducing agents, oxidizing agents, hydrogen, aluminum alkyls, or silanes. Chain transfer agents include alkylalumoxanes, a compound represented by the formula AlR3 or ZnR2 (where each R is, independently, a C1-C8 aliphatic radical, such as methyl, ethyl, propyl, butyl, pentyl, hexyl, octyl or an isomer thereof), or a combination thereof, such as diethyl zinc, methylalumoxane, trimethylaluminum, triisobutylaluminum, trioctylaluminum, or a combination thereof.

### Solution Polymerization

A solution polymerization is a polymerization process in which the polymer is dissolved in a liquid polymerization medium, such as an inert solvent or monomer(s) or their blends. A solution polymerization is typically homogeneous. A homogeneous polymerization is one where the polymer product is dissolved in the polymerization medium. Such systems are not turbid as described in J. Vladimir Oliveira, C. Dariva and J. C. Pinto, Ind. Eng, Chem. Res. 29, 2000, 4627. Solution polymerization may involve polymerization in a continuous reactor in which the polymer formed, the starting monomer and catalyst materials supplied are agitated to reduce or avoid concentration gradients and in which the monomer acts as a diluent or solvent or in which a hydrocarbon is used as a diluent or solvent. Suitable processes can operate at temperatures from about 0° C. to about 250° C., such as from about 50° C. to about 170° C., such as from about 80° C. to about 150° C., such as from about 100° C. to about 140° C., and or at pressures of about 0.1 MPa or more, such as 2 MPa or more. The upper pressure limit is not critically constrained but can be about 200 MPa or less, such as 120 MPa or less, such as 30 MPa or less. Temperature control in the reactor can generally be obtained by balancing the heat of polymerization and with reactor cooling by reactor jackets or cooling coils to cool the contents of the reactor, auto refrigeration, pre-chilled feeds, vaporization of liquid medium (diluent, monomers or solvent) or combinations of all three. Adiabatic reactors with pre-chilled feeds can also be used. The purity, type, and amount of solvent can be optimized for the maximum catalyst productivity for a particular type of polymerization. The solvent can be also introduced as a catalyst carrier. The solvent can be introduced as a gas phase or as a liquid phase depending on the pressure and temperature. Advantageously, the solvent can be kept in the liquid phase and introduced as a liquid. Solvent can be introduced in the feed to the polymerization reactors.

A solution polymerization process may be performed in a batchwise fashion (e.g., batch; semi-batch) or in a continuous process. Suitable reactors may include tank, loop, and tube designs. In at least one embodiment, the process is performed in a continuous fashion and dual loop reactors in a series configuration are used. In at least one embodiment, the process is performed in a continuous fashion and dual continuous stirred-tank reactors (CSTRs) in a series configuration are used. Furthermore, the process can be performed in a continuous fashion and a tube reactor can be used. In another embodiment, the process is performed in a continuous fashion and one loop reactor and one CSTR are used in a series configuration. The process can also be performed in a batchwise fashion and a single stirred tank reactor can be used.

### VCB Polymers and Copolymers

In at least one embodiment, the VCB homopolymer or copolymer has an Mw value of 1,000,000 g/mol or less. In at least one embodiment, the VCB homopolymer and copolymer has an Mw value from 800,000 g/mol to 20,000 g/mol, such as from 500,000 g/mol to 40,000 g/mol, such as from 300,000 g/mol to 60,000 g/mol. The Mw can also range from a low of 70,000 g/mol, 80,000 g/mol, or 90,000 g/mol, to a high of 280,000 g/mol, 240,000 g/mol, or 200,000 g/mol.

In at least one embodiment, the VCB homopolymer or copolymer has an Mw/Mn value of 5 or less, such as from 1 to 4, such as from 1 to 3.1 to 2.

In at least one embodiment, the VCB copolymer has a comonomer content of from 1 wt % to 99.5 wt %, such as from 3 wt % to 95 wt %, or from 15 wt % to 75 wt %, based on the total weight of the VCB copolymer. The comonomer content can also range from a low of about 0.5, 1.0 or 3.0 wt % to a high of about 10, 20 or 45 wt %, based on the total weight of the VCB copolymer.

In at least one embodiment, the catalysts, catalyst systems, and processes of the present disclosure can provide VCB polymers with one or more of: Mn (e.g., 400,000 g/mol or less), Mw values of 800,000 g/mol or greater, narrow PDI (e.g., about 3 or less), comonomer content (if present) of about 1 wt % or greater, at high catalyst activity (e.g., greater than 100 kg polymer per mole of catalyst per hour)

In at least one embodiment, the VCB copolymer has an r1r2 value of 3.0 or less, such as from 0.1 to 2.5, such as from 0.5 to 2.

In at least one embodiment, the VCB polymers and copolymer have a melting point (Tm) of 246° C. or less, such as from 246 to 165, such as from 240 to 180° C. The Tm can also range from a low of about 165° C., 170° C., or 175° C. to a high of about 220° C., 230° C., or 246° C.

In one or more embodiments, the VCB polymer compositions, particularly homopolymers of VCB, are characterized by a composition distribution breadth T₇₅-T₂₅, as measured by TREF, that is less than 15° C., preferably less than 10° C., more preferably 9.1° C. or less, in other embodiments less than 9° C., and in other embodiments less than 6° C.

The T₇₅-T₂₅ value represents the homogeneity of the composition distribution as determined by temperature rising elution fractionation (“TREF”). A TREF curve is produced as described in more detail below. Then the temperature at which 75% of the polymer is eluted is subtracted from the temperature at which 25% of the polymer is eluted, as determined by the integration of the area under the TREF curve. The T₇₅-T₂₅ value represents the difference. The closer these temperatures come together, the narrower the composition distribution.

### Solubility Distribution Breadth Index (SDBI)

In one or more embodiments, the VCB polymer compositions typically have a narrower composition distribution as measured by solubility distribution breadth index (“SDBI”). For example, the VCB polymer compositions, particularly homopolymers of VCB, have a SDBI less than 50° C., or less than 45° C., or less than 40° C. Details for determining the SDBI can be found in WO 1993/003093, published Feb. 18, 1993.

### Blends

In another embodiment, the polymer (such as the VCB homopolymer or VCB copolymer) can be combined with one or more additional polymers prior to being formed into a film, molded part or other article. Other useful polymers include polyethylene, isotactic polypropylene, highly isotactic polypropylene, syndiotactic polypropylene, random copolymer of propylene and ethylene, and/or butene, and/or hexene, polybutene, ethylene vinyl acetate, LDPE, LLDPE, HDPE, ethylene vinyl acetate, ethylene methyl acrylate, copolymers of acrylic acid, polymethylmethacrylate or any other polymers polymerizable by a high-pressure free radical process, polyvinylchloride, polybutene-1, isotactic polybutene, ABS resins, ethylene-propylene rubber (EPR), vulcanized EPR, EPDM, block copolymer, styrenic block copolymers, polyamides, polycarbonates, PET resins, cross linked polyethylene, copolymers of ethylene and vinyl alcohol (EVOH), polymers of aromatic monomers such as polystyrene, poly-1 esters, polyacetal, polyvinylidine fluoride, polyethylene glycols, and/or polyisobutylene.

In at least one embodiment, the polymer (such as the VCB homopolymer or VCB copolymer) is present in the above blends, at from 10 wt % to 99 wt %, based upon the weight of the polymers in the blend, such as 20 wt % to 95 wt %, such as at least 30 wt % to 90 wt %, such as at least 40 wt % to 90 wt %, such as at least 50 wt % to 90 wt %, such as at least 60 to 90 wt %, such as at least 70 wt % to 90 wt %.

The blends described above may be produced by mixing the polymer (VCB homopolymer or VCB copolymer) with one or more other polymers (as described above), by connecting reactors together in series to make reactor blends or by using more than one catalyst in the same reactor to produce multiple species of polymer. The polymers can be mixed together prior to being put into the extruder or may be mixed in an extruder.

The blends may be formed using conventional equipment and methods, such as by dry blending the individual components and subsequently melt mixing in a mixer, or by mixing the components together directly in a mixer, such as, for example, a Banbury mixer, a Haake mixer, a Brabender internal mixer, or a single or twin-screw extruder, which may include a compounding extruder and a side-arm extruder used directly downstream of a polymerization process, which may include blending powders or pellets of the resins at the hopper of the film extruder. Additionally, additives may be included in the blend, in one or more components of the blend, and/or in a product formed from the blend, such as a film, as desired. Such additives can include, for example: fillers; antioxidants (e.g., hindered phenolics such as IRGANOX™ 1010 or IRGANOX™ 1076 available from Ciba-Geigy); phosphites (e.g., IRGAFOS™ 168 available from Ciba-Geigy); anti-cling additives; tackifiers, such as polybutenes, terpene resins, aliphatic and aromatic hydrocarbon resins, alkali metal and glycerol stearates, and hydrogenated rosins; UV stabilizers; heat stabilizers; anti-blocking agents; release agents; anti-static agents; pigments; colorants; dyes; waxes; silica; fillers; and talc.

### EXAMPLES

The following non-limiting examples are provided to better illustrate one or more aspects of the present invention. Several homopolymers and copolymers of vinylcyclobutane were prepared using various single site catalyst systems and activators, as described herein. The resulting VCB homopolymers and copolymers were then evaluated for various thermal properties and behaviors. In the examples that follow, the activator was either MAO or N,N-dimethylanilinium tetrakis(perfluoronaphthalenyl) borate ([DMAH][B(C₁₀F₇)₄]), and the following catalysts A-Q were used:
A=dimethylsilyl(bis(4-(3,5-di-tert-butylphenyl)-2-methyl-indenyl)zirconium dimethyl
B=dimethylsilyl(bis(2-methyl-4-(naphthalen-1-yl)-indenyl))zirconium dimethyl
C=dimethylsilyl(4-(4-(tert-butyl)phenyl)-2-methyl-1,5,6,7-tetrahydro-s-indacenyl) (2,3,4,5-tetramethylcyclopentadienyl) zirconium dichloride
D=dimethylsilyl(4-(4-(tert-butyl)phenyl)-2-methyl-1,5,6,7-tetrahydro-s-indacenyl) (2,3,4,5-tetramethylcyclopentadienyl) hafnium dimethyl
E=dimethylsilyl(4-(2-(isopropyl)phenyl)-2-methyl-1,5,6,7-tetrahydro-s-indacenyl) (2,3,4,5-tetramethylcyclopentadienyl) zirconium dichloride
F=dimethylsilyl (4-([1,1′-biphenyl]-2-yl)-2-hexyl-indenyl)(4-(3,5-di-tert-butyl-4-methoxyphenyl)-2-methyl-indenyl) zirconium dichloride
G=dimethylsilyl(4-(4-(tert-butyl)phenyl)-2-isopropyl-inden-1-yl)(4-(4-(tert-butyl)phenyl)-2-methyl-1,5,6,7-tetrahydro-s-indacenyl) zirconium dichloride
H=dimethylsilyl(bis(indenyl))hafnium dimethyl
I=dimethylsilyl(bis((4s)-4-(9H-carbazol-9-yl)-2-methyl-inden-1-yl)zirconium dimethyl
J=N-tert-butyl-1,1-dimethyl-1-(2,6,6-trimethyl-1,5,6,7-tetrahydro-s-indacenyl) silanaminyl titanium dimethyl
K=N-(1-((1R,3s)-adamantan-1-yl)ethyl)-1-(4-(4-(tert-butyl)phenyl)-2-methyl-indenyl)-1,1-dimethylsilanaminyl titanium dimethyl
L=2′,2′″-(pyridine-2,6-diyl)bis(5-(tert-butyl)-3-adamantyl-[1″,1′″-biphenyl]-2-ate)hafnium dimethyl
M=2′,2′″-(pyridine-2,6-diyl)bis(5-(tert-butyl)-3-adamantyl-[1″,1′″-biphenyl]-2-ate)zirconium dimethyl
N=(R)—N-(2,6-diisopropylphenyl)-2-(8-(phenylamido)-5,6,7,8-tetrahydronaphthalen-1-yl)quinolin-8-amido hafnium dimethyl
O=((cyclopentadienyl(2,7-di-tert-butyl-fluorenyl)silanediyl)bis(4,1-phenylene))bis(triethylsilane) hafnium dimethyl
P=((cyclopentadienyl(2,7-di-tert-butyl-fluorenyl)silanediyl)bis(4,1-phenylene))bis(triethylsilane) zirconium dimethyl
Q=dimethylsilyl(bis(4-(phenyl)-2-methyl-indenyl)zirconium dimethyl

Catalysts A, B, F, G, H, I, O, P and M were obtained from commercial sources. Catalysts C, D, and E were prepared using adapted syntheses described in WO2014099303, WO2017069854, U.S. Pat. No. 9,266,910B2 and WO202134459A1. Catalyst K was prepared according to WO2022155026A1. Catalysts L and M were prepared according to WO2020/167799 and US20200254431.

### Example 1

### General Procedure for Homopolymerization of Vinylcyclobutane.

A 25 mL vial equipped with magnetic stir bar was charged with toluene (typically 1-4 mL) and desired amounts of vinylcyclobutane (typically 1-4 mL). While stirring, a toluene solution of activator and catalyst (typically 0.5-4.0 μmol) was introduced. In the case of ionic activator, N,N-dimethylanilinium tetrakis(perfluoronaphthalenyl)borate ([DMAH][B(C₁₀F₇)₄]) was added in 1.0-1.1 equiv relative to catalyst. When MAO was used, between 500-1000 equivalents were added. Upon catalyst and activator injection, the vial were sealed and heated to a desired temperature (Tₚ, typically 25-120° C.). The reactions were allowed to proceed for desired amount of time (typically 10-60 minutes). The reactions were then quenched by opening to air and the polymer was precipitated with ca 5 mL of acetone, filtered and dried in vacuo. Table 1 below summarizes the catalyst, activators, and loadings that were used and the resulting VCB polymer properties.

TABLE 1
Homopolymerization of vinylcyclobutane with variety of single site catalysts.

| | | Cat. | | | | | | | | | | | |
|---|---|---|---|---|---|---|---|---|---|---|---|---|---|
| Run | Cata- | Loading | | Tₚ | VCB:Toluene | Time | Yield | A (g/ | | | | | |
| # | lyst | (μmol) | Activator | (° C.) | ratio (mL) | (h) | (g) | (mmol · h)) | Mₙ | M_{w} | M_{z} | PDI | Tₘ |
| 1 | B | 1.50 | MAO | 25 | 2:3 | 0.25 | 0.297 | 818 | 23,704 | 55,348 | 86,512 | 2.34 | 197 |
| 2 | F | 1.50 | MAO | 25 | 2:3 | 0.25 | 0.231 | 636 | 21,019 | 44,925 | 64,088 | 2.14 | 204 |
| 3 | E | 1.50 | MAO | 25 | 2:3 | 0.25 | 0.611 | 1682 | 7,127 | 17,813 | 71,001 | 2.50 | 230 |
| 4 | A | 1.50 | [DMAH][B(C₁₀F₇)₄] | 25 | 2:3 | 0.25 | 0.195 | 537 | 26,948 | 63,215 | 93,111 | 2.35 | 189 |
| 5 | D | 1.50 | [DMAH][B(C₁₀F₇)₄] | 70 | 2:3 | 0.16 | 0.701 | 2895 | 3,428 | 7,371 | 20,157 | 2.15 | 216 |
| 6 | C | 1.50 | [DMAH][B(C₁₀F₇)₄] | 70 | 2:3 | 0.33 | 0.512 | 1057 | 2,831 | 5,044 | 7,907 | 1.78 | 212 |
| 9 | A | 2.50 | [DMAH][B(C₁₀F₇)₄] | 25 | 1:4 | 1.0 | 0.055 | 22 | — | — | — | — | 176 |
| 10 | A | 2.50 | [DMAH][B(C₁₀F₇)₄] | 75 | 1:4 | 1.0 | 0.165 | 66 | — | — | — | — | 151 |
| 11 | N | 2.50 | [DMAH][B(C₁₀F₇)₄] | 75 | 1:4 | 1.0 | 0.106 | 42 | — | — | — | — | 178 |
| 12 | H | 2.50 | [DMAH][B(C₁₀F₇)₄] | 75 | 1:4 | 1.0 | 0.220 | 88 | — | — | — | — | 192 |
| 13 | M | 2.00 | [DMAH][B(C₁₀F₇)₄] | 25 | 2:3 | 2.50 | 0.115 | 23 | 18,480 | 50,179 | 82,874 | 2.72 | — |
| 14 | I | 2.00 | [DMAH][B(C₁₀F₇)₄] | 70 | 2:3 | 18.0 | 0.550 | 15 | 8,447 | 22,148 | 37,042 | 2.62 | — |
| 15 | K | 4.00 | MAO | 25 | 2:3 | 0.25 | 0.115 | 115 | 20,532 | 61,351 | 104,981 | 2.99 | — |
| 16 | K | 4.00 | [DMAH][B(C₁₀F₇)₄] | 25 | 2:3 | 0.25 | 0.226 | 226 | 21,110 | 67,224 | 117,060 | 3.18 | — |
| 17 | F | 2.50 | [DMAH][B(C₁₀F₇)₄] | 75 | 1:4 | 1.0 | 0.360 | 144 | — | — | — | — | 163 |
| 18 | L | 2.50 | [DMAH][B(C₁₀F₇)₄] | 25 | 1:4 | 1.0 | 0.215 | 86 | — | — | — | — | 215, 206 |
| 19 | L | 2.50 | [DMAH][B(C₁₀F₇)₄] | 75 | 1:4 | 1.0 | 0.640 | 256 | — | — | — | — | 215 |
| 20 | L | 1.25 | [DMAH][B(C₁₀F₇)₄] | 75 | 2:3 | 1.0 | 0.610 | 488 | — | — | — | — | 216, 209 |
| 21 | L | 3.75 | [DMAH][B(C₁₀F₇)₄] | 75 | 2:3 | 1.0 | 1.180 | 315 | — | — | — | — | 216, 210 |
| 22 | L | 2.50 | [DMAH][B(C₁₀F₇)₄] | 75 | 4:1 | 1.0 | 2.230 | 892 | — | — | — | — | 216, 210 |
| 23 | L | 2.50 | [DMAH][B(C₁₀F₇)₄] | 75 | 1:4 | 0.25 | 0.415 | 664 | 24,670 | 69,962 | 126,859 | 2.84 | 217, 210 |
| 24 | L | 2.50 | [DMAH][B(C₁₀F₇)₄] | 75 | 1:4 | 0.25 | 0.316 | 504 | 20,516 | 50,146 | 85,851 | 2.44 | 217, 210 |
| 25 | L | 0.50 | [DMAH][B(C₁₀F₇)₄] | 75 | 1:4 | 1.0 | 0.065 | 129 | — | — | — | — | — |
| 26 | L | 0.50 | [DMAH][B(C₁₀F₇)₄] | 100 | 1:3 | 1.0 | 0.429 | 857 | 14,638 | 32,976 | 53,537 | 2.25 | 234.1 |
| 27 | L | 0.50 | [DMAH][B(C₁₀F₇)₄] | 120 | 1:3 | 1.0 | 0.646 | 1292 | 7,653 | 16,162 | 25,824 | 2.11 | 234.0 |
| 28 | M | 0.50 | [DMAH][B(C₁₀F₇)₄] | 75 | 1:3 | 1.0 | 0.066 | 131 | — | — | — | — | — |
| 29 | M | 0.50 | [DMAH][B(C₁₀F₇)₄] | 100 | 1:3 | 1.0 | 0.429 | 857 | 4,659 | 11,011 | 19,320 | 2.38 | 216.9 |
| 30 | M | 0.50 | [DMAH][B(C₁₀F₇)₄] | 120 | 1:3 | 1.0 | 1.142 | 2284 | 3,095 | 7,173 | 12,688 | 2.32 | 214.7 |

The results presented in Table 1 indicate that vinylcyclobutane can be effectively polymerized at variety of conditions, concentrations and with a wide variety of single site catalysts which included, metallocenes, half metallocenes (CGC complexes) and post-metallocenes. At the same time, the same catalysts produced a wide product slate with a variety of molecular weights and polymer crystallinities. Surprisingly, the prepared polymers had high melting points-in many cases the melting temperatures exceeded 200° C. as shown in Table 1.

### General Procedure for Larger Scale Homopolymerizations of Vinylcyclobutane.

A reaction vessel was charged with solvent (isohexane or toluene), vinylcyclobutane (100 or 200 mL), and scavenger (neat TIBAL or TNOAL, 25 wt % in hexanes), then stirred and optionally heated to desired temperature (Tₚ, 50° C. or ambient temperature). A solution of catalyst L and activator N,N-dimethylanilinium tetrakis(perfluoronaphthalenyl)borate ([DMAH][B(C₁₀F₇)₄], 1.0 -1.1 equiv) was then introduced to the reactor. The reaction was allowed to proceed for desired amount of time (typically 3-48 hours). The reaction was then quenched by opening to air and the polymer was precipitated with acetone, filtered and dried in vacuo. Table 2 below summarizes the results.

TABLE 2
Homopolymerization of vinylcyclobutane with catalyst L and [DMAH][B(C₁₀F₇)₄] with additional characterization.

| | Cat | | | TNOAL | Iso- | | | Time | Activ- | | | | En- | | | |
|---|---|---|---|---|---|---|---|---|---|---|---|---|---|---|---|---|
| | Load- | | | (mL, 25 | hex- | Tolu- | | at | ity (g/ | | | | thal- | TREF | T₇₅ − | |
| | ing | VCB | TIBAL | wt % in | ane | ene | Tₚ | Quench | mmol · | Tₘ*** | | | py | Peak(s) | T₂₅ | |
| Run | (μmol) | (mL) | (mg) | hexanes) | (mL) | (mL) | (° C.) | (h) | h) | (° C.) | Mn | Mw | (J/g) | (° C.) | (° C.) | SDBI |
| 31 | 62.5 | 100 | 250 | | 0 | 300 | 50 | 5 | 136 | 235 | 70,825 | 193,414 | 39 | | | |
| 32 | 62.5 | 100 | | 1 | 300 | | 50 | 3 | 279 | 242 | 88,211 | 222,974 | 38 | 156.3 | 5.2 | 39.4 |
| 33 | 125 | 200 | | 2 | 600 | | 50 | 5 | 205 | 241 | 102,432 | 275,133 | 35 | 156.5 | 4.4 | 35.2 |
| 34 | 10 | 200 | 20 | | 650 | 20 | am- | 48 | 92 | 246 | 144,780 | 381,486 | 41 | 148, | 8.8 | 40.9 |
| | | | | | | | bient | | | | | | | 158.8 | | |
| 35 | 125 | 200 | | 2 | 600 | | 50 | 4 | 250 | 242 | 95,340 | 241,823 | 38 | 157.3 | 9.1 | 40.8 |

### Example 2: Vinylcyclobutane Co-Polymerized With Ethylene to Yield Linear Low Density Polyethylenes and Ethylene Based Plastomers

### General Procedure for Preparation of Ethylene Based Plastomers and LLDPE Containing VCB.

Polymerizations were carried out in a parallel pressure reactor, as generally described in U.S. Pat. Nos. 6,306,658; 6,455,316; 6,489,168; WO 00/09255; and Murphy et al., J. Am. Chem. Soc., 2003, 125, 4306-4317 each of which is fully incorporated herein by reference to the extent not inconsistent with this specification. Ethylene-VCB (E-VCB) copolymerizations were carried out under high-throughput conditions according to the following general procedure. A pre-weighed glass vial insert and disposable stirring paddle were fitted to each reaction vessel of the reactor, which contains 48 individual reaction vessels. The reactor was then closed and ethylene gas was introduced at a desired pressure. Then solvent (typically the isohexane) was added to bring the total reaction volume, including the subsequent additions, to 5 mL and the reactor vessels were heated to their set temperature (usually from about 50° C. to about 110° C.). The contents of the vessel were stirred at 800 rpm. An activator solution (typically 1.1 molar equivalents relative to catalyst in toluene) was then injected into the reaction vessel along with 500 microliters of isohexane, followed by addition of purified vinycyclobutane (typically 50-300 μL). Catalyst (typically 0.50 mM in toluene, such as 20-40 nmol of catalyst) and another aliquot of isohexane (500 microliters) were then added to initiate the reaction. Equivalence is determined based on the mol equivalents relative to the moles of the transition metal in the catalyst complex. The reaction was then allowed to proceed until a pre-determined amount of pressure had been taken up by the reaction. Alternatively, the reaction was allowed to proceed for a set amount of time. At this point, the reaction was quenched by pressurizing the vessel with compressed air. After the polymerization reaction, the glass vial insert containing the polymer product and solvent was removed from the pressure cell and the inert atmosphere glove box, and the volatile components were removed using a Genevac HT-12 centrifuge and Genevac VC3000D vacuum evaporator operating at elevated temperature and reduced pressure. The vial was then weighed to determine the yield of the polymer product. The resultant polymer was analyzed by Rapid GPC (see below) to determine the molecular weight and by DSC to determine melting point.

To determine various molecular weight related values by GPC, high temperature size 5 exclusion chromatography was performed using an automated “Rapid GPC” system as generally described in U.S. Pat. Nos. 6,491,816; 6,491,823; 6,475,391; 6,461,515; 6,436,292; 6,406,632; 6,175,409; 6,454,947; 6,260,407; and 6,294,388, each of which is fully incorporated herein by reference for US purposes. This apparatus has a series of three 30 cm×7.5 mm linear columns, each containing PLgel 10 μm, Mix B. The GPC system was calibrated using polystyrene standards ranging from 580-3,390,000 g/mol. The system was operated at an eluent flow rate of 2.0 mL/minutes and an oven temperature of 165° C. 1,2,4-trichlorobenzene was used as the eluent. The polymer samples were dissolved in 1,2,4-trichlorobenzene at a concentration of 0.1-0.9 mg/mL. 250 uL of a polymer solution was injected into the system. The concentration of the polymer in the eluent was monitored using an evaporative light scattering detector (as shown by the examples in Table 3) or Polymer Char IR4 detector. The molecular weights presented are relative to linear polystyrene standards and are uncorrected.

Table 3 below shows the data from the ethylene-VCB polymerizations. The reaction conditions were 20-115 psi of ethylene with 20-30 nmol of catalyst in isohexane at 100° C. and a vinylcyclobutane gradient ranging from 50-300 uL. The catalyst was activated with [DMAH][B(C₁₀F₇)₄]. Runs 36-65 describe ethylene rich compositions of E-VCB copolymers, while the runs 43-48 describe vinylcyclobutane rich compositions. Highly VCB rich compositions are described in runs 49-56.

TABLE 3
ethylene-vinylcyclobutane (E-VCB) copolymerization data

| | | | | Activity | | | VCB in | |
|---|---|---|---|---|---|---|---|---|
| | | Ethylene | VCB | (kg/ | M_{w} | Tₘ | polymer | |
| Run | Catalyst | (psi) | (μL) | mmol · h) | (g/mol) | (° C.) | (wt %) | r1r2 |
| 36 | O | 115 | 50 | 187.9 | 665,190 | 86.1 | 15.6 | 0.1606 |
| 37 | O | 115 | 100 | 196.4 | 529,345 | 54.8 | 24.8 | 0.2750 |
| 38 | O | 115 | 150 | 132.5 | 421,714 | — | 31.6 | 0.1083 |
| 39 | O | 115 | 200 | 96.88 | 365,814 | — | 40.8 | 0.2387 |
| 40 | J | 115 | 50 | 234.8 | 449,914 | 104.1 | 8.9 | 2.4964 |
| 41 | J | 115 | 100 | 261.8 | 325,910 | 93.2 | 15.4 | 1.5436 |
| 42 | J | 115 | 150 | 167.4 | 231,560 | 82.1 | — | — |
| 43 | J | 115 | 200 | 105.8 | 168,038 | 77.1 | 24.2 | 1.4846 |
| 44 | L | 115 | 50 | 315.6 | 471,980 | 90.1 | 16.2 | 0.7417 |
| 45 | L | 115 | 100 | 214.1 | 409,551 | 67.6 | 24.8 | 0.8826 |
| 46 | L | 115 | 150 | 140.5 | 383,453 | 43.7 | 27.1 | 0.5182 |
| 47 | L | 115 | 200 | 70.2 | 366,485 | — | 37.4 | 0.7881 |
| 48 | K | 115 | 50 | 29.1 | 1,869,103 | 90.0 | 16.3 | 0.8880 |
| 49 | K | 115 | 100 | 24.4 | 1,518,438 | — | 27.6 | 0.9137 |
| 50 | K | 115 | 150 | 79.8 | 1,586,534 | — | 27.5 | 0.6476 |
| 51 | K | 115 | 200 | 63.6 | 1,540,641 | — | 31.5 | 0.6024 |
| 52 | H | 20 | 300 | 4.3 | 94,297 | — | 75.7 | |
| 53 | O | 20 | 300 | 1.7 | 138,414 | — | 78.0 | |
| 54 | J | 20 | 300 | 3.4 | 33,028 | — | — | |
| 55 | N | 20 | 300 | 1.8 | 434,476 | — | 71.2 | |
| 56 | L | 20 | 300 | 1.8 | 510,867 | — | 39.8 | |
| 57 | Q | 20 | 300 | 8.2 | 198,398 | — | 77.7 | |
| 58 | F | 10 | 800 | 10.5 | 113,531 | — | | |
| 59 | F | 20 | 800 | 10.8 | 86,350 | — | | |
| 60 | G | 10 | 800 | 6.6 | 171,786 | — | | |
| 61 | G | 20 | 800 | 9.4 | 207,786 | — | | |
| 62 | L | 10 | 800 | 0.6 | 208,037 | — | | |
| 63 | L | 20 | 800 | 1.6 | 257,008 | — | | |
| 64 | P | 10 | 800 | 43.0 | 62,030 | — | | |
| 65 | P | 20 | 800 | 65.1 | 77,811 | — | | |

### Example 3: Copolymerization of Vinylcyclobutane With α-Olefin

Vinylcyclobutane (20 mL) and toluene (80 mL) and an a-olefin such as 1-hexene, 1-octene or 1-decene (typically 0.1-1 mL) were combined in a 500 mL pressure vessel. TIBAL (100 umol) was then added, the pressure vessel was sealed and heated to 50° C. Once at 50° C., a combined solution of catalyst L (12.5 umol) and dimethylanilinium tetrakis(pentrafluorophenylborate) (13.75 umol) was added. The pressure vessel was quickly sealed and the temperature was ramped to 55° C. with stirring (500 RPM). After desired time period (typically 1-4 hours), the vessel was cooled to room temperature and the polymer was slurried in 100 mL of hexane and filtered on a disposable plastic frit. 20 mg of Irganox 1076 (as toluene solution) was then added and the polymers was thoroughly mixed then poured into a glass dish for drying. Table 4 below summarizes the results of polymerization.

TABLE 4
Copolymers of vinylcyclobutane with α-olefin

| | | | | | | | Alpha- |
|---|---|---|---|---|---|---|---|
| | | | | | | | olefin |
| | Co- | Tₘ | Tc | Mn | Mw | | content |
| Run# | monomer | (° C.) | (° C.) | (g/mol) | (g/mol) | Mw/Mn | (mol %) |
| 66 | 1-Hexene | 213 | 183 | 48,930 | 117,387 | 2.4 | 3.6 |
| 67 | 1-Hexene | 193 (203) | 159 | 43,247 | 103,758 | 2.4 | 14.8 |
| 68 | 1-Hexene | 184 (176) | 132 | 41,677 | 96,238 | 2.31 | 19.2 |
| 69 | 1-Hexene | 169 (160) | 105 | 40,640 | 93,121 | 2.29 | 24.3 |
| 70 | 1-Octene | 223 | 193 | 50,701 | 118,567 | 2.34 | 2.9 |
| 71 | 1-Octene | 213 (219) | 180 | 46,870 | 115,999 | 2.47 | 1.3 |
| 72 | 1-Octene | 209 | 167 | 47,947 | 115,756 | 2.41 | 3.3 |
| 73 | 1-Decene | 223 | 192 | 47,693 | 116,542 | 2.44 | BDL |
| 74 | 1-Decene | 212 (218) | 179 | 48,334 | 116,905 | 2.42 | 1.9 |
| 75 | 1-Decene | 208 | 163 | 48,276 | 117,079 | 2.43 | 3.3 |
| 76 | none | 235 | 207 | 42,197 | 115,281 | 2.73 | N/A |

### Example 4: Copolymerization of Propylene With Vinylcyclobutane

A 1 L autoclave reactor equipped with a mechanical stirrer was used for polymer preparation. Prior to the run, the reactor was placed under nitrogen purge while maintaining 90° C. temperature for 30 minutes. Upon cooling back to ambient temperature, propylene feed (500 mL), scavenger (0.2 mL of 1M TIBAL, triisobutylaluminum), a desired amount of vinylcyclobutane (typically 10-20 mL), and optionally hydrogen (charged from a 50 mL bomb at a desired pressure) were introduced to the reactor and were allowed to mix for 5 minutes. Approximately 25 mg supported metallocene catalyst C (prepared according to general methods described in US20220315680A1) was then introduced to the reactor by flushing the pre-determined amount of catalyst slurry (5 wt % in mineral oil) from a catalyst tube with 100 mL of liquid propylene. The reactor was kept for 5 minutes at room temperature (pre-polymerization stage), before raising the temperature to 70° C. The reaction was allowed to proceed at that temperature for a desired time period (typically 30 min). After the given time, the temperature was reduced to 25° C., the excess propylene was vented off and the polymer granules were collected, and dried in air overnight. Table 5 below summarizes the results of polymerization results and polymer characterization. The presence of incorporated vinylcyclobutane units (runs #78-79) is evident based on ¹³C NMR data, as well as via expected reduction in polymer melting point (Tm) relative to iPP control (run #77).

TABLE 5
Copolymer of propylene with vinylcyclobutane

| | | | | | | Comonomer | VCB | |
|---|---|---|---|---|---|---|---|---|
| | | VCB | | | | Content | Content | Tₘ |
| Run# | Comonomer | (mL) | Mn | Mw | Mw/Mn | (mol %) | (mol %) | (° C.) |
| 77 | propylene | 0 | 64,949 | 256,071 | 3.94 | 100 | 0 | 159 |
| 78 | propylene | 10 | 53,391 | 177,540 | 3.33 | 99.5 | 0.5 | 150 |
| 79 | propylene | 20 | 49,074 | 175,785 | 3.58 | 99 | 1 | 146 |

### Comparative Example: VCB Polymerization Using Ziegler-Natta Catalyst

A 600 mL Parr reactor equipped with a glass liner was purged under N₂ flow at 140° C. for 1 hour. The unit was then taken into the glovebox, where it was pre-charged with 100 mL vinylcyclobutane and 100 mL of hexane, and desired quantity of aluminum alkyl (typically 2.5 mmol). The desired amount of commercially available ZN catalyst (typically 30-60 mg) was placed in a catalyst tube, along with aluminum alkyl (typically 2.5 mmol) and optionally external donor. Approximately 20 psi of hydrogen was added to the reactor at room temperature. Once at 70° C., the catalyst was injected into the reactor at 70° C. with high-pressure nitrogen. The reaction was allowed to proceed for 1 hour. The reactor was then cooled to room temperature, vented, and the polymer was filtered on a glass frit and dried in vacuo. Table 6 below summarizes the results of polymerization

TABLE 6
Comparative Ziegler Natta polymers

| | | | Al- | | | | | | |
|---|---|---|---|---|---|---|---|---|---|
| ZN | | Cat | alkyl | H2 | Yield | Activity | | | |
| Catalyst | Donor | (mg) | (mmol) | (psi) | (g) | (g/g) | Mn | Mw | Mw/Mn |
| 4^{th} Gen. | C | 30.0 | 4.5 | 19 | 11.4 | 380 | 5,112 | 20,916 | 4.09 |
| (phthalate) | | | | | | | | | |
| 5^{th} Gen. | — | 53.0 | 5 | 19 | 31.7 | 598 | — | — | — |
| (diether) | | | | | | | | | |

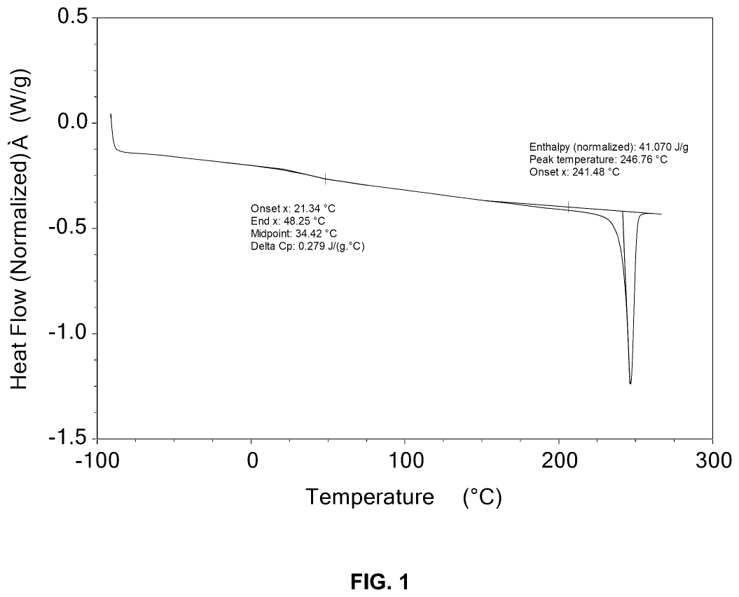

FIG. 1 shows the thermal behavior of poly(vinylcyclobutane) made according to conditions outlined in run #34 which exhibits glass transition temperature of 34° C. and a high melting point of 246° C. unique to homopolymer composition. Such high melting point is unusual compared to conventional poly(olefins) and is higher than that reported for poly(vinylcyclobutane) produced by prior art Z/N catalyst systems.

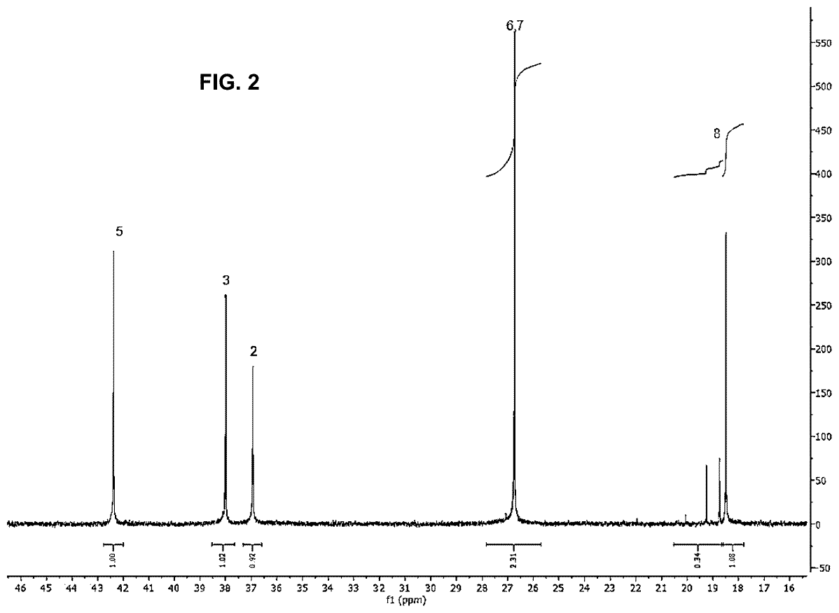

FIG. 2 shows ¹³C NMR spectroscopic data for the poly(vinylcyclobutane) prepared according to the conditions described in run #32. FIG. 2 also confirms isotacic structure of the vinylcyclobutane units.

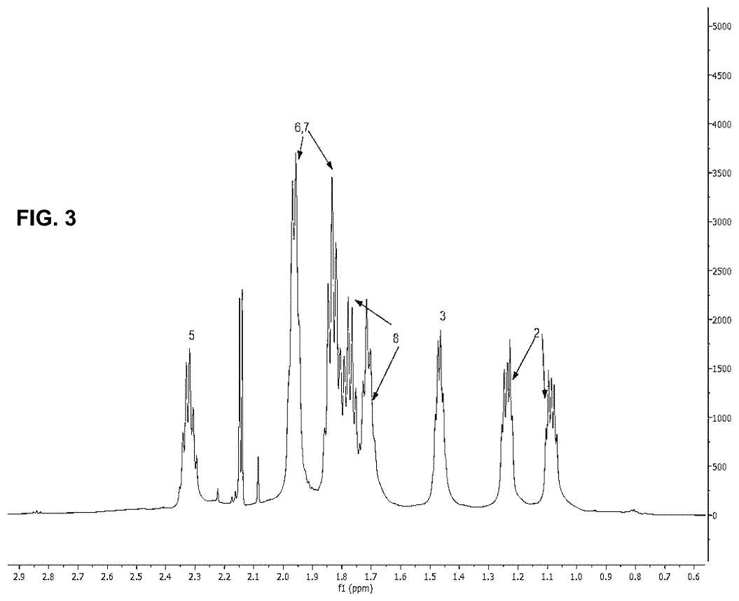

FIG. 3 shows ¹H NMR spectroscopic data for the poly(vinylcyclobutane) prepared according to conditions outlined for run #32. The ¹H NMR spectrum confirms the presence of cyclic 4-carbon ring structures consistent with the assignment for poly(vinylcyclobutane).

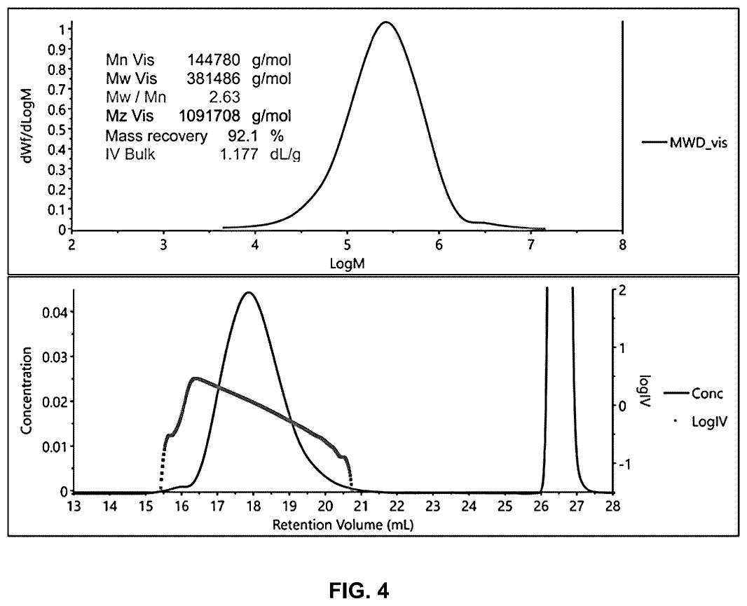

FIG. 4 shows GPC data for the poly(vinylcyclobutane) polymer prepared according to conditions outlined in run #34. The GPC data confirmed a narrow PDI (PDI=2.6) and a high Mw >300,000 g/mol. Such narrow PDI value is unique to usage of single site catalysts in preparation of poly(vinylcyclobutane).

### DSC Procedure for Polymers in Table 1

For VCB homopolymers in Table 1, melting Temperature, Tₘ, is measured by differential scanning calorimetry (“DSC”) using a DSCQ200 unit. The sample is first equilibrated at 25° C. and subsequently heated to 280° C. using a heating rate of 10° C./min (first heat). The sample is held at 280° C. for 3 min. The sample is subsequently cooled down to −10° C. with a constant cooling rate of 10° C./min (first cool). The sample is equilibrated at −10° C. before being heated to 280° C. at a constant heating rate of 10° C./min (second heat). The exothermic peak of crystallization (first cool) is analyzed using the TA Universal Analysis software and the corresponding to 10° C./min cooling rate is determined. The endothermic peak of melting (second heat) is also analyzed using the TA Universal Analysis software and the peak melting temperature (Tₘ) corresponding to 10° C./min heating rate is determined.

### DSC Procedure for Polymers in Table 2

For VCB homopolymers in Table 2, Tₘ is measured by DSC using a DSCQ2000 unit, using a Tzero pan and lid and a cool/heat/cool/heat/cool/heat procedure. The sample is first cooled to −90° C. from 40° C. (first cool) at 10° C./min and subsequently heated to 270° C. using a heating rate of 10° C./min (first heat). The sample is subsequently cooled down to −90° C. with a constant cooling rate of 10° C./min (second cool). Then heated to 270° C. at a constant heating rate of 10° C./min (second heat). The sample was then cooled at 2° C./min to −90° C. (third cool) and then heated to 270° C. at 10° C./min (third heat). Tₘ is taken as the peak location of the melting peak from the heating ramp following the 2° C./min cooling segment. Enthalpy of melting is taken from the melting endotherm of the heating ramp following the 2° C./min cooling segment. The melting peak was integrated using a linear baseline between approximately 150° C. and flat baseline following the melting endotherm.

### DSC Procedure for E-VCB Copolymers in Table 3

For the high throughput samples in Table 3, Tₘ was measured by DSC using commercially available equipment such as a TA Instruments TA-Q200 DSC. Typically, 5 to 10 mg of molded polymer or plasticized polymer is sealed in an aluminum pan and loaded into the instrument at about room temperature. Samples were pre-annealed at about 220° C. for about 15 minutes and then allowed to cool to about room temperature overnight. The samples were then heated to about 220° C. at a heating rate of about 100° C./min, held at this temperature for at least about 5 minutes, and then cooled at a rate of about 50° C./min to a temperature typically at least about 50° C. below the crystallization temperature. Melting points were collected during the heating period.

### DSC Procedure for Polymers in Table 4:

For polymers listed in Table 4, melting Temperature, Tₘ, is measured by DSC using a TA Instruments Q2000 using Tzero pan and lid.

For copolymers with 1-hexene, a heat/cool/heat procedure was performed to obtain thermal behavior from the initiation state. The sample is first heated to 250° C. using a heating rate of 10° C./min (first heat). The sample is subsequently cooled down to 0° C. with a constant cooling rate of 10° C./min (first cool). Then heated to 250° C. at a constant heating rate of 10° C./min (second heat). Tₘ is taken as the peak location of the melting peak from the second heat. T_{c} is taken as the peak location of the crystallization exotherm from the first cooling cycle.

For copolymers with 1-octene or 1-decene, a cool/heat/cool/heat procedure was performed to obtain thermal behavior from the initiation state. The sample is first cooled to −90° C. (first cool) at 10° C./min and subsequently heated to 250° C. using a heating rate of 10° C./min (first heat). The sample is subsequently cooled down to −90° C. with a constant cooling rate of 10° C./min (second cool). Then heated to 250° C. at a constant heating rate of 10° C./min (second heat).

### DSC Procedure for Polymers in Table 5:

For VCB homopolymers in Table 1, melting Temperature, Tₘ, was measured by differential scanning calorimetry (“DSC”) using a DSCQ200 unit. The sample was first equilibrated at 25° C. and subsequently heated to 280° C. using a heating rate of 10° C./min (first heat). The sample was held at 280° C. for 3 min. The sample was subsequently cooled down to −10° C. with a constant cooling rate of 10° C./min (first cool). The sample was equilibrated at −10° C. before being heated to 280° C. at a constant heating rate of 10° C./min (second heat). The exothermic peak of crystallization (first cool) was analyzed using the TA Universal Analysis software and the corresponding to 10° C./min cooling rate is determined. The endothermic peak of melting (second heat) was also analyzed using the TA Universal Analysis software and the peak melting temperature (Tₘ) corresponding to 10° C./min heating rate was determined.

TREF Method for pVCB Homopolymers

Temperature Rising Elution Fractionation (TREF) analysis was done using a Crystallization Elution Fractionation (CEF) instrument from Polymer Char, S.A., Valencia, Spain. The principles of CEF analysis and a general description of the particular apparatus used are given in the article Monrabal, B. et al. Crystallization Elution Fractionation. A New Separation Process for Polyolefin Resins. Macromol. Symp. 2007, 257, 71. In particular, a process conforming to the “TREF separation process” shown in FIG. 1a of this article, in which F_{c}=0, was used. Pertinent details of the analysis method and features of the apparatus used are as follows.

The solvent used for preparing the sample solution and for elution was 1,2,4-Dichlorobenzene (TCB) filtered using a 0.1-μm Teflon filter (Millipore). The sample (16-32 mg) to be analyzed was dissolved in 8 ml of TCB metered at ambient temperature by shaking (Medium setting) at 170° C. for 90 min. A small volume of the polymer solution was first filtered by an inline filter (stainless steel, 10 μm), which is back-flushed after every filtration. The filtrate was then used to completely fill a 200-μl injection-valve loop. The volume in the loop was then introduced near the center of the CEF column (15-cm long SS tubing, ⅜″ o.d., 7.8 mm i.d.) packed with an inert support (SS balls) at 170° C., and the column temperature was stabilized at 170° C. for 20 min.

The sample volume was then allowed to crystallize in the column by reducing the temperature to 60° C. at a cooling rate of 1° C./min. The column was kept at 60° C. for 10 min before injecting the TCB flow (1 ml/min) into the column for 10 min to elute and measure the polymer that did not crystallize (soluble fraction). The wide-band channel of the infrared detector used (Polymer Char IR4) generates an absorbance signal that is proportional to the concentration of polymer in the eluting flow. A complete TREF curve was then generated by increasing the temperature of the column from 0 to 180° C. at a rate of 2° C./min while maintaining the TCB flow at 1 ml/min to elute and measure the concentration of the dissolving polymer. The TREF curve was further processed as follows:
1. The solvent-only response of the instrument was generated and subtracted from the TREF curve of the sample. The solvent-only response is generated by running, typically before, the same method as used for the polymer sample, but without any polymer added to the sample vial; using the same solvent reservoir as for the polymer sample and without replenishing with fresh solvent; and within a reasonable proximity of time from the run for the polymer sample.
2. The temperature axis of the TREF curve was appropriately shifted to correct for the delay in the IR signal caused by the column-to-detector volume. This volume is obtained by first filling the injection-valve loop with a ˜1 mg/ml solution of an HDPE resin; then loading the loop volume in the same location within the column where a sample is loaded for TREF analysis; then directly flowing, at a constant flow rate of 1 ml/min, the hot solution towards the detector using an isothermal method; and then measuring the time after injection for the HDPE probe's peak to appear in the IR signal. The delay volume (ml) is therefore equated to the time (min).
3. The curve was baseline corrected and appropriate integration limits were selected. And the curve was normalized so that the area of the curve is 100 wt %.

### Gel Permeation Chromatography (GPC)

For purposes of the claims, and unless otherwise indicated, the distribution and the moments of molecular weight (Mw, Mn, Mz, Mw/Mn, etc.) are determined by using a high temperature Gel Permeation Chromatography (Polymer Char GPC-IR) equipped with a multiple-channel band-filter based Infrared detector IR5 and a four capillary Wheatstone bridge viscometer. Three Agilent PLgel 10-μm Mixed-B LS columns are used to provide polymer separation. Reagent grade 1,2,4-trichlorobenzene (TCB) (from Sigma-Aldrich) including ˜300 ppm antioxidant BHT is used as the mobile phase at a nominal flow rate of ˜1 mL/min. The whole system operates at a temperature of 145° C. Polymer samples are weighed and sealed in standard 10 ml Agilent vials with ˜10 μL flow marker (heptane) added for flow rate correction. The sample vials are then loaded to an autosampler which provides automatic solvent filling and dissolution at 160° C. with continuous shaking. The nominal injection volume is 200 μL and the polymer solution concentration ranges from 0.5 to 2.5 mg/mL.

Due to the absence of dn/dc and Mark-Houwink parameters for VCB polymers, the molecular weight was determined from universal calibration relationship and intrinsic viscosity. The intrinsic viscosity at each point in the chromatogram or each elution volume slice, [η]ᵢ, was calculated from the equation [η]ᵢ=ηₛₚᵢ/cᵢ, where the ηₛₚᵢ is the specific viscosity measured from viscometer while the cᵢ is the polymer concentration determined from the IR5 broadband channel output. According to the Universal calibration relationship:

$${[ η ]}_{i} {M}_{i} = {[ η ]}_{P S i} {M}_{P S i} = {K ( {M}_{P S i} )}^{a + 1}$$

where the M_{PSi} is the molecular weight of PS standard determined from column calibration curve in each elution volume slice, the “K” and the “a” are the Mark-Houwink parameters of PS in TCB which are chosen as 0.000175 dL/g and 0.67 respectively. All calculations were performed with vendor-provided software GPC ONE™ (Polymer Characterization, S. A., Valencia Spain).

### NMR Method for E-VCB Copolymers (Table 3)

Ethylene-vinylcyclobutane (E-VCB) copolymers were prepared in 1,1,2,2-tetrachloroethane-d2 at a concentration of 100 mg/3 mL of solvent in a 10 mm NMR tube. ¹H and ¹³C NMR were run in the same tube. Samples were run at a temperature of 120° C., at a field of 700 MHZ equipped with a 10 mm high temperature cryoprobe. ¹H NMR conditions were the following: 3° pulse width, 512 scans, 10 Hz spinning speed, and a 15 second delay. ¹³C NMR conditions were the following: inverse gated decoupling with 60 second delay, at least 512 scans, 100 ppm spectral width, centered at 50 ppm, and 10 Hz spinning speed.

### Calculations:

V=vinylcyclobutane, E=ethylene, r=ring br=branch, nomenclature for other assignments based on the Randall review article “A Review of high resolution liquid ¹³Carbon NMR characterization of ethylene-based polymers” Polymer reviews, 29, 201-317 (1989).

| regions | assignment | Triads | Chemical shift | |
|---|---|---|---|---|
| A | CH r EVE | EVE | 44 | ppm |
| B | CH r VVV | VVV | 42.5 | ppm |
| C | CH VVE br, r | VVE | 42 | ppm |
| D | CH VVE br, r | VVE | 41.7 | ppm |
| E | CH EVE br | EVE | 41.4 | ppm |
| F | CH br VVV | VVV | 38.57 | ppm |
| G | CH₂ αα | VVV + VVE | 36.1 | ppm |
| | VVV, VVE | | | |
| H | αγ, α | VEV + 1/2VEE + | 32.3-31.2 | ppm |
| | | EVE + 1/2EVV | | |
| I | γ, γγ, δ | 2EEE + 1/2VEE | 31-28.3 | ppm |
| J | 2CH₂ r EVE | EVE | 27.81 | ppm |
| K | 2CH₂ r, VVE | VVE | 27.4 | ppm |
| L | β | VEE | 27 | ppm |
| M | 2CH₂ r VVV | VVV | 26.8 | ppm |
| N | ββ | VEV | 24.35 | ppm |
| O | CH₂ r VVV | VVV | 18.6 | ppm |
| P | CH₂ r EVE, VVE | EVE + VVE | 18.25 | ppm |

| Assignment | Calculation region | Mole fraction |
|---|---|---|
| EVE | E | EVE/total |
| EVV | D | EVV/total |
| VVV | O | VVV/total |
| VEV | N | VEV/total |
| VEE | L | VEE/total |
| EEE | (I − 0.5*L)/2 | EEE/total |
| Total | EVE + EVV + VVV + | |
| | VEV + VEE + EEE | |
| Mole % V | | V = (EVE + EVV + VVV)*100 |
| Mole % E | | E = (VEV + VEE + EEE)*100 |
| Weight % V | | V*82*100/(V*82 + E*28) |
| Weight % E | | E*28*100/(V*82 + E*28) |

### Triad to Diad Conversion

$$\begin{matrix}EE = EEE + 0.5 * ( VEE ) \\ VV = VVV + 0.5 * ( VVE ) \\ EV = EVE + VEV + 0.5 * VVE + 0.5 * EEV\end{matrix}$$

### Diad to Monad Conversion

$$\begin{matrix}E = EE + 0.5 * EV \\ V = VV + 0.5 * EV\end{matrix}$$

A copolymerization between monomers “E” and “X” in the presence of catalyst “M” can be represented by the following reaction schemes and rate equations where R₁₁ is the rate of “E” insertion after “E”, R₁₂ is the rate of “X” insertion after “E”, R₂₁ is the rate of “E” insertion after “X”, R₂₂ is the rate of “X” insertion after “X”, and k₁₁, k₁₂, k₂₁, and k₂₂ are the corresponding rate constants for each. The reactions scheme and rate equations are illustrated below.

$$\begin{matrix}M - E + E & M - E - E & {R}_{11} = {k}_{11} [ M - E ] [ E ] \\ M - E + X & M - X - E & {R}_{12} = {k}_{12} [ M - E ] [ X ] \\ M - X + E & M - E - X & {R}_{21} = {k}_{21} [ M - X ] [ E ] \\ M - X + X & M - X - X & {R}_{22} = {k}_{22} [ M - X ] [ X ]\end{matrix}$$

The reactivity ratios r₁ and r₂ are:

$$\begin{matrix}{r}_{1} = \frac{{k}_{11}}{{k}_{12}} \\ {r}_{2} = \frac{{k}_{22}}{{k}_{21}} \\ {r}_{1} {r}_{2} = \frac{{k}_{11} {k}_{22}}{{k}_{12} {k}_{21}} .\end{matrix}$$

The product of r₁×r₂ provides information on how the different monomers distribute themselves along the polymer chain. Below, are illustrations of alternating, random and blocky copolymers and how the product of r₁×r₂ relates to each:

| | | |
|---|---|---|
| r₁r₂ = 0 | alternating | EXEXEXEXEXEXEXEXEXEX |
| | copolymerization | |
| r₁r₂ = 1 | random | XXEXEXEXXEXXXEEXEEXE |
| | copolymerization | |
| r₁r₂ > 1 | blocky | XXXXEEEEEEXXXEEEEEXX |
| | copolymerization | |

The reactivity ratios r₁ and r₂ also represent the reactivity of ethylene and propylene in the copolymer, respectively, which are used to describe the characteristic of the catalyst system. r₁r₂, the product of r₁ and r₂, represents the distribution of monomers in the main chain of the copolymer.

For ethylene copolymers, the reactivity ratio (r₁r₂) is defined as follows r₁r₂=4*(EE*VV)/(EV)², where EE, VV and EV are diads where E=ethylene, V=vinylcyclobutane.

### NMR Calculations for Polymers in Table 4:

### **VCB-Alpha-Olefin NMR Calculations

| | | | |
|---|---|---|---|
| | Chemical | | |
| Assignment | Shift | Calculation | Mole % |

| | | | |
|---|---|---|---|
| CH (r) VCB | 42.2 | ppm | r |
| αα (VCB) | 41.23 | ppm | αα |
| CH (br) VCB | 39.1 | ppm | br |
| CH₂ (a) VCB | 27.2 | ppm | a/2 |
| CH₂ (b) | 17.99 | ppm | b |

| | | |
|---|---|---|
| VCB | =Average(r + αα + | VCB/ |
| | br + a/2 + b) | Total*100 |
| α olefin | =Average(aa + CH + all | α olefin/ |
| | xBn peaks) | Total*100 |
| Total | =VCB + α olefin | |

xBn peaks were defined as the branch peaks for the alpha olefin; eg. Octene had a 6 carbon branch (n) with (x=1-6): 1B6, 2B6, etc.

### NMR Calculations for Polymers in Table 5:

PP-VCB calculations assume only isolated incorporation of VCB. Samples were referenced to the isotactic peak of the CH₃ of the PP to 21.83 ppm.

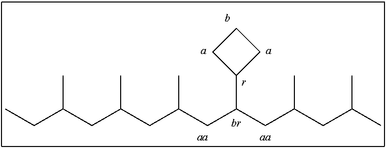 [SMILES: CCC(C)CC(C)CC(C)CC(CC(C)CC(C)C)C1CCC1]

| | | | | |
|---|---|---|---|---|
| Assignment | Chemical Shift | Calculation | Mole % | Weight % |

| | | | |
|---|---|---|---|
| CH₂ (PP) | 46 | ppm | CH₂ PP |
| CH (r) VCB | 42.2 | ppm | r |
| αα (VCB) | 41.23 | ppm | αα/2 |
| CH (br) VCB | 39.1 | ppm | br |
| CH (PP) | 28 | ppm | CH PP |
| CH₂ (a) VCB | 27.2 | ppm | a/2 |
| CH₃ (PP) | 21.83 | ppm | CH₃ PP |
| CH₂ (b) | 17.99 | ppm | b |

| | | | |
|---|---|---|---|
| VCB | =(r + αα/2 + br + a/2 + b)/5 | VCB/Total*100 | (VCB*82)/weight total*100 |
| PP | =(CH₂ + CH + CH₃ PP)/3 | PP/Total*100 | (PP*42)/weight total*100 |
| Total | =VCB + PP | | |
| weight total | =VCB*82 + PP*42 | | |

All patents and patent applications, test procedures (such as ASTM methods, UL methods, and the like), and other documents cited herein are fully incorporated by reference to the extent such disclosure is not inconsistent with this disclosure and for all jurisdictions in which such incorporation is permitted.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, meaning the values take into account experimental error, machine tolerances and other variations that would be expected by a person having ordinary skill in the art.

The foregoing has also outlined features of several embodiments so that those skilled in the art can better understand the present disclosure. Those skilled in the art should appreciate that they can readily use the present disclosure as a basis for designing or modifying other methods or devices for carrying out the same purposes and/or achieving the same advantages of the embodiments disclosed herein. Those skilled in the art should also realize that such equivalent constructions do not depart from the spirit and scope of the present disclosure, and that they can make various changes, substitutions, and alterations herein without departing from the spirit and scope of the present disclosure, and the scope thereof is determined by the claims that follow.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A process for polymerizing vinylcyclobutane (VCB), comprising:
contacting vinylcyclobutane monomer in the presence of a catalyst compound that includes a single-site metallocene, post metallocene, or half metallocene, and an activator, under reaction conditions to produce a VCB polymer having a PDI of less than 3.0.

2. The process of claim 1, wherein the single-site catalyst compound is the post metallocene catalyst compound represented by Formula (I): 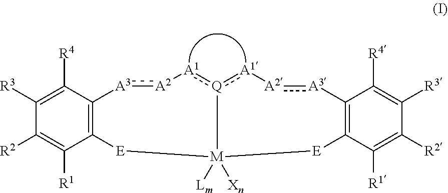
wherein:
M is a group 3, 4, 5, or 6 transition metal or a Lanthanide;
E and E′ are each independently O, S, or NR⁹ where R⁹ is independently hydrogen, a C₁-C₄₀ hydrocarbyl, a C₁-C₄₀ substituted hydrocarbyl or a heteroatom-containing group;
Q is group 14, 15, or 16 atom that forms a dative bond to metal M;
A¹QA^{1′} are part of a heterocyclic Lewis base containing 4 to 40 non-hydrogen atoms that links A² to A^{2′} via a 3-atom bridge with Q being the central atom of the 3-atom bridge, A¹ and A^{1′} are independently C, N, or C(R²²), where R²² is selected from the group consisting of hydrogen, C₁-C₂₀ hydrocarbyl, and C₁-C₂₀ substituted hydrocarbyl;
A³ [symbol] A² is a divalent group containing 2 to 40 non-hydrogen atoms that links A¹ to the E-bonded aryl group via a 2-atom bridge;
A^{2′} [symbol] A^{3′} is a divalent group containing 2 to 40 non-hydrogen atoms that links A^{1′} to the E′-bonded aryl group via a 2-atom bridge;
L is a Lewis base;
X is an anionic ligand;
n is 1, 2 or 3;
m is 0, 1, or 2;
n+m is not greater than 4;
each of R¹, R², R³, R⁴, R^{1′}, R^{2′}, R^{3′}, and R^{4′} is independently hydrogen, a C₁-C₄₀ hydrocarbyl, a C₁-C₄₀ substituted hydrocarbyl, a heteroatom or a heteroatom-containing group, and one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings;
any two L groups may be joined together to form a bidentate Lewis base;
an X group may be joined to an L group to form a monoanionic bidentate group; and
any two X groups may be joined together to form a dianionic ligand group.

3. The process of claim 2, wherein the M is Hf, Zr or Ti.

4. The process of claim 2, wherein E and E′ are each O.

5. The process of claim 2, wherein R¹ and R^{1′} is independently a C₄-C₄₀ tertiary hydrocarbyl group.

6. The process of claim 2, wherein R¹ and R^{1′} is independently a C₄-C₄₀ cyclic tertiary hydrocarbyl group.

7. The process of claim 2, wherein each X is, independently, selected from the group consisting of substituted or unsubstituted hydrocarbyl radicals having from 1 to 20 carbon atoms, hydrides, amides, alkoxides, sulfides, phosphides, halides, and a combination thereof, (two X's may form a part of a fused ring or a ring system).

8. The process of claim 2, wherein each L is, independently, selected from the group consisting of: ethers, thioethers, amines, phosphines, ethyl ether, tetrahydrofuran, dimethylsulfide, triethylamine, pyridine, alkenes, alkynes, alenes, and carbenes and a combinations thereof, optionally two or more L's may form a part of a fused ring or a ring system).

9. The process of claim 2, wherein M is Zr or Hf, Q is nitrogen, both A¹ and A^{1′} are carbon, both E and E′ are oxygen, and both R¹ and R^{1′} are C₄-C₂₀ cyclic tertiary alkyls.

10. The process of claim 2, wherein M is Zr or Hf, Q is nitrogen, both A¹ and A^{1′} are carbon, both E and E′ are oxygen, and both R¹ and R^{1′} are adamantan-1-yl or substituted adamantan-1-yl.

11. The process of claim 2, wherein M is Zr or Hf, Q is nitrogen, both A¹ and A^{1′} are carbon, both E and E′ are oxygen, and both R¹ and R^{1′} are C₆-C₂₀ aryls.

12. The process of claim 2, wherein Q is nitrogen, A¹ and A^{1′} are both carbon, both R¹ and R^{1′} are hydrogen, both E and E′ are NR⁹, where R⁹ is selected from the group consisting of a C₁-C₄₀ hydrocarbyl, a C₁-C₄₀ substituted hydrocarbyl, and a heteroatom-containing group.

13. The process of claim 2, wherein Q is carbon, A¹ and A^{1′} are both nitrogen, and both E and E′ are oxygen.

14. The process of claim 2, wherein Q is carbon, A¹ is nitrogen, A^{1′} is C(R²²), and both E and E′ are oxygen, where R²² is selected from the group consisting of hydrogen, C₁-C₂₀ hydrocarbyl, and C₁-C₂₀ substituted hydrocarbyl.

15. The process of claim 2, wherein the heterocyclic Lewis base is selected from the group consisting of: 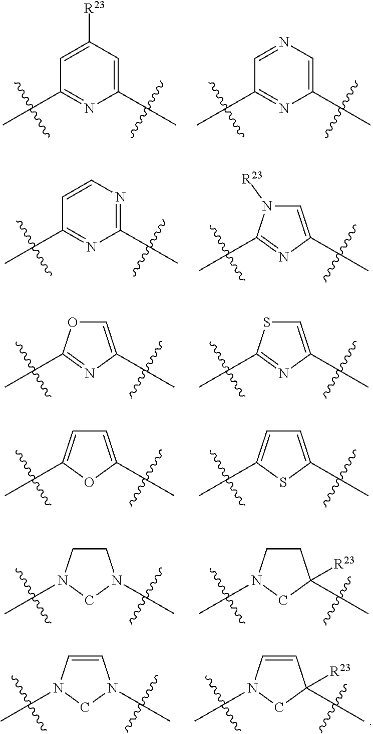
where each R²³ is independently selected from the group consisting of hydrogen, C₁-C₂₀ alkyls, and C₁-C₂₀ substituted alkyls.

16. The process of claim 1, wherein the catalyst compound is one or more of the single-site metallocene or half metallocene catalyst compounds selected from the group consisting of Formulas 1-5: 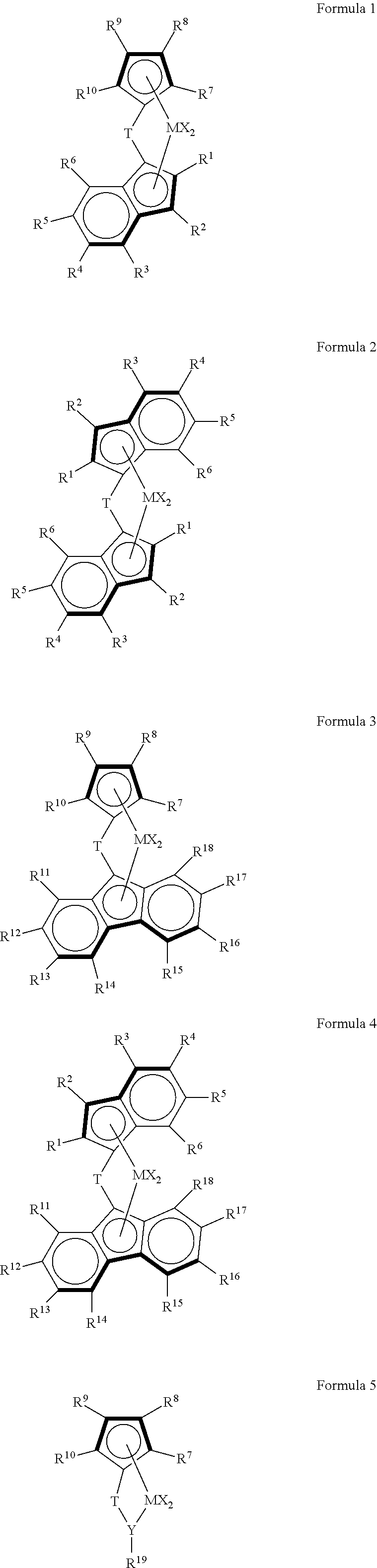
wherein M is a transition metal atom selected from group 3, 4, or 5 of the Periodic Table of Elements;
and preferably selected from the group consisting of Ti, Zr, and Hf,
each X is a univalent anionic ligand, or the two Xs are joined and bound to the M to form a metallocycle ring, or the two Xs are joined to form a chelating ligand, a diene ligand, or an alkylidene ligand,
T is a bridging group represented by the formula, (R*2G)g, where each G is C, Si, or Ge, g is 1 or 2, and each R* is, independently, hydrogen, halogen, C₁ to C₂₀ hydrocarbyl or a C₁ to C₂₀ substituted hydrocarbyl, and two or more R* can optionally form a cyclic structure including aromatic, partially saturated, or saturated cyclic or fused ring system, preferably T is selected from the group consisting of R′₂C, R′₂Si, R′₂Ge, R′₂CCR′₂, R′₂CCR′₂CR′₂, R′₂CCR′₂CR′₂CR′₂, R′C═CR′, R′C═CR′CR′₂, R′₂CCR′═CR′CR′₂, R′C═CR′CR′═CR′, R′C═CR′CR′₂CR′₂, R′₂CSiR′₂, R₂CSiR′₂CR′₂, R′₂SiCR′₂SiR′₂, R′C═CR′SiR′₂, R′₂CGeR′₂, R′₂GeGeR′₂, R′₂CGeR′₂CR′₂, R′₂GeCR′₂GeR′₂, R′₂SiGeR′₂, R′C═CR′GeR′₂, R′B, R′₂C—BR′, R′₂C—BR′—CR′₂, R′₂C—O—CR′₂, R′₂CR′₂C—O—CR′₂CR′₂, R′₂C—O—CR′₂CR′₂, R′₂C—O—CR′═CR′, R′₂C—S—CR′₂, R′₂CR′₂C—S—CR′₂CR′₂, R′₂C—S—CR′₂CR′₂, R′₂C—S—CR′═CR′, R′₂C—Se—CR′₂, R′₂CR₂C—Se—CR′₂CR′₂, R′₂C—Se—CR₂CR′₂, R′₂C—Se—CR′═CR′, R′₂C—N═CR′, R′₂C—NR′—CR′₂, R′₂C—NR′—CR′₂CR′₂, R′₂C—NR′—CR′═CR′, R′₂CR′₂C—NR′—CR′₂CR′₂, R′₂C—P═CR′, or R′₂C—PR′—CR′₂ where each R′ is, independently, hydrogen or a C1 to C20 containing hydrocarbyl (such as methyl, ethyl, propyl, butyl, pentyl, hexyl, heptyl, octyl, nonyl, decyl, undecyl, or dodecyl), substituted hydrocarbyl, halocarbyl, substituted halocarbyl, silylcarbyl or germylcarbyl substituent and, optionally, two or more adjacent R′ may join to form a substituted or unsubstituted, saturated, partially unsaturated or aromatic, cyclic or polycyclic substituent, preferably T is a bridging group comprising carbon or silica, such as dialkylsilyl, more preferably T is selected from the group consisting of CH₂, CH₂CH₂, C(CH₃)₂, SiMe₂, SiPh₂SiMePh, silylcyclobutyl (Si(CH₂)₃), (Ph)₂C, (p-(Et)₃SiPh)₂C, and cyclopentasilylene (Si(CH2)4) (Si(CH₂)₄),
R¹, R², R⁴, R5, R¹¹-R¹⁹ are independently a substituted or unsubstituted C₁ to a C₂₀ hydrocarbyl group or hydrogen and any two adjacent R¹, R², R⁴, R5, and R¹¹-R¹⁸ can be joined to form a cyclic structure, wherein R¹ is optionally a primary substituted or unsubstituted C₁-C₁₂ alkyl or hydrogen group such as hydride, methyl, ethyl, propyl, isopropyl, butyl, isobutyl, pentyl, isopentyl, hexyl, cyclopropyl, or cyclohexyl, and
R³ is a substituted or unsubstituted C₁ to a C₂₀ hydrocarbyl, aryl group or hydrogen, more preferably R³ is selected from the group consisting of phenyl, 1-naphthyl, 2-naphthyl, 9-anthracenyl, 2-biphenyl, 3-biphenyl, 4-biphenyl, 2-methylphenyl, 3-methylphenyl, 4-methylphenyl, 2,3-dimethylphenyl, 2,4-dimethylphenyl, 2,5-dimethylphenyl, 2,6-dimethylphenyl, 3,4-dimethylphenyl, 3,5-dimethylphenyl, 2,4,5-trimethylphenyl, 3,4,5-trimethylphenyl, 2,3,4,5,6-pentamethylphenyl, 2-ethylphenyl, 3-ethylphenyl, 4-ethylphenyl, 2,3-diethylphenyl, 2,4-diethylphenyl, 2,5-diethylphenyl, 2,6-diethylphenyl, 3,4-diethylphenyl, 3,5-diethylphenyl, 3-isopropylphenyl, 4-isopropylphenyl, 3,5-di-isopropylphenyl, 2,5-di-isopropylphenyl, 2-tert-butylphenyl, 3-tert-butylphenyl, 4-tert-butylphenyl, 3,5-di-tert-butylphenyl, 3,5-di-tert-butyl-4-methoxyphenyl, 2,5-di-tert-butylphenyl, 2-trimethylsilylphenyl, 3-trimethylsilylphenyl, 4-trimethylsilylphenyl, 3,5-bis(trimethylsilyl)phenyl, 2-trifluoromethylphenyl, 3-trifluoromethylphenyl, 4-trifluoromethylphenyl, 3,5-bis(trifluoromethyl)phenyl, cyclopropyl, carbazolyl, indolyl, pyrrolyl, or 2-furanyl, 3-furanyl, 5-methyl-2-furanyl, 5-ethyl-2-furanyl, 4,5-dimethyl-2-furanyl, 2-methyl-3-furanyl, 5-methyl-3-furanyl, 2-thiophenyl, 3-thiophenyl, 5-methyl-2-thiophenyl, 2-methyl-3-thiophenyl, and 5-methyl-3-thiophenyl.

17. The process of claim 1, wherein the reaction conditions include a reactor reactor pressure from 0.07 MPa to 7 MPa, a reactor temperature from 20° C. to 250° C., an optional hydrocarbon solvent and hydrogen;

18. The process of claim 1, wherein the the activator is either aluminoxane or salts of non-coordinating (NCA) anions.

19. The process of claim 18, wherein the the activator is present in molar ratio relative to catalyst greater than 1:1, such as greater than 10:1, such as greater than 250:1, such as greater than 500:1.

20. The process of claim 1 wherein the catalyst compound is supported on alumina (Al₂O₃), zirconia (ZrO₂), silica (SiO₂), SiO₂/Al₂O₃, SiO₂/titania (TiO₂), silica clay, silicon oxide/clay, or mixtures thereof.

21. The process of claim 1, further comprising contacting the vinylcyclobutane monomer in the presence of one or more C2-C20 alpha olefins or one or more C4-C30 dienes.

22. The process of claim 1, further comprising contacting the vinylcyclobutane monomer in the presence of one or more C2-C20 alpha olefins and one or more C4-C30 dienes.

23. A homopolymer comprising vinylcyclobutane, wherein the homopolymer has a polydispersity (PDI) of less than 3.0.

24. The homopolymer of claim 23, wherein the PDI is less than 2.8.

25. The homopolymer of claim 23, further comprising a melting temperature (Tm) of 165° to 246° C.

26. The homopolymer of claim 23, further comprising a TREF peak of reater than 148° C.

27. The homopolymer of claim 23, further comprising a TREF T75-T25 of less than 9.1.

28. The homopolymer of claim 23, further comprising a TREF SDBI of less than 50.

29. A copolymer comprising vinylcyclobutane and one or more comonomers comprising at least one C2 to C20 olefin, the copolymer having a polydispersity (PDI) of less than 3.0.

30. The copolymer of claim 29, further comprising an r1r2 value of less than 2.5.

31. The copolymer of claim 29, wherein the copolymer has a comonomer content of less than 99.5 mol % and greater than 0.5 mol %, based on total weight of the copolymer.

32. The copolymer of claim 29, wherein the at least one C2 to C20 olefin is a diene.
